(19) United States
(12) Patent Application Publication
(10) Pub. No.: US 2013/0321220 A1
(43) Pub. Date: Dec. 5, 2013

(54) METAMATERIAL, ELECTRIC APPARATUS, AND ELECTRIC APPARATUS INCLUDING METAMATERIAL

(71) Applicant: Murata Manufacturing Co., Ltd., Nagaokakyo-Shi (JP)

(72) Inventor: Atsushi Toujo, Nagaokakyo-Shi (JP)

(73) Assignee: Murata Manufacturing Co., Ltd., Nagaokakyo-Shi (JP)

(21) Appl. No.: 13/961,997

(22) Filed: Aug. 8, 2013

Related U.S. Application Data
(63) Continuation of application No. PCT/JP2012/052498, filed on Feb. 3, 2012.

(30) Foreign Application Priority Data
Feb. 10, 2011 (JP) 2011-027484
Mar. 2, 2011 (JP) 2011-044838

(51) Int. Cl. H01Q 1/36; H01Q 1/24

(52) U.S. Cl. CPC H01Q 1/36; H01Q 1/243
USPC 343/702; 343/722

(57) ABSTRACT

An electric apparatus that includes a component having a conductive layer in a fixed range in the depth direction, the conductive layer including a particular region that is electromagnetically isolated from other regions. The electric apparatus further includes a metamaterial which exhibits a dielectric constant having an absolute value less than 1 and a magnetic permeability having an absolute value more than 1 with respect to a predetermined resonant wavelength in an electromagnetic field. The metamaterial is arranged so as to cut off the near resonant wavelength component of an electric current flowing through the conductive layer in the particular region, and at least part of the particular region is configured to radiate an electromagnetic wave.

### CROSS REFERENCE TO RELATED APPLICATIONS

The present application is a continuation of International application No. PCT/2012/052498, filed Feb. 3, 2012, which claims priority to Japanese Patent Application No. 2011-027484, filed Feb. 10, 2011, and Japanese Application No. 2011-044838, filed Mar. 2, 2011, the entire contents of each of which are incorporated herein by reference.

### FIELD OF THE INVENTION

The present invention relates to a metamaterial, an electric apparatus, and an electric apparatus including a metamaterial.

### BACKGROUND OF THE INVENTION

Antennas have a long history, including many known techniques, such as a monopole antenna, a dipole antenna, a helical antenna, and an inverted F antenna. Typically, a λ/4 line has one of a bar shape and a plate shape, and a conductor is formed on one of a film and a printed substrate. In addition, for size reduction, an antenna includes a meandered line, uses a dielectric to shorten a wavelength, and is formed of a multi-layer structure in three dimensions.

Further, there is a ceramic chip antenna (for instance, JP 9-162625 A (hereinafter, referred to as “Patent Document 1”)). Proposed is a metamaterial antenna of a mushroom structure in which a slit is provided in the surface thereof (for instance, JP 2009-535942 A (hereinafter, referred to as “Patent Document 2”), and JP 2010-502131 A (hereinafter, referred to as “Patent Document 3”)).
Patent Document 1: JP 9-162625 A
Patent Document 2: JP 2009-535942 A
Patent Document 3: JP 2010-502131 A

### SUMMARY OF THE INVENTION

For instance, a monopole antenna which receives one segment reception service for cellular phones and mobile terminals, so-called a one segment broadcast, is of the extendable and contractable rod type to be provided on the outside of an apparatus. The antenna of a cellular phone is often formed on a printed substrate. A chip antenna is mounted on a substrate.

FIG. 75 is a diagram showing the arrangement of a conventional antenna 3000 in which a case 3001 is formed of a resin. Referring to FIG. 75, when the antenna 3000 is formed on a substrate 3300 of a cellular phone and the like, the resin case 3001 on the outside of the cellular phone passes an electric wave therethrough, causing no problem.

FIG. 76 is a diagram in which a case 4001 is formed of a metal. Referring to FIG. 76, the case 4001 which is formed of one of a metal and a conductive resin does not pass an electric wave therethrough. Therefore, even when formed on a substrate 4300 in the case 4001, an antenna 4000 cannot function as an antenna.

In addition, the antenna in Patent Documents 1 to 3 in the case which does not pass an electric wave therethrough cannot function as an antenna.

FIG. 77 is a diagram in which a case 4002 of part of the metal case 4001 is formed of a resin. As a first method, when the case 4001 does not pass an electric wave therethrough, only the portion of the case 4002 of part of the metal case 4001 is formed of a resin which passes an electric wave therethrough so as not to cut off the electric wave. For instance, in a recent notebook PC (Personal Computer), part of the top metal plate thereof is formed of a resin to form an antenna therein.

FIG. 78 is a diagram showing an antenna 4100 arranged on the outside of the metal case 4001. Referring to FIG. 78, as a second method, when the case 4001 does not pass an electric wave therethrough, the antenna 4100 is provided on the outside of the apparatus.

The antenna 4100 on the outside of the apparatus has no functional problems. However, in that case, the antenna 4100 can be an obstacle, and can be troublesome to be projected. Consequently, the second method cannot meet the needs of consumers. After all, the antenna is desirably incorporated.

As described above, when part of the metal case 4001 is formed of a resin, the strength and the heat dissipation are lowered. In addition, the texture is partially changed, which is unfavorable in design.

In addition, since the portion to be replaced with a resin is minimum, the antenna is required to be mounted in a small space. Therefore, the antenna is required to be smaller, so that the gain can be sacrificed. Further, with too many wireless standards, the number of antennas required has been increased. Consequently, the number of antenna mounting positions has not been enough.

Part of the metal case which is electromagnetically isolated can function as an antenna, thereby solving the above problems.

The present invention has been made in view of the above problems, and an object of the present invention is to provide a metamaterial and an electric apparatus, which can electromagnetically isolate a particular region from other regions.

To achieve the above object, an aspect of the present invention provides a metamaterial, in which a dielectric constant having an absolute value less than 1 and a magnetic permeability having an absolute value more than 1 can be exhibited with respect to a predetermined resonant wavelength in an electromagnetic field, a cutoff region (e.g., a high impedance region, and a reflective region) which cuts off the near resonant wavelength component of an electric current flowing through a conductive layer (e.g., only a metal layer, and a metal layer less than a skin depth +an insulator layer) of a component having the conductive layer in a fixed range in the depth direction is formed in a sectioning region which sections a particular region of the conductive layer from other regions, and at least part of the particular region can radiate an electromagnetic wave.

The fixed range in the depth direction of the component is referred to as the range in which the depth from one surface of the component is e.g., a to b (when the thickness of the component is t, 0≦a≦b≦t). For instance, when a=0 and b=t, the conductive layer occupies the entire thickness range of the component. When a=0 and b<t, the conductive layer occupies the range from one surface of the component to depth b. When a>0 and b<t, the conductive layer occupies the range sandwiched between the layer from one surface of the component to depth a and the layer from the other surface to depth t−b. When a>0 and b=t, the conductive layer occupies the range from the other surface of the component to depth t−a.

Preferably, the conductive layer has a thickness less than a skin depth according to the material of the conductive layer. The portion of the particular region which can radiate an electromagnetic wave is formed on the surface of the conductive layer in the particular region.

The particular region is in contact with the contour of the component (the end of the component, and the contour of a slit when a slit is provided). The portion of the particular region which can radiate an electromagnetic wave is formed on the end surface of the conductive layer in the particular region in the portion in contact with the contour of the component (for instance, the end surface of the conductive layer which is contacted onto the particular region and is exposed from the slit, and the end surface of the conductive layer in the particular region at the end of the component).

Another aspect of the present invention provides an electric apparatus including a component (e.g., only a metal layer, and a metal layer less than a skin depth +an insulator layer) having a conductive layer in a fixed range in the depth direction. The conductive layer includes a region which electromagnetically isolates a particular region of the conductive layer from other regions.

Preferably, the electric apparatus further includes a metamaterial which can exhibit a dielectric constant having an absolute value less than 1 and a magnetic permeability having an absolute value more than 1 with respect to a predetermined resonant wavelength of an electromagnetic field. The metamaterial is arranged so that a cutoff region (e.g., a high impedance region, and a reflective region) which cuts off the near resonant wavelength component of an electric current flowing through the conductive layer is formed in a sectioning region which sections the particular region from other regions. At least part of the particular region can radiate an electromagnetic wave.

The fixed range in the depth direction of the component is referred to as the range in which the depth from one surface of the component is e.g., a to b (when the thickness of the component is t, 0≦a<b≦t). For instance, when a=0 and b=t, the conductive layer occupies the entire thickness range of the component. When a=0 and b<t, the conductive layer occupies the range from one surface of the component to depth b. When a>0 and b<t, the conductive layer occupies the range sandwiched between the layer from one surface of the component to depth a and the layer from the other surface to depth t−b. When a>0 and b=t, the conductive layer occupies the range from the other surface of the component to depth t−a.

Preferably, the conductive layer has a thickness less than a skin depth according to the material of the conductive layer. The portion of the particular region which can radiate an electromagnetic wave is formed on the surface of the conductive layer in the particular region.

Preferably, the particular region is in contact with the contour of the component (the end of the component, and the contour of a slit when a slit is provided). The portion of the particular region which can radiate an electromagnetic wave is formed on the end surface of the conductive layer in the particular region in the portion in contact with the contour of the component (for instance, the end surface of the conductive layer which is in contact with the particular region and is exposed from the slit, and the end surface of the conductive layer in the particular region at the end of the component).

Preferably, an electricity supply point is provided in the particular region. The electric current flowing through the conductive layer is an electric current supplied from the electricity supply point. The particular region is an antenna to which electricity is supplied from the electricity supply point.

More preferably, the component structures part of a housing which is molded to shield the inside thereof from the outside thereof. The metamaterial is provided in the housing. The electric apparatus further includes a circuit (e.g., a tuning circuit, an amplifier circuit, and an output circuit) which is provided in the housing, supplies electricity to an electricity supply point, and processes a near resonant wavelength electromagnetic wave resonated in the particular region.

Preferably, the electric apparatus further includes a grounding component which is arranged on the opposite side of the particular region across the metamaterial.

Preferably, the electric apparatus further includes a grounding portion which is replaced with the metamaterial and is provided in part of the sectioning region near the electricity supply point.

Preferably, the electric apparatus further includes a predetermined function portion (camera unit) having a predetermined function (camera function). The metamaterial is previously incorporated into the predetermined function portion so that the predetermined function portion is attached at a predetermined position and the metamaterial is arranged at a position in which the cutoff region is formed in the sectioning region.

Preferably, an electromagnetic wave is incident onto one surface of the particular region. The electric current flowing through the conductive layer is an electric current generated by the electromagnetic wave incident onto one surface of the particular region. The particular region radiates the electromagnetic wave having the wavelength of the incident electromagnetic wave from the other surface.

Preferably, the metamaterial includes one of a

multi-layer ceramic capacitor and a chip coil.

Preferably, the particular region is a region in which part of the component is sectioned by at least one of a slit and a grounding portion. At least part of the particular region can radiate an electromagnetic wave.

According to the present invention, the particular region in the component functions as an antenna. As a result, part of the component having the conductive layer can function as an antenna.

More preferably, the opening in the component by the slit is closed by an insulating component. According to the present invention, the opening is reinforced by the insulating component. As a result, even when the slit is provided in the component, the strength can be ensured.

More preferably, the grounding portion is provided in the insulating component. According to the present invention, the grounding portion is provided as part of the insulating component. As a result, the grounding portion can be efficiently formed.

More preferably, the resonant frequency of the particular region can be adjusted according to the position of the grounding portion. When the slit is formed by punching, the manufacturing cost can be low. However, in this case, the resonant frequency cannot be adjusted according to the size of the slit. According to the present invention, even after the slit is formed, the resonant frequency can be adjusted according to the position of the grounding portion provided later. As a result, the resonant frequency can be adjusted without increasing the cost.

More preferably, the slit is U-shaped and the particular region is a region inside a U-shape.

Preferably, the electric apparatus is a portable terminal, a PC, a video, a television, an electric appliance such as a refrigerator and an air conditioner, a transporting apparatus such as an automobile and a train, and constructing equipment such as a house door with an electric lock.

According to the present invention, the particular region is electromagnetically isolated from other regions. Therefore, the metamaterial and the electric apparatus, which can electromagnetically isolate the particular region from other regions can be provided.

The particular region is isolated from the outside of the sectioning region in the resonance with the resonant wavelength component of the electromagnetic field. Therefore, the metamaterial and the electric apparatus, which can electromagnetically isolate the particular region in the component from other regions can be provided.

When electricity is supplied from the electricity supply point, the particular region functions as an antenna which is electromagnetically isolated from the outside of the sectioning region to be resonated with the near resonant wavelength component of the electromagnetic field. Therefore, part of the component can function as an antenna.

The particular region as the electric window which passes an electromagnetic wave from one surface through the other surface can be formed in the plane having the conductive layer.

### BRIEF EXPLANATION OF THE DRAWINGS

FIG. 1 is a schematic appearance view of a capacitor resonator 300.

FIG. 2 is a cross-sectional view taken along line II-II shown in FIG. 1.

FIG. 3 is an explanatory view of a resonator circuit formed of the capacitor resonator 300 at a resonant frequency.

FIG. 4 is a graph showing an example of the frequency characteristic of a relative permeability generated in the capacitor resonator 300.

FIG. 5 is a diagram showing a metamaterial which uses a coil resonator 100 and has a negative dielectric constant.

FIG. 6 is a chart showing the relative permeability of the metamaterial shown in FIG. 5.

FIG. 7 is a chart showing the relative permittivity of the metamaterial shown in FIG. 5.

FIG. 8 is a diagram showing a metamaterial which uses the coil resonator 100 and has a negative magnetic permeability.

FIG. 9 is a chart showing the relative permeability of the metamaterial shown in FIG. 8.

FIG. 10 is a chart showing the relative permittivity of the metamaterial shown in FIG. 8.

FIG. 11 is a diagram showing a capacitor resonator in which inner electrodes in outermost portions are directly connected to each other and a coil resonator.

FIG. 12 is a chart showing the relative permittivity of the resonators shown in FIG. 11.

FIG. 13 is a chart showing the relative permeability of the resonators shown in FIG. 11.

FIG. 14 is a diagram showing a metamaterial according to a first embodiment.

FIG. 15 is a chart showing the relative permittivity of the resonators shown in FIG. 14.

FIG. 16 is a chart showing the relative permeability of the resonators shown in FIG. 14.

FIG. 17 is a diagram showing a metamaterial of a second embodiment in which the structure of the capacitor resonator is changed.

FIG. 18 is a schematic diagram of the metamaterial of the second embodiment.

FIG. 19 is a diagram showing the structure of the metamaterial according to the second embodiment.

FIG. 20 is a perspective view of a unit 600.

FIG. 21 is a side view of the unit 600 seen from the y direction.

FIG. 22 is a perspective view of a unit 700.

FIG. 23 is a side view of the unit 700.

FIG. 24 is a perspective view of a unit 800.

FIG. 25 is a side view of the unit 800.

FIG. 26 is a top view of the unit 800.

FIG. 27 is a perspective view of a unit 900.

FIG. 28 is a front view of the unit 900.

FIG. 29 is a side view of the unit 600.

FIG. 30 is an explanatory view of a method for making the unit 900 according to a fifth embodiment.

FIG. 31 is a diagram showing the structure of a unit 1000 according to a sixth embodiment.

FIG. 32 is a schematic diagram of the position relation between a metamaterial which combines a split ring resonator 1210 and a half-wavelength resonator 1220, a signal line 200, and a ground 220.

FIG. 33 is a schematic diagram of the state of electric charges and electric fields when the metamaterial shown in FIG. 32 exhibits a negative dielectric constant.

FIG. 34 is a schematic diagram of the state of a magnetic field when the metamaterial shown in FIG. 32 exhibits a negative magnetic permeability.

FIG. 35 is a schematic diagram of the position relation between a metamaterial which has a resonator arrangement different from that of the metamaterial in FIG. 34, the signal line 200, and the ground 220.

FIG. 36 is an explanatory view of electric field concentration regions when the metamaterial shown in FIG. 35 exhibits a negative dielectric constant.

FIG. 37 is an explanatory view of a magnetic field concentration region when the metamaterial shown in FIG. 35 exhibits a negative magnetic permeability.

FIG. 38 is a diagram showing the transmission of an electromagnetic wave on a transmission line for each value range of magnetic permeability μ and dielectric constant ∈.

FIG. 39 is a diagram showing an antenna using metamaterials according to a seventh embodiment.

FIG. 40 is a diagram showing in more detail the antenna using the metamaterials according to the seventh embodiment.

FIG. 41 is a diagram showing an example of a structure which forms an antenna using the metamaterials according to the seventh embodiment.

FIG. 42 is a diagram showing the structure of electromagnetic wave resonance simulation on a metal plate when a metamaterial is not used.

FIGS. 43(A), 43(B), and 43(C) are diagrams showing electromagnetic wave resonance simulation results on the metal plate when the metamaterial is not used.

FIG. 44 is a diagram showing the structure of electromagnetic wave resonance simulation on a metal plate when a metamaterial is used.

FIGS. 45(A) and 45(B) are diagrams showing electromagnetic wave resonance simulation results on the metal plate when the metamaterial is used.

FIG. 46 is a diagram showing an example in which an antenna using metamaterials according to a ninth embodiment is applied to a product.

FIG. 47 is a diagram showing an example of a structure which forms an antenna using the metamaterials according to the tenth embodiment.

FIG. 48 is a diagram showing in detail part of the structure which forms an antenna using the metamaterials according to a tenth embodiment.

FIGS. 49(A) and 49(B) are diagrams showing the simulation results of the antenna using the metamaterials 2100C according to the tenth embodiment.

FIG. 50 is a schematic explanatory view of the structure of an antenna using the metamaterial according to the seventh to ninth embodiments.

FIG. 51 is a schematic explanatory view of the structure of an antenna using a metamaterial according to an eleventh embodiment.

FIG. 52 is a schematic explanatory view of the structure of an antenna using a metamaterial according to a twelfth embodiment.

FIG. 53 is a schematic explanatory view of the structure of an antenna using a metamaterial according to a thirteenth embodiment.

FIG. 54 is a schematic explanatory view of the structure of an antenna using a metamaterial according to a fourteenth embodiment.

FIG. 55 is an explanatory view of the structure of an antenna using a metamaterial according to a fifteenth embodiment.

FIG. 56 is a diagram showing an example in which an antenna using metamaterials according to a sixteenth embodiment is applied to a product.

FIG. 57 is a diagram showing an example in which an antenna using metamaterials according to a seventeenth embodiment is applied to a product.

FIG. 58 is an explanatory view of the structure of an antenna using a metamaterial according to a eighteenth embodiment.

FIG. 59 is an explanatory view of the structure of an antenna using a metamaterial according to a nineteenth embodiment.

FIG. 60 is a first diagram showing an example in which an antenna using a metamaterial according to a twentieth embodiment is applied to a smartphone.

FIG. 61 is a second diagram showing an example in which an antenna using the metamaterial according to the twentieth embodiment is applied to a smartphone.

FIG. 62 is a third diagram showing an example in which an antenna using the metamaterial according to the twentieth embodiment is applied to a smartphone.

FIG. 63 is a fourth diagram showing an example in which an antenna using the metamaterial according to the twentieth embodiment is applied to a smartphone.

FIGS. 64(A) and 64(B) are explanatory views of the structure of an electric window using metamaterials according to a twenty-first embodiment.

FIGS. 65(A) and 65(B) are explanatory views of the function of the electric window using the metamaterials according to the twenty-first embodiment.

FIG. 66 is a diagram showing an example in which an electric window using metamaterials according to a twenty-second embodiment is applied to a product.

FIG. 67 is an explanatory view of the structure of an antenna using a slit according to a twenty-third embodiment.

FIG. 68 is an explanatory view of the structure of an antenna using a slit according to a twenty-fourth embodiment.

FIG. 69 is an explanatory view of the structure of an antenna using a slit according to a twenty-fifth embodiment.

FIG. 70 is an explanatory view of the structure of an antenna using a slit 2900U according to a twenty-sixth embodiment.

FIG. 71 is a diagram taken along line A-A in FIG. 70, seen in the direction of the appended arrows.

FIG. 72 is a perspective view of the structure of the antenna using the slit according to the twenty-sixth embodiment.

FIG. 73 is an explanatory view of plural conventional slot antennas on the same metal plate.

FIG. 74 is an explanatory view of plural antennas using slits according to a twenty-seventh embodiment on the same metal plate.

FIG. 75 is a diagram showing the arrangement of a conventional antenna in which a case is formed of a resin.

FIG. 76 is a diagram in which a case is formed of a metal.

FIG. 77 is a diagram in which a case of part of the metal case is formed of a resin.

FIG. 78 is a diagram showing an antenna arranged on the outside of the metal case.

FIG. 79 is an explanatory view of a structure which electrically isolates a metal line by using a metamaterial according to a twenty-eighth embodiment.

FIG. 80 is a side view of the structure which electrically isolates the metal line by using the metamaterial according to the twenty-eighth embodiment.

FIG. 81 is a front view of the structure which electrically isolates the metal line by using the metamaterial according to the twenty-eighth embodiment.

FIGS. 82(A), 82(B), and 82(C) are three views showing the detail of an upper stage of the structure which electrically isolates the metal line by using the metamaterial according to the twenty-eighth embodiment.

FIGS. 83(A), 83(B), and 83(C) are three views showing the detail of a lower stage of the structure which electrically isolates the metal line by using the metamaterial according to the twenty-eighth embodiment.

FIG. 84 is an explanatory view of the structure of a metamaterial according to a twenty-ninth embodiment.

FIGS. 85(A), 85(B), and 85(C) are three views of the metamaterial according to the twenty-ninth embodiment.

FIG. 86 is a schematic plan view of a state in which the metamaterial according to the twenty-ninth embodiment is mounted on a smartphone.

FIG. 87 is a schematic perspective view of a state in which the metamaterial according to the twenty-ninth embodiment is mounted on a smartphone.

### DETAILED DESCRIPTION OF THE INVENTION

### [Problems in Realizing a Left-Handed Metamaterial]

In recent years, a device called a metamaterial has been noted. The metamaterial is an artificial substance having electromagnetic and optical characteristics that substances in the natural world do not have. As the typical characteristic of such a metamaterial, a negative magnetic permeability (μ<0), a negative dielectric constant (∈<0), and a negative refraction factor (when both of a magnetic permeability and a dielectric constant are negative) are given. The region in which μ<0 and ∈>0 and the region in which μ>0 and ∈<0 are also referred to as an “evanescent solution region”. The region in which μ<0 and ∈<0 is referred to as a “left-handed region”.

The left-handed metamaterial in which μ<0 and ∈<0 realizes a negative dielectric constant and a negative magnetic permeability at the same time, and is made by periodically arranging a negative dielectric constant element and a negative magnetic permeability element.

The left-handed metamaterial is classified as a circuit metamaterial and a resonant metamaterial. In the resonant metamaterial, as a means which realizes negative μ, for instance, there is a split ring resonator (SRR) (for instance, see “Left-handed metamaterial” (Nikkei Electronics, the January 2 issue, Nikkei Business Publications, Inc., Jan. 2, 2006, p. 75-81)).

On the other hand, as a means which realizes negative ∈, there is a sufficiently long metal thin wire with respect to the wavelength of an electromagnetic wave. According to this metal thin wire, the plasma frequency is lowered to realize negative ∈. “Low Frequency Plasmons in thin-wire structures” (J B Pendry et al., J. Phys.: Condens. Matter Vol. 10 (1998) 4785-4809) describes that a metal thin wire array can realize negative ∈. In addition, JP No. 2008-507733 describes that a periodic lattice wire has the negative dielectric constant.

It is also known that a metal thin wire having a half length of wavelength λ of an electromagnetic wave generates a negative dielectric constant by the resonance with the electromagnetic wave.

In the method with the sufficiently long metal thin wire with respect to the wavelength of an electromagnetic wave to realize negative ∈, the metamaterial cannot be reduced in size. Accordingly, the use of the metal wire having a half length of wavelength λ of an electromagnetic wave is considered.

However, when combined with a resonator which realizes negative μ to realize the left-handed metamaterial, a λ/2 metal wire which is a kind of resonator can interfere with the resonator which realizes negative μ. As a result, the combination of the metal wire and the resonator cannot exhibit negative ∈ and negative μ at the same time.

Embodiments of the metamaterial which can solve the above problems and exhibit a negative dielectric constant and a negative magnetic permeability at the same time will be described below.

[About Resonators]

The left-handed metamaterial according to the present invention is the resonant metamaterial in which resonators are combined with each other. Accordingly, first, resonators structuring the left-handed metamaterial of the present invention will be described.

(Multi-Layer Capacitor Resonator)

As one resonator used in this embodiment, there is a multi-layer capacitor resonator including plural electrodes. The resonator is formed with a resonator circuit which mainly includes electrostatic capacitance (capacitance) generated between the electrodes. The resonator circuit has sensitivity to the particular frequency component of an electromagnetic wave generated by an alternating current flowing through a signal line arranged around the resonator, and receives the electromagnetic wave having the frequency component to cause an electric resonance phenomenon. The resonance phenomenon exhibits a negative magnetic permeability.

Here, to generate magnetic permeability resonance which is the metamaterial function, the length in the propagating direction of an electric current in each resonator is required to be shorter than at least λ/4 with respect to wavelength λ of an electromagnetic wave at a target frequency. Further, the length in the propagating direction of an electric current in each resonator is preferably equal to λ/20 or less.

As the resonator, a multi-layer capacitor formed by stacking plural plate electrodes and insulators (dielectrics) can be used. Hereinafter, a structure which realizes the resonator by using the multi-layer capacitor will be illustrated. According to this structure, the resonator can be easily structured by using a commercially-available multi-layer capacitor such as a multi-layer ceramic capacitor. However, an electrode member which is specially designed for structuring the resonator according to the present invention may be used.

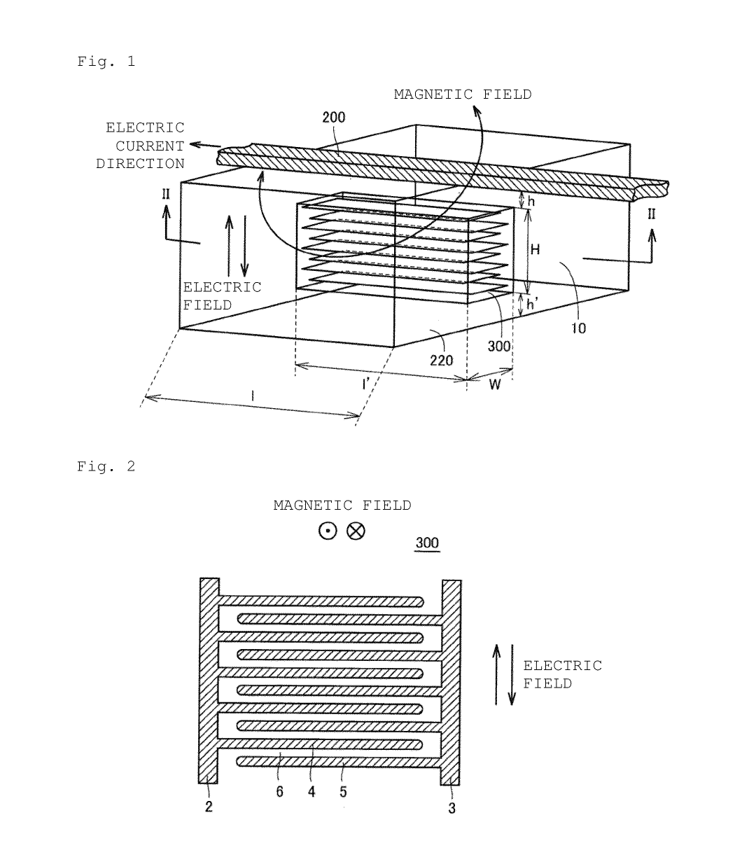

FIG. 1 is a schematic appearance view of a capacitor resonator 300. Referring to FIG. 1, the capacitor resonator 300 is covered by an outer cover 10 which is a non-magnetic body. As the outer cover 10, a resin material, such as Teflon (trademark), is suitable. The capacitor resonator 300 is arranged close to a signal line 200 through which an electric current including a predetermined frequency component flows, and receives the particular frequency component (resonant frequency) of an electromagnetic wave generated by the electric current to generate resonance. In addition, a ground 220 is arranged on the opposite side of the surface of the capacitor resonator 300 in contact with the signal line 200.

The resonance in the capacitor resonator 300 generates a magnetic flux therein to exhibit a negative magnetic permeability.

In order that the capacitor resonator 300 exhibits a negative magnetic permeability which is the metamaterial function, length I′ of the capacitor resonator 300 in the electric current propagating direction in the signal line 200 is required to be shorter than at least λ/4 with respect to wavelength λ of an electromagnetic wave at a resonant frequency. Further, length I of the capacitor resonator 300 is preferably equal to λ/20 or less.

Hereinafter, as an example of the capacitor resonator 300, the multi-layer capacitor having eight-layer inner electrodes having length I′ of 1.6 mm, width W of 0.8 mm, and height H of 1.2 mm is used. Distance h between the signal line 200 and the multi-layer capacitor is 0.2 mm, and distance h′ between the multi-layer capacitor and the ground is 0.2 mm.

Here, when λ/4 is length I′ of 1.6 mm, λ is 6.4 mm, which corresponds to frequency fmax=46.875 GHz in air. Therefore, a capacitor resonator 300 array at a pitch of equal to λ/4 or less can be used as a metamaterial in the GHz bandwidth. Of course, length I of the resonator can be designed, as needed, according to a frequency region to be applied.

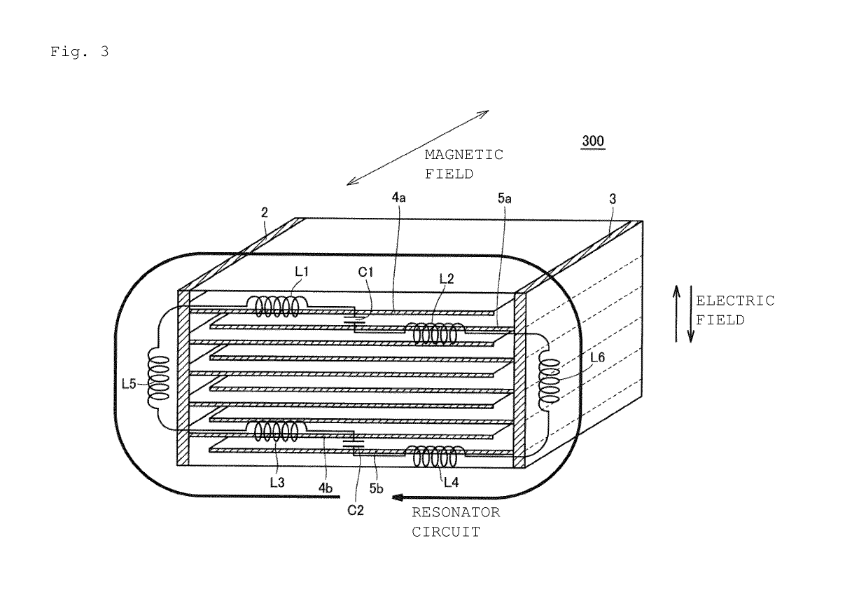

Next, referring to FIGS. 1 and 2, the structure of the capacitor resonator 300 will be described. FIG. 2 is a cross-sectional view taken along line II-II shown in FIG. 1.

Referring to FIG. 1, the electric current flows through the signal line 200 to generate an alternating current magnetic field in the circumferential direction about the signal line 200. That is, the magnetic line of force of the magnetic field forms a concentric circle about the signal line 200. In addition, electric potentials are generated in the signal line 200 through which the electric current flows. An alternating current electric field is thus generated between the signal line 200 and the ground 220.

Referring to FIG. 2, the capacitor resonator 300 includes plural first inner electrodes 4 and plural second inner electrodes 5, each first electrode 4 and each inner electrode 5 being opposite to each other via a spacer 6 which is an insulator having a high relative permittivity. The inner electrodes 4 are electrically connected to a first outer electrode 2, and the second inner electrodes 5 are electrically connected to a second outer electrode 3. In this manner, the plate-shaped inner electrodes 4 and 5 are stacked onto each other in the capacitor resonator 300, so that electrostatic capacitance (capacitance) whose value is determined according to the electrode area, the distance between the electrodes, and the relative permittivity of the spacer 6 is generated between each first inner electrode 4 and each second inner electrode 5 which are adjacent to each other.

Each electrode surface of the first inner electrodes 4 and the second inner electrodes 5 which structure the capacitor resonator 300 is arranged substantially parallel to the magnetic line of force of the magnetic field. With it, each electrode surface of the first outer electrode 2 and the second outer electrode 3 is arranged substantially parallel to the magnetic line of force of the magnetic field on each surface which is different from each electrode surface of the first outer electrode 2 and the second outer electrode 3. That is, as shown in FIG. 2, when the magnetic line of force of the magnetic field generated by the electric current flowing through the signal line 200 is generated in the front-rear direction to the sheet, the capacitor resonator 300 is arranged so that the electrode cross-section longitudinal direction of the first inner electrodes 4 and the second inner electrodes 5 coincides with the right-left direction to the sheet, and that the electrode cross-section longitudinal direction of the first outer electrode 2 and the second outer electrode 3 coincides with the up-down direction to the sheet.

The capacitor resonator 300 is arranged to maintain the position relation shown in FIG. 2, so that a resonator circuit shown in FIG. 3 is formed with respect to the predetermined frequency component, and exhibits a negative magnetic permeability.

FIG. 3 is an explanatory view of the resonator circuit formed of the capacitor resonator 300 at a resonant frequency.

Referring to FIG. 3, the first inner electrodes 4, the second inner electrodes 5, the first outer electrode 2, and the second outer electrode 3, which are arranged so that each electrode surface thereof is substantially parallel to the magnetic line of force of the magnetic field function as a coil (inductor) according to the path length.

In the capacitor resonator 300, an uppermost electrode 4a among the first inner electrodes, the first outer electrode 2, and a lowermost electrode 4b among the first inner electrodes are electrically connected to each other to form an electric current path including these. In the same manner, an uppermost electrode 5a among the second inner electrodes, the second outer electrode 3, and a lowermost electrode 5b among the second inner electrodes are electrically connected to each other to form an electric current path including these. Here, the electric current paths are electrically connected to each other via electrostatic capacitance (capacitance C1) between the electrodes 4a and 5a and electrostatic capacitance (capacitance C2) between the electrodes 4b and 5b, thereby forming the resonator circuit including capacitances C1 and C2 and inductances L1 to L6 generated by the electrodes. Therefore, the capacitor resonator 300 according to this embodiment has a resonant frequency which is determined by capacitance (C1+C2) and inductance (L1+L2+L3+L4+L5+L6). An electromagnetic wave at the resonant frequency is thus incident to exhibit magnetic permeability resonance.

In the capacitor resonator 300, electrostatic capacitance is generated between the adjacent inner electrodes, but other electrostatic capacitances except for the uppermost and lowermost electrostatic capacitances have little influence on the forming of the resonator circuit. This is because the electric current concentrates onto the outermost layers of the circulation paths which generate resonance.

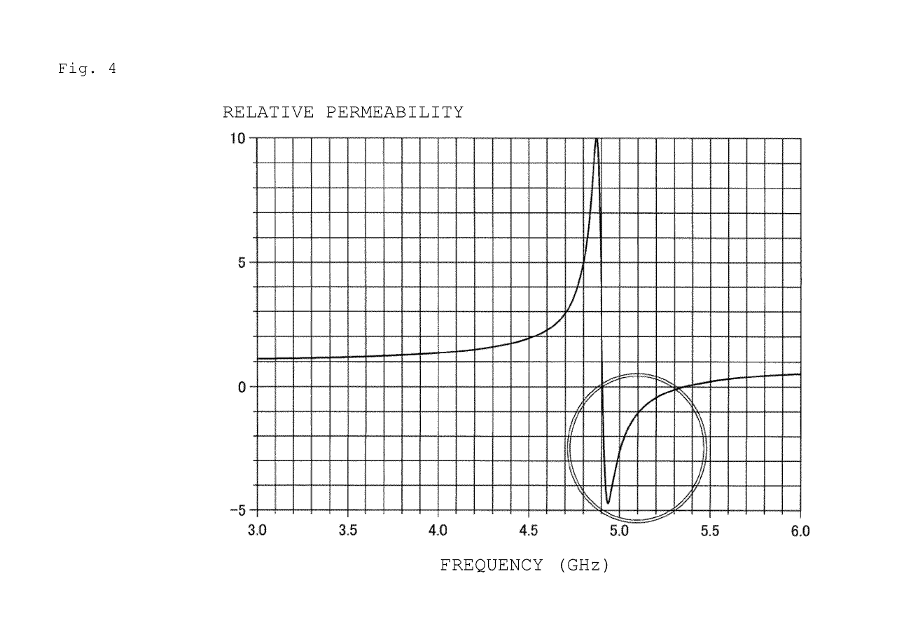

FIG. 4 is a graph showing an example of the frequency characteristic of a relative permeability generated in the capacitor resonator 300. The change characteristic shown in FIG. 4 is calculated by simulation. Here, the relative permeability expresses the ratio of a magnetic permeability to a magnetic permeability in vacuum.

Referring to FIG. 4, the capacitor resonator 300 has a resonant frequency of about 4.9 GHz. The relative permeability is greatly changed therebefore and thereafter, to generate a negative magnetic permeability.

In the above description, each electrode surface of the first inner electrode 4, the second inner electrodes 5, the first outer electrode 2, and the second outer electrode 3 is arranged substantially parallel to the magnetic line of force of the magnetic field. The negative magnetic permeability which is the metamaterial function can thus be exhibited. Here, the wording “substantially parallel” excludes a state in which each electrode surface is orthogonal to the magnetic line of force of a magnetic field, and includes, not only a state in which each electrode surface is quite parallel to the magnetic line of force of a magnetic field, but also a state in which each electrode surface has a predetermined angle with respect to a magnetic line of force. In practical use, when the magnitude of a negative magnetic permeability exhibited in the capacitor resonator 300 is a value which can satisfy the requirement of an application to be applied, it is assumed to be “substantially parallel”.

(Coil Resonator)

A coil resonator which is another kind of resonator used for a metamaterial of this embodiment will be described. While the capacitor resonator exhibits a negative magnetic permeability, the coil resonator can realize a negative dielectric constant when the center axis thereof is parallel to the electric field direction (and at right angle with respect to the magnetic field). In addition, the coil resonator can realize a negative magnetic permeability when the center axis thereof is at right angle with respect to the electric field direction (and parallel to the magnetic field).

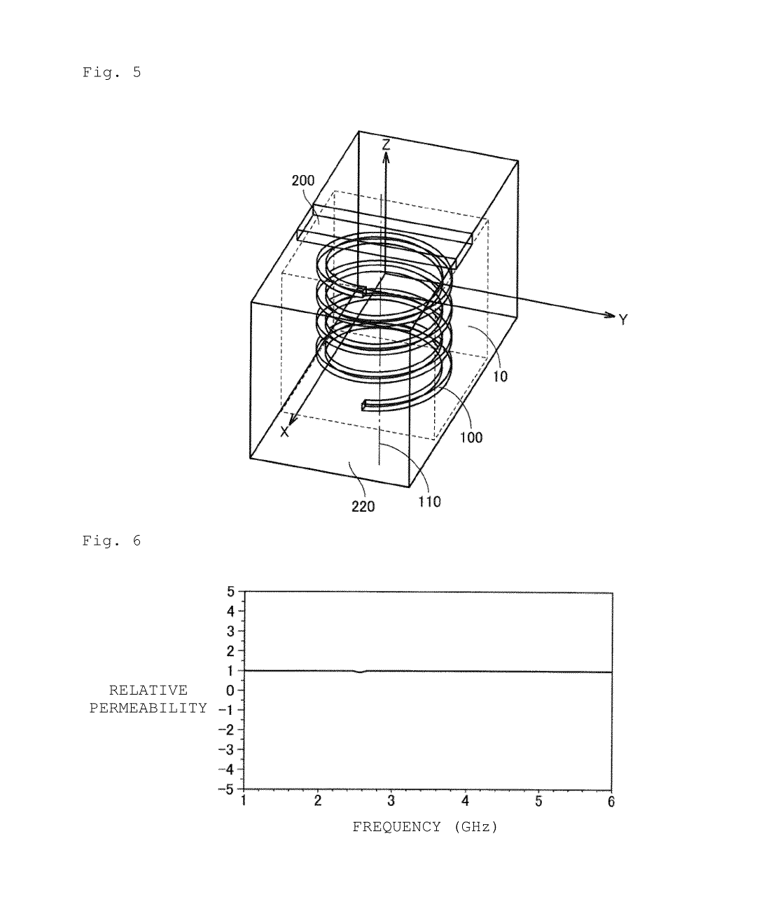

First, the structure of a metamaterial which exhibits a negative dielectric constant by using the coil resonator will be described with reference to FIG. 5. FIG. 5 is an explanatory view of the structure of the metamaterial which exhibits a negative dielectric constant by using the coil resonator.

Referring to FIG. 5, the metamaterial includes a coil resonator 100, and the outer cover 10. The coil resonator 100 is covered by the outer cover 10 which is a non-magnetic body. The coil resonator 100 is arranged between the signal line 200 and the ground 220. The ground 220 is arranged on the surface of the outer cover 10 on the opposite side of the surface of the coil resonator 100 in contact with the signal line 200.

An electric current including a predetermined frequency component flows through the signal line 200. In this embodiment, the signal line 200 is a strip line. However, the signal line 200 is an example of a conductor which flows an electric current therethrough, and is not limited to this.

The coil resonator 100 includes a turned metal wire. The entire length of the coil resonator 100 (the entire length of the metal wire) is about half of the wavelength of the electric current flowing through the signal line 200. Here, the frequency of the electric current flowing through the signal line 200 is in the GHz bandwidth. The coil resonator 100 has a length of 28 mm.

In FIG. 5, the coil resonator 100 has a metal wire which is wound about a center axis 110, that is, has a spring shape. However, the shape of the coil resonator 100 is not limited to the shape of the metal wire wound along the cylindrical surface, which is shown in FIG. 5. For instance, the coil resonator 100 may have a metal wire wound along a square pillar. Alternatively, the coil resonator 100 may have a metal wire wound along a spherical surface.

The coil resonator 100 may have the above length and shape. The coil resonator 100 having a wound metal wire can be used. As the coil resonator 100, an existing coil and a specially-made coil may be used.

The outer cover 10 fixes the position of the coil resonator 100. As the outer cover 10, a resin material, such as Teflon (trademark), is suitable. However, the outer cover 10 is an example of a supporting member which fixes the position of the coil resonator 100, and the coil resonator 100 may be fixed by other members.

The center axis 110 of the coil resonator 100 is parallel to an electric field generated by the electric current flowing through the signal line 200, more specifically, to an electric field generated between the signal line 200 and the ground 220. That is, the outer cover 10 fixes the coil resonator 100 so that the center axis 110 is parallel to the electric field. In other words, the coil resonator 100 is arranged so that the electric potentials at both ends of the coil are different along the gradient of the electric field.

In the example shown in FIG. 5, the center axis 110 is in the direction from the signal line 200 to the ground 220. That is, the center axis 110 is orthogonal to the ground 220 plane, and extends through the signal line 200. By this arrangement, the center axis 110 is parallel to an electric field generated by the electric current flowing through the signal line 200 (and perpendicular to a magnetic field generated by the electric current flowing through the signal line 200).

The coil resonator 100 receives the particular frequency (resonant frequency) of the electric field generated by the electric current flowing through the signal line 200, thereby generating resonance with respect to the signal line 200.

FIGS. 6 and 7 show the electromagnetic characteristic of the coil resonator 100. FIGS. 6 and 7 show a relative permeability and a relative permittivity, which are exhibited by the metamaterial shown in FIG. 5. Here, the relative permittivity expresses the ratio of a dielectric constant to a dielectric constant in vacuum, and the relative permeability expresses the ratio of a magnetic permeability to a magnetic permeability in vacuum. As shown in FIG. 7, the metamaterial in FIG. 5 exhibits a negative dielectric constant near 2.6 GHz. On the other hand, as shown in FIG. 6, the relative permeability is positive at all times.

As described above, the coiled metal wire having a half length of the wavelength exhibits a negative dielectric constant. The metamaterial using the coiled metal wire can be smaller than that which realizes a negative dielectric constant by using a liner metal wire.

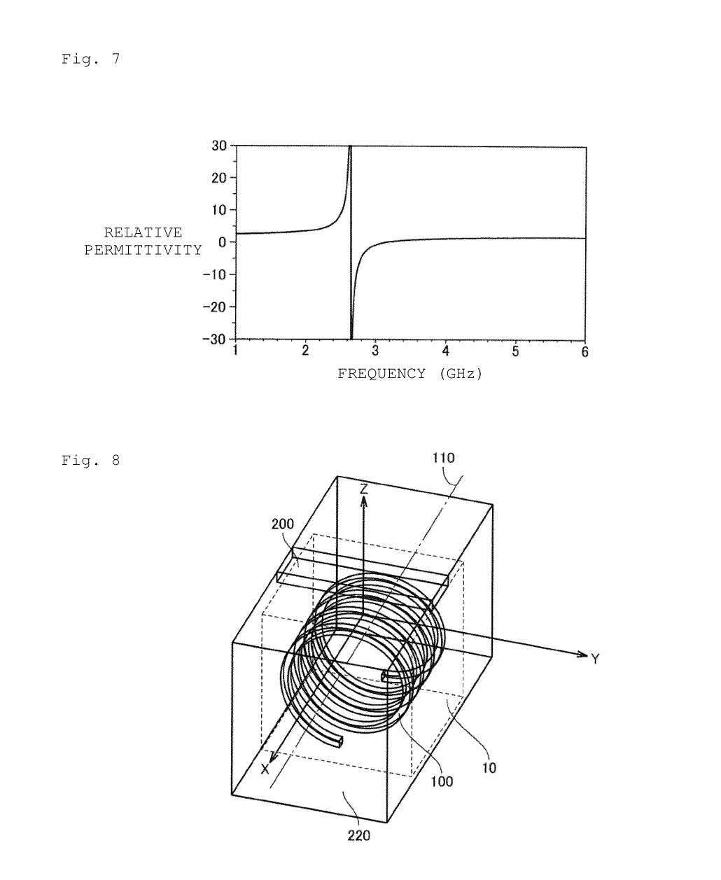

An example in which a metamaterial having negative magnetic permeability (μ) is realized by using a spring-like metal wire will be described. The metamaterial having negative μ is realized by placing the coil resonator 100 which has the same length and shape as the coil resonator 100 shown in FIG. 5 so that the center axis 100 is parallel to a magnetic field. The negative magnetic permeability exhibition of the coil resonator 100 arranged as above will be described below with reference to FIGS. 8 to 10.

FIG. 8 is an explanatory view of the structure of a metamaterial exhibiting a negative dielectric constant by using the coil resonator. The metamaterial shown in FIG. 8 is arranged so that the coil resonator 100 shown in FIG. 6 is rotated 90° about the Y axis so that the center axis thereof is parallel to a magnetic field generated by an electric current flowing through the signal line 200 (and perpendicular to an electric field generated by the electric current flowing through the signal line 200).

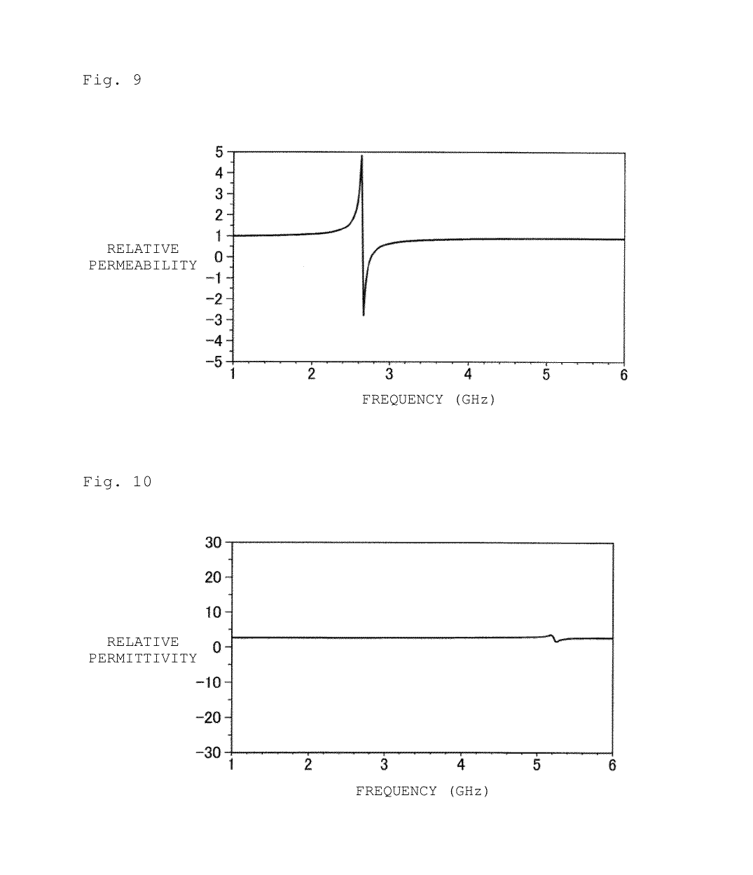

FIGS. 9 and 10 show a relative permeability and a relative permittivity, which are exhibited by the metamaterial shown in FIG. 8. As shown in FIG. 9, the metamaterial in FIG. 8 exhibits a negative magnetic permeability near 2.6 GHz. On the other hand, as shown in FIG. 10, the relative permittivity is positive at all times.

By changing the center axis direction in this manner, the coil resonator 100 having the same structure can exhibit a negative dielectric constant and a negative magnetic permeability. The coil resonator 100 arranged so that the center axis direction is non-orthogonal to the magnetic field direction and the electric field direction exhibits a negative dielectric constant and a negative magnetic permeability at the same time.

### First Embodiment

As a metamaterial according to a first embodiment of the present invention, a coil resonator and a capacitor resonator are arranged side by side.

In order that the combination of these resonators becomes the left-handed metamaterial, that is, to exhibit a negative magnetic permeability and a negative dielectric constant at the same time, the arrangement and structure of the resonators are important. First, the coil resonator and the capacitor resonator are required to be arranged to exhibit a negative dielectric constant and a negative magnetic permeability, respectively. Further, in order that the resonators do not cause inappropriate interference, the structure of the resonators is required to be considered.

To exhibit a negative dielectric constant, the coil resonator may be arranged so that the axis thereof is parallel to the electric field direction (the z direction). On the other hand, to exhibit a negative magnetic permeability, the capacitor resonator may be arranged so that each inner polar plate thereof is parallel to the magnetic field direction, that is, to the plane (x-y plane) in which the z direction forms a normal line.

In addition to the above arranging conditions, the capacitor resonator preferably satisfies the conditions in which two inner electrodes in the outermost portions have reverse phases, that is, the signs of electric charges stored in the inner electrodes are reverse. This is for avoiding the interference between the capacitor resonator and the coil resonator. Hereinafter, this will be described in more detail with reference to FIGS. 11 to 16.

FIG. 11 is a diagram showing a capacitor resonator in which inner electrodes in outermost portions are directly connected to each other and a coil resonator. These resonators are arranged close to each other. However, the coil resonator and the capacitor resonator are not electrically in contact with each other. The coil resonator is placed in an electric field, so that electric charges having different signs appear at both ends. In FIG. 11, a positive electric charge (+ in FIG. 11) appears at the upper end, and a negative electric charge (− in FIG. 11) appears at the lower end. At an anti-resonant frequency, the signs of the electric charges at both ends are reversed to generate an electric field vector in the opposite direction, thereby exhibiting a negative dielectric constant.

On the other hand, the uppermost and lowermost electrodes in FIG. 11 of the capacitor resonator are directly electrically connected to each other by the uppermost electrode by the outer electrode to store electric charges having the same sign. FIG. 11 shows the case that the uppermost and lowermost electrodes have negative electric charges.

In the state shown in FIG. 11, the negative electric charges stored in the lowermost electrode and the lower end of the coil resonator, which are close to each other, interfere with each other. Therefore, the negative dielectric constant and the negative magnetic permeability are not generated at the same time. That is, the anti-resonant frequency of the negative dielectric constant and the anti-resonant frequency of the negative magnetic permeability cannot coincide with each other.

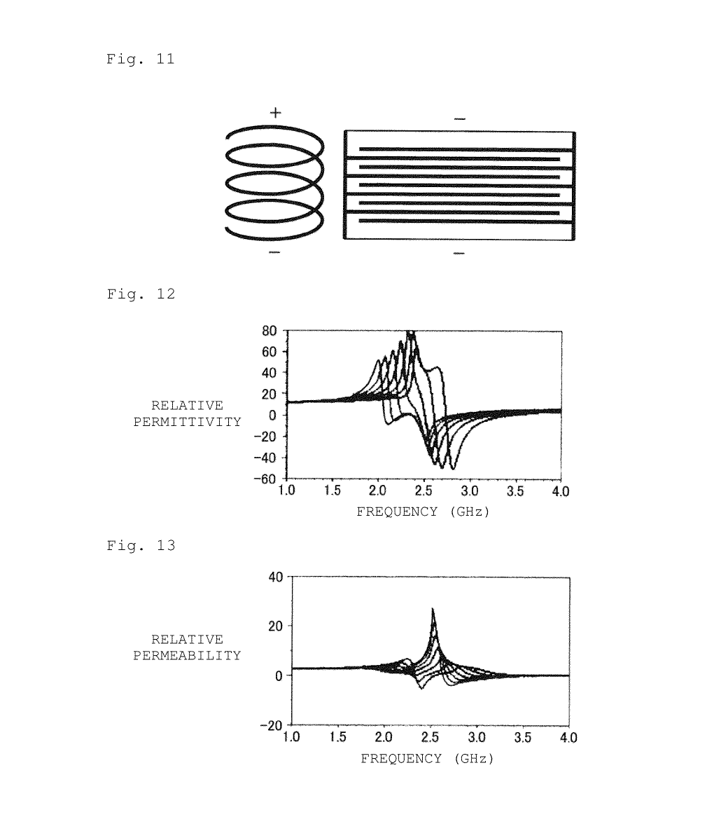

This will be specifically described with reference to FIGS. 12 and 13. FIG. 12 is a chart showing the relative permittivity of the resonators shown in FIG. 11. FIG. 13 is a chart showing the relative permeability of the resonators shown in FIG. 11.

FIG. 12 shows the relative permittivity characteristic of all the resonators when the shape (length) of the coil resonator is changed. The resonant frequency of a dielectric constant is changed according to change in the shape of the coil resonator. The frequency at which a negative dielectric constant is generated is thus changed.

FIG. 13 shows the relative permeability characteristic of all the resonators when the shape (length) of the coil resonator is changed. The resonant frequency of a magnetic permeability is changed according to change in the shape of the coil resonator. The frequency at which a negative magnetic permeability is generated is thus changed. Although the shape of the capacitor resonator is not changed, the resonant frequency of the magnetic permeability is changed due to the interference between the electric charges at the ends of the resonators.

When the shape of the coil resonator is changed in this manner, both of the negative dielectric constant bandwidth and the negative magnetic permeability bandwidth are changed. Due to this, a negative dielectric constant and a negative magnetic permeability cannot be exhibited at the same frequency. When the frequency representing a negative dielectric constant (magnetic permeability) is increased, the frequency representing a negative magnetic permeability (dielectric constant) is also increased. On the contrary, when the frequency representing a negative dielectric constant (magnetic permeability) is decreased, the frequency representing a negative magnetic permeability (dielectric constant) is also decreased. In this way, the resonant frequency of a magnetic permeability (dielectric constant) is away from the resonant frequency of a dielectric constant (magnetic permeability). It is thus difficult to design the resonators so that a negative dielectric constant and a negative magnetic permeability can be exhibited at the same frequency.

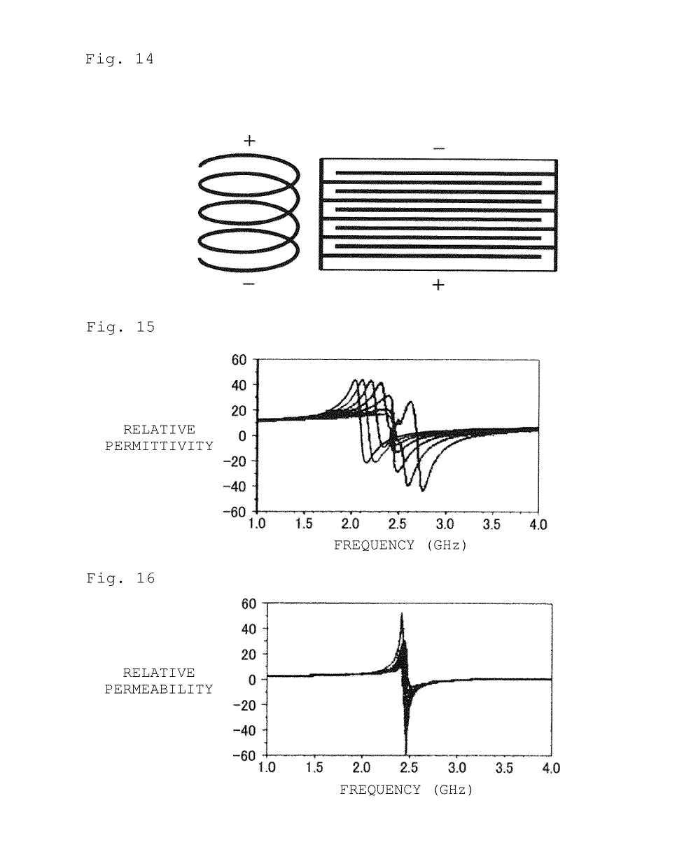

Accordingly, as shown in FIG. 14, in the metamaterial according to this embodiment, two kinds of resonators are arranged. The metamaterial according to this embodiment includes the coil resonator 100, the capacitor resonator 300, and the outer cover 10 (not shown in FIG. 14). As shown in FIG. 11, the outer cover 10 fixes the capacitor resonator and the coil resonator so that they are close to each other. Like the above description, in place of the outer cover 10, other supporting members may be used.

As in FIG. 11, the coil resonator is placed in an electric field, so that electric charges having different signs appear at both ends. As in FIG. 11, also in FIG. 14, a positive electric charge (+ in FIG. 14) appears at the upper end, and a negative electric charge (− in FIG. 14) appears at the lower end. At an anti-resonant frequency, the signs of the electric charges at both ends are reversed to generate an electric field vector in the opposite direction, thereby exhibiting a negative dielectric constant.

On the other hand, the capacitor resonator is different from that shown in FIG. 11. The uppermost and lowermost electrodes in FIG. 14 of the capacitor resonator are not directly electrically connected to each other by the outer electrode, and are connected via electric capacitance. Therefore, the uppermost and lowermost electrodes have reverse phases (and store electric charges having reverse signs). In FIG. 14, the uppermost electrode has a negative electric charge, and the lowermost electrode has a positive electric charge.

Unlike the state shown in FIG. 11, in the state shown in FIG. 14, the interference between the electric charges stored in the lowermost electrode (or the uppermost electrode) and the lower end (or the upper end) of the coil resonator, which are close to each other, can be prevented. Therefore, a negative dielectric constant and a negative magnetic permeability can be generated at the same time. That is, the anti-resonant frequency of the negative dielectric constant and the anti-resonant frequency of the negative magnetic permeability can coincide with each other.

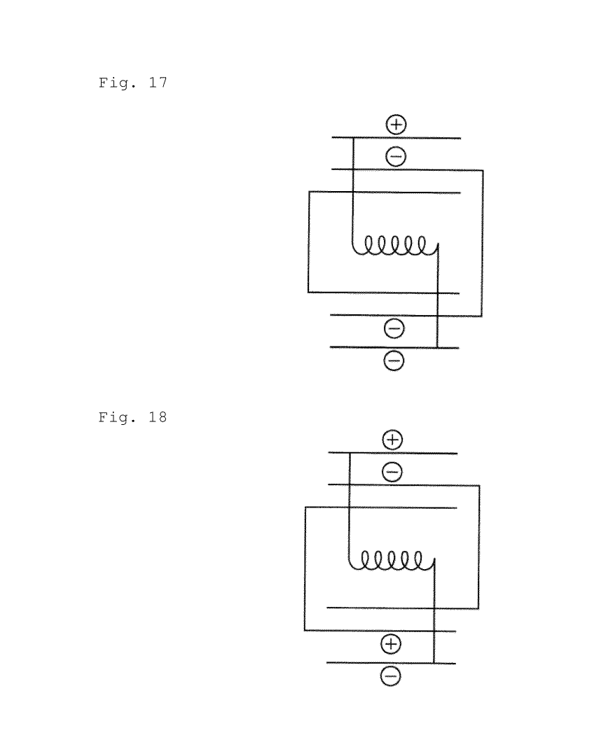

This will be described with reference to FIGS. 15 and 16. FIG. 15 shows the relative permittivity characteristic of all the resonators when the shape of the coil resonator is changed. The resonant frequency of a dielectric constant is changed according to change in the shape of the coil resonator. The frequency at which a negative dielectric constant is generated is thus changed.

FIG. 16 shows the relative permeability characteristic of all the resonators when the shape of the coil resonator is changed. Even when the shape of the coil resonator is changed, the resonant frequency of a magnetic permeability is hardly changed. This is because the interference between the electric charges at the ends of the resonators is prevented and the resonance characteristic of the capacitor resonator is not changed.

As described above, the metamaterial according to this embodiment can generate a negative dielectric constant and a negative magnetic permeability at the same time so as to be the left-handed metamaterial.

In FIG. 14, a set of one coil resonator and one capacitor resonator is shown, but the metamaterial may include plural sets. In this case, for instance, the sets are fixed at positions in which they are one-dimensionally or two-dimensionally continuous by the supporting member.

### Second Embodiment

In the first embodiment, the coil resonator is used as the resonator having negative ∈. However, the present invention is not limited to the coil resonator as the resonator having negative ∈, and can use a resonator which includes a substantially λ/2 line and is resonated with an electromagnetic wave.

In addition, as described in the first embodiment, the resonator having negative ∈ and the resonator having negative μ (in the first embodiment, the capacitor resonator) are not required to be arranged side by side.

In the second embodiment, as the resonator having negative ∈, a resonator including a λ/2 line and two conductive plates connected to both ends of the line is used, and the resonator having negative ∈ is combined with the capacitor resonator having negative μ in a shared space.

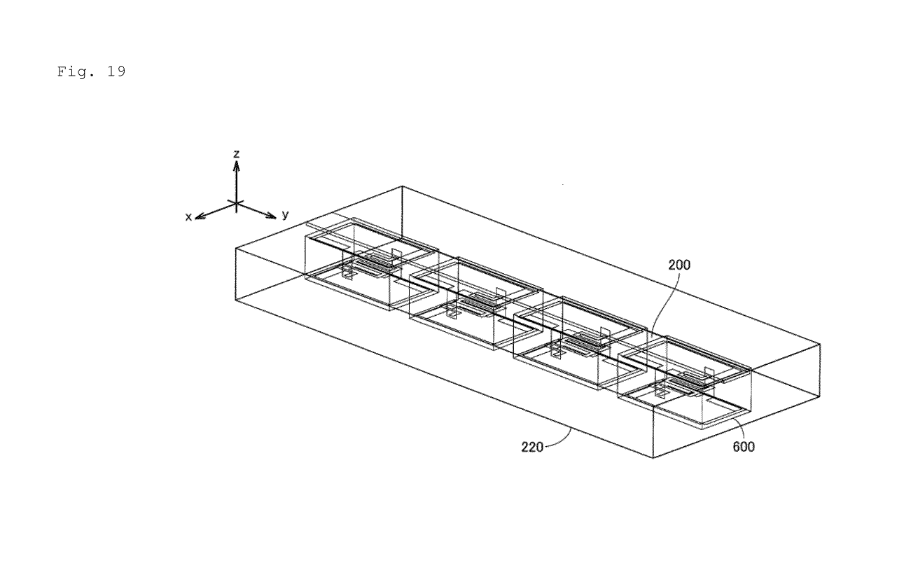

FIGS. 17 and 18 schematically show the structure of a metamaterial according to the second embodiment. FIG. 18 is a schematic diagram of the metamaterial according to the second embodiment. FIG. 17 shows the metamaterial according to the second embodiment in which the structure of the capacitor resonator is changed.

In both of FIGS. 17 and 18, two conductive plates are arranged on the outside of two outermost electrodes of the capacitor resonator so as to be opposite to the respective outermost electrodes. In addition, the conductive plates are connected by a wound line. The line has a length of substantially λ/2 of a resonant wavelength.

The wound line can ensure its length in a small space. However, according to resonant wavelength, and when size reduction is not required, the line is not required to be wound. In addition, FIGS. 17 and 18 show the line wound in coil shape, but size reduction is enabled without being limited to line winding, and can be realized by line bending. For instance, a meandered line may be used.

The capacitance between each conductive plate and the line is increased to increase the absolute value of a negative dielectric constant at a resonant frequency. In addition, the wavelength shortening effect by capacitance can shorten the substantial λ/2 length. According to the value of a negative dielectric constant determined, each conductive plate is not required to be provided. Further, due to the design, the conductive plate may be connected only at one end of the line.

FIGS. 17 and 18 are different in that while in FIG. 17, two outermost electrodes of the capacitor resonator are directly connected to each other, in FIG. 18, two outermost electrodes are not directly connected to each other and have reverse phases. Like the metamaterial according to the first embodiment, the metamaterial according to this embodiment shown in FIG. 18 can prevent the interference between electric charges, and can exhibit a negative dielectric constant and a negative magnetic permeability at the same time. The structure shown in FIG. 17 is difficult to exhibit a negative dielectric constant and a negative magnetic permeability at the same time.

FIG. 19 shows the specific structure of the metamaterial according to this embodiment which is schematically shown in FIG. 18. Referring to FIG. 19, the metamaterial according to this embodiment includes plural units 600 in which each negative dielectric constant resonator and each negative magnetic permeability resonator are made into a substrate material. In each unit, by using the multi-layer substrate technique, each negative dielectric constant resonator and each negative magnetic permeability resonator are made into one chip. In this structure, the substrate material corresponds to the supporting member.

Each unit 600 is arranged directly below the signal line 200 and between the signal line 200 and the ground 220. In addition, the units 600 are continuously arranged in space. In FIG. 19, four units 600 are arranged in the direction along the signal line 200, but are not limited to this arrangement. The resonators arranged in one dimension can also be arrayed in the same plane to structure a planar metamaterial. Further, plural planar metamaterials are superposed on each other to structure a cubic metamaterial.

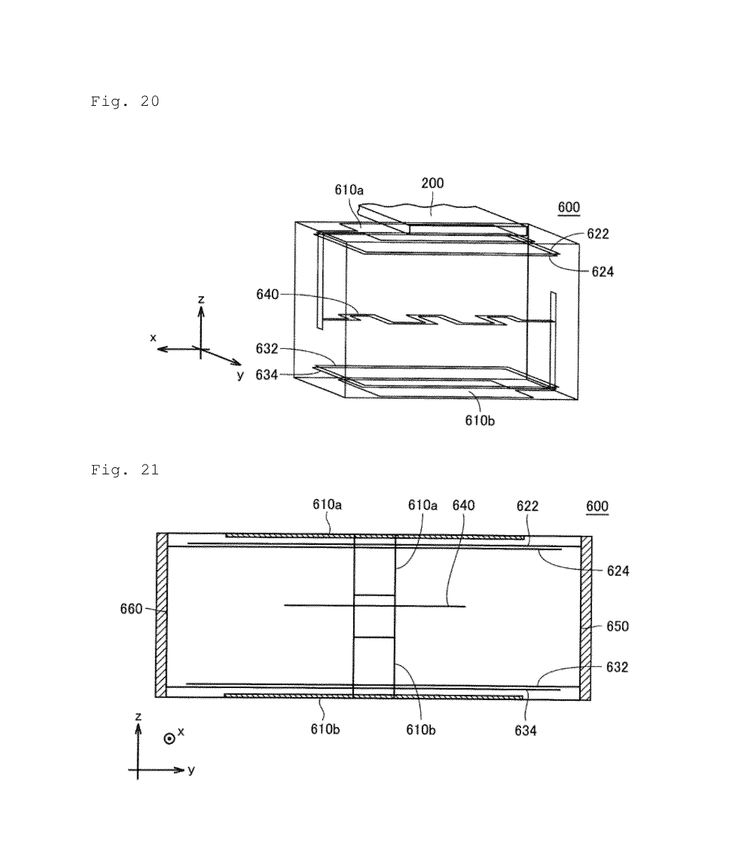

The structure of each unit 600 will be described with reference to FIGS. 20 and 21. FIG. 20 is a perspective view of the unit 600. FIG. 21 is a side view of the unit 600 seen from the y direction.

As shown in FIG. 20, the unit 600 includes an uppermost electrode 610a, a lowermost electrode 610b, a first inner electrode 622, a second inner electrode 624, a third inner electrode 632, a fourth inner electrode 634, and a line 640. As shown in FIG. 21, the unit 600 further includes a first outer electrode 650, and a second outer electrode 660.

The uppermost electrode 610a is arranged above the first inner electrode 622, the second inner electrode 624, the third inner electrode 632, and the fourth inner electrode 634 (at the position in which the z coordinate is large). The lowermost electrode 610b is arranged below the first inner electrode 622, the second inner electrode 624, the third inner electrode 632, and the fourth inner electrode 634 (at the position in which the z coordinate is small). The uppermost electrode 610a has a side surface portion which extends in the −z direction. The lowermost electrode 610b has a side surface portion which extends in the +z direction. In addition, the uppermost electrode 610a is arranged directly below the signal line 200.

The line 640 connects the side surface portion of the uppermost electrode 610a which extends in the −z direction and the side surface portion of the lowermost electrode 610b which extends in the +z direction. The line 640 connects the side surface portion of the uppermost electrode 610a and the side surface portion of the lowermost electrode 610b to function as part of a λ/2 line which realizes a negative dielectric constant.

The line length of the line 640 and the side surface portions is designed according to resonant frequency. Here, to take the λ/2 length, the line 640 is a meandered line on the center layer. However, the shape of the line 640 is not limited to this, and may be e.g., helical and spiral.

The uppermost electrode 610a and the lowermost electrode 610b increase the absolute value of a negative dielectric constant and shorten a resonant wavelength. The resonant wavelength is shorted by the wavelength shortening effect by the capacitance between the uppermost electrode 610a and the signal line. The uppermost electrode 610a and the lowermost electrode 610b can also be omitted according to required negative dielectric constant and resonant frequency.

The first inner electrode 622 and the second inner electrode 624 are arranged close and opposite to each other. In addition, the third inner electrode 632 and the fourth inner electrode 634 are arranged close and opposite to each other. A pair of the first inner electrode 622 and the second inner electrode 624 (called an upper electrode pair) is arranged on the uppermost electrode 610a side. A pair of the third inner electrode 632 and the fourth inner electrode 634 (called a lower electrode pair) is arranged on the lowermost electrode 610b side. Each inner electrode surface is parallel to the direction of a magnetic field generated by an electric current flowing through the signal line 200 (and perpendicular to the electric field direction).

As shown in FIG. 21, the first outer electrode 650 connects the first inner electrode 622 and the third inner electrode 632. As shown in FIG. 21, the second outer electrode 660 connects the second inner electrode 624 and the fourth inner electrode 634. The outer electrode surfaces are parallel to the direction of a magnetic field generated by an electric current flowing through the signal line 200 (and perpendicular to the direction of an electric field).

The line 640, the uppermost electrode 610a, and the lowermost electrode 610b realize a negative dielectric constant. The first to fourth inner electrodes 622, 624, 632, and 634, the first outer electrode 650, and the second outer electrode 660 form a capacitor resonator having two upper electrodes and two lower electrodes, thereby realizing a negative magnetic permeability. Of course, the λ/2 line realizing a negative dielectric constant and the capacitor resonator realizing a negative magnetic permeability are not directly electrically connected to each other. In addition, the λ/2 line and the capacitor resonator are not electrically connected to the signal line 200 and the ground 220, and are isolated. The units 600 are not in contact with each other.

The units 600 are spatially continuously arranged, so that the metamaterial according to this embodiment functions as the left-handed metamaterial. The arrangement of the units 600 is not limited to the above method. For instance, the units 600 may be arranged in two dimensions in the plane.

The metamaterial according to this embodiment is made by making each negative dielectric constant resonator and each negative magnetic permeability resonator into each unit. The metamaterial according to this embodiment can thus be industrially manufactured.

### Third Embodiment

In a third embodiment, a metamaterial uses a split ring resonator in place of the capacitor resonator according to the second embodiment.

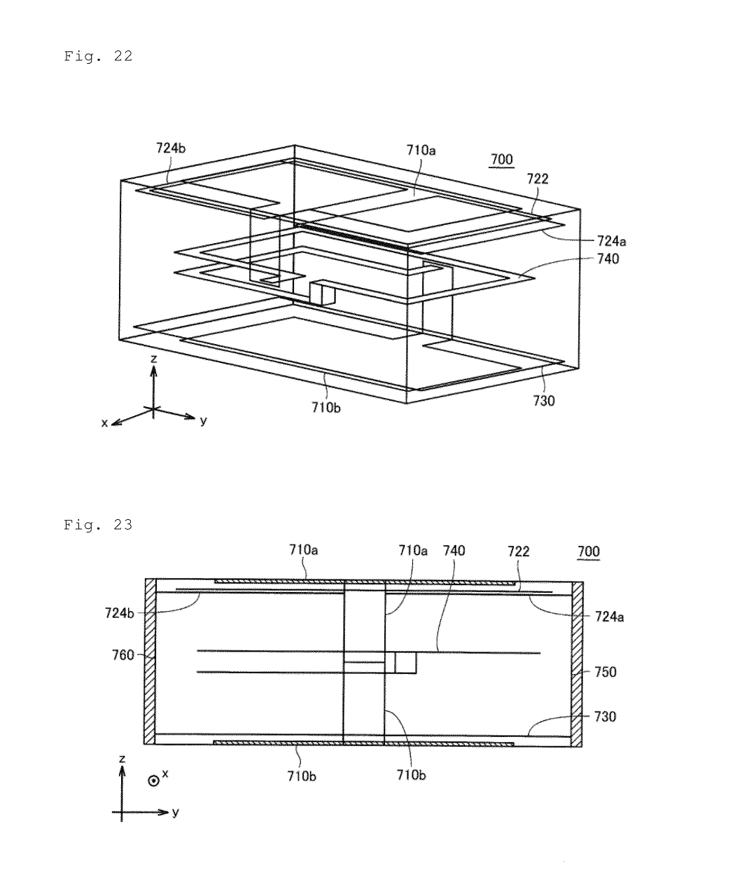

FIGS. 22 and 23 show the structure of a unit 700 of the metamaterial according to the third embodiment. FIG. 22 is a perspective view of the unit 700. FIG. 23 is a side view of the unit 700.

Referring to FIG. 22, the unit 700 includes an uppermost electrode 710a, a lowermost electrode 710b, a first inner electrode 722, a second inner electrode 724a, a third inner electrode 724b, a fourth inner electrode 730, and a line 740. Referring to FIG. 23, the unit 700 further includes a first outer electrode 750, and a second outer electrode 760.

The uppermost electrode 710a and the lowermost electrode 710b have the same structure as the uppermost electrode 610a and the lowermost electrode 610b according to the second embodiment, and are arranged on the outside of the inner electrodes.

The line 740 connects the uppermost electrode 710a and the lowermost electrode 710b. Like the line 640 of the second embodiment, the line 740 functions as part of a λ/2 line to realize a negative dielectric constant. In this embodiment, the line 740 has a helical structure, and makes a one and half-turn in the horizontal plane.

The second inner electrode 724a and the third inner electrode 724b are away from each other in the same plane. The first outer electrode 750 connects the second inner electrode 724a and the fourth inner electrode 730. The second outer electrode 760 connects the third inner electrode 724b and the fourth inner electrode 730. That is, the second inner electrode 724a, the first outer electrode 750, the third inner electrode 724b, the second outer electrode 760, and the fourth inner electrode 730 have the same structure as a split ring resonator. Therefore, these electrodes exhibit a negative magnetic permeability.

The first inner electrode 722 is opposite to the second inner electrode 724a and the third inner electrode 724b so as not to be electrically connected to the second inner electrode 724a and the third inner electrode 724b. The first inner electrode 722 compensates for the electrostatic capacitance in the disconnected portion between the second inner electrode 724a and the third inner electrode 724b to lower a resonant frequency.

### Fourth Embodiment

As another example of the metamaterial in which the negative dielectric constant resonator and the negative magnetic permeability resonator are made into one chip, the negative magnetic permeability resonator can be arranged in the coil therearound. In the fourth embodiment, an example of such a metamaterial is shown.

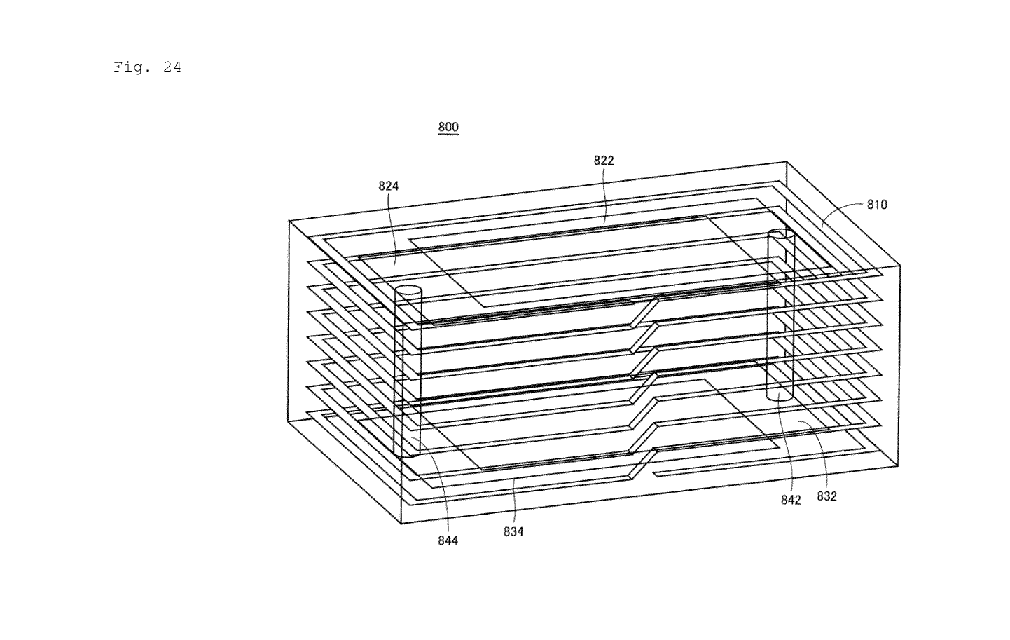

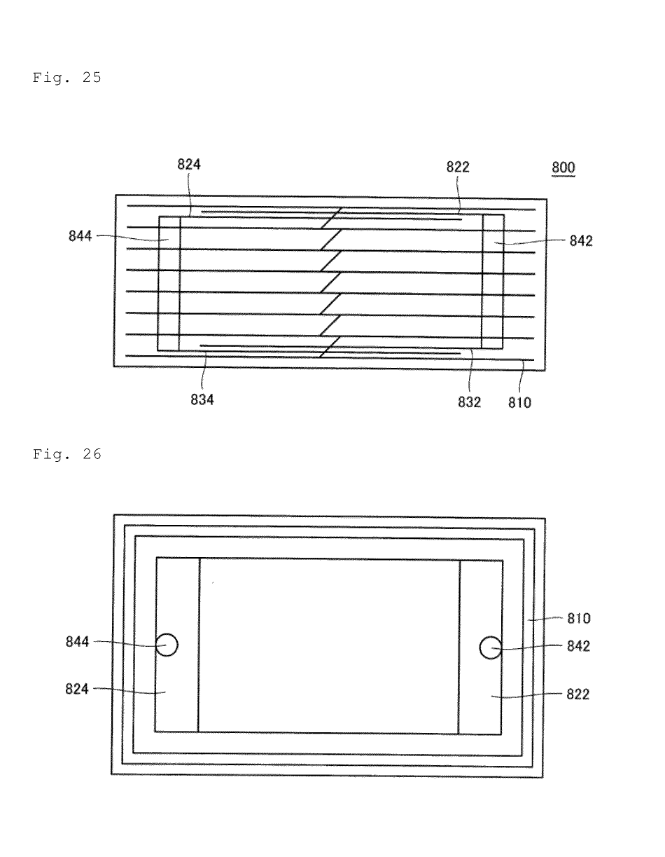

The structure of a unit 800 of the metamaterial according to the fourth embodiment will be described with reference to FIGS. 24 to 26. FIG. 24 is a perspective view of the unit 800. FIG. 25 is a side view of the unit 800. FIG. 26 is a top view of the unit 800.

The unit 800 includes a coiled conductor 810, a first electrode 822, a second electrode 824, a third electrode 832, a fourth electrode 834, a first via 842, and a second via 844.

The coiled conductor 810 makes plural turns (in the example shown here, eight turns) about the region close to the surfaces of the unit 800. The coiled conductor 810 surrounds the first electrode 822, the second electrode 824, the third electrode 832, the fourth electrode 834, the first via 842, and the second via 844.

The first electrode 822 and the second electrode 824 are arranged close and opposite to each other. In addition, the first electrode 822 and the second electrode 824 are shifted from each other in the horizontal plane.

The third electrode 832 and the fourth electrode 834 are arranged close and opposite to each other. In addition, the third electrode 832 and the fourth electrode 834 are shifted from each other in the horizontal plane.

A pair of the first electrode 822 and the second electrode 824 is formed in the upper portion in the unit 800. A pair of the third electrode 832 and the fourth electrode 834 is formed in the lower portion in the unit 800. The upper and lower portions herein follow FIGS. 24 and 25.

The first via 842 connects the first electrode 822 and the third electrode 832. In addition, the second via 844 connects the second electrode 824 and the fourth electrode 834.

By the above structure, the first to fourth electrodes 822, 824, 832, and 834, the first via 842, and the second via 844 function as a capacitor resonator to exhibit a negative magnetic permeability.

As compared with the second and third embodiments, according to the structure of this embodiment, the size of each unit can be maintained, and the length of the line (coil) can be longer. Therefore, a low resonant frequency can be obtained.

### Fifth Embodiment

In each unit (metamaterial unit) which makes the metamaterial according to the third and fourth embodiments, the negative magnetic permeability resonator has the outer electrode which connects the inner electrodes. On the contrary, in the negative magnetic permeability resonator according to this embodiment, a conductive portion which connects inner electrodes is realized by a via.

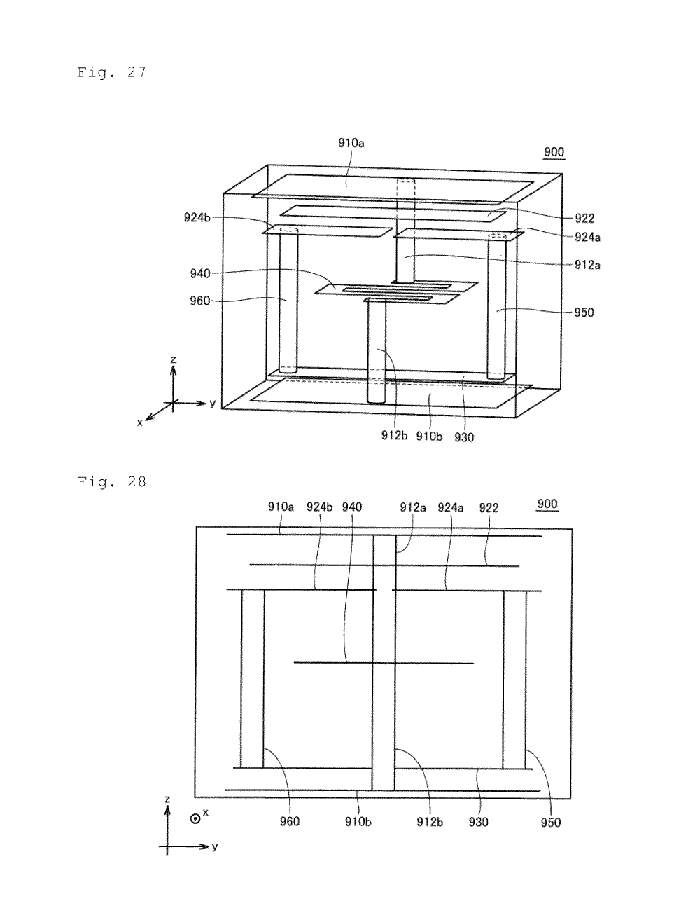

FIGS. 27 to 29 show the structure of a metamaterial unit 900 according to the fifth embodiment. FIG. 27 is a perspective view of the unit 900. FIG. 28 is a front view of the unit 900. FIG. 29 is a side view of the unit 900.

Referring to FIGS. 27 to 29, the unit 900 includes an uppermost electrode 910a, a first via 912a, a second via 912b, a lowermost electrode 910b, a first inner electrode 922, a second inner electrode 924a, a third inner electrode 924b, a fourth inner electrode 930, a line 940, a third via 950, and a fourth via 960.

The first via 912a, the line 940, and the second via 912b connect the uppermost electrode 910a and the lowermost electrode 910b.

The entire length of the first via 912a, the line 940, and the second via 912b is substantially half of the resonant wavelength. The first via 912a, the line 940, and the second via 912b function as part of a λ/2 line to realize a negative dielectric constant. The shape of the line 940 is not limited to the shown meandered shape, and may be e.g., helical and spiral.

Like the uppermost electrode 610a and the lowermost electrode 610b shown in FIG. 21, the uppermost electrode 910a and the lowermost electrode 910b increase the absolute value of a negative dielectric constant and shorten a resonant wavelength. However, the uppermost electrode 910a and the lowermost electrode 910b can also be omitted.

The outer end of the first via 912a (the end which is not connected to the line 940) and the outer end of the second via 912b (the end which is not connected to the line 940) are preferably located on the outside of the negative magnetic permeability resonator so that electric charges are stored at both ends of the λ/2 line regardless of the presence or absence of the uppermost electrode 910a and the lowermost electrode 910b.

The third via 950 connects the second inner electrode 924a and the fourth inner electrode 930. The fourth via 960 connects the third inner electrode 924b and the fourth inner electrode 930. The second inner electrode 924a, the third via 950, the third inner electrode 924b, the fourth via 960, and the fourth inner electrode 930 have the same structure as a sprit ring resonator, and function as the resonator which exhibits a negative magnetic permeability. Like the first inner electrode 722 of the fourth embodiment, the first inner electrode 922 compensates for the electrostatic capacitance in the disconnected portion between the second inner electrode 924a and the third inner electrode 924b to lower a resonant frequency.

The unit 900 according to this embodiment does not require any outer electrodes. The unit can thus be easily manufactured. When the unit including outer electrodes is made, typically, the portions other than the outer electrodes are stacked, and are then stuck onto a component in which the outer electrodes are stacked. On the other hand, the unit 900 according to this embodiment can be made only by layer stacking.

In addition, the unit 900 is preferable for making the metamaterial in which plural units are arrayed. When the units having outer electrodes are contacted onto each other, an electric current which flows through the outer electrodes in one unit also flows through the outer electrodes in the other unit, so that electromagnetic wave resonance cannot occur appropriately. Therefore, the units are required to be away from each other and to be subjected to unit processing of covering each outer electrode with an insulator. The units 900 according to this embodiment can be adjacent to each other, so that the metamaterial can be smaller. In addition, the processing is not necessary, so that the metamaterial using the unit 900 can be easily made.

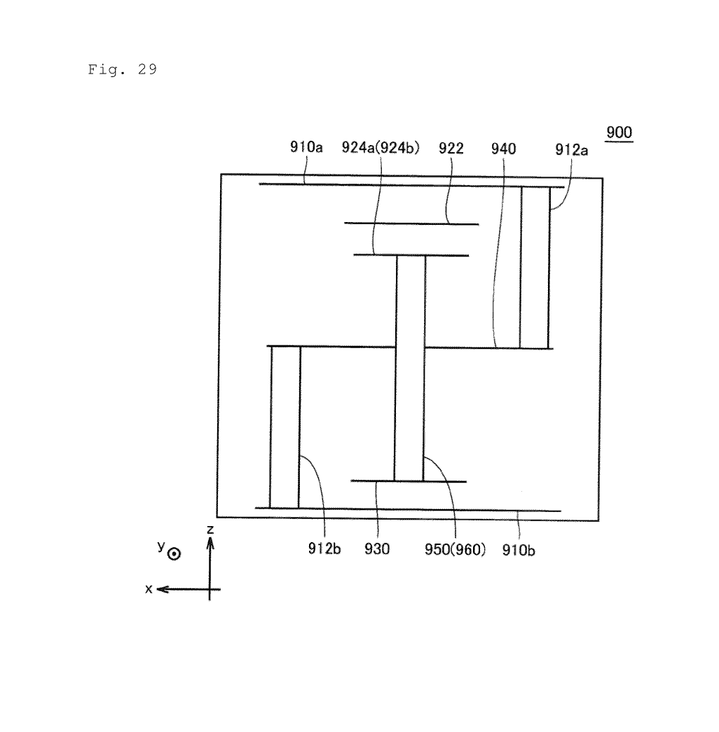

A method for making the unit 900 will be described with reference to FIG. 30. FIG. 30 is an explanatory view of the method for making the unit 900 according to a fifth embodiment.

Referring to FIG. 30, the unit 900 is made by sequentially stacking plural layers. FIG. 30 shows layers L1 to L6 including the main components of the unit 900. The material of each layer (substrate material) is an insulating material, such as a resin. Metal components are formed on the substrate materials of some layers. In addition, vias are formed in the substrate materials of some layers to extend through the substrate materials. FIG. 30 shows part of layers L1 to L6. Actually, layers L1 to L6 extend in the lateral direction in FIG. 30.

On each of layers L1 to L6, arranged are the components of plural (in FIG. 30, 3×3) units which are periodically arranged. Layer L1 includes plural lowermost electrodes 910b. Layer L2 includes plural fourth inner electrodes 930. Layer L3 includes plural lines 940. Layer L4 includes plural pairs of the second inner electrode 924a and the third inner electrode 924b. Layer L5 includes plural first inner electrodes 922. Layer L6 includes plural uppermost electrodes 910a.

In addition, the vias are formed in the regions of the layers corresponding to the first via 912a, the second via 912b, the third via 950, and the fourth via 960. In FIG. 30, the vias are indicated by the thin lines in the vertical direction.

The layers are stacked to make a stacking body. Then, the stacking body is cut to make each unit 900. Nine units 900 can be made from the portions shown in FIG. 30. Without separating the stacking body into each unit 900, some units 900 may be integrated to be cut out from the stacking body.

In this embodiment, the conductive portions of the split resonator shown in the third embodiment are the vias, but the conductive portions of a different type resonator can also be the vias. For instance, the outer electrodes of the multi-layer capacitor resonator shown in the second embodiment may be the vias.

### Sixth Embodiment

In each metamaterial unit according to the second, third, and fifth embodiments, the line which exhibits a negative dielectric constant is formed in the LC resonator (specifically, a multi-layer capacitor resonator, and a split resonator). However, the line is not necessarily required to be in the LC resonator. In the sixth embodiment, a unit 1000 in which a λ/2 line is arranged on the outside of the LC resonator is described.

FIG. 31 shows the structure of the unit 1000 according to the sixth embodiment. FIG. 31 is a diagram showing the structure of the unit 1000 according to the sixth embodiment.

Referring to FIG. 31, the unit 1000 includes an uppermost electrode 1010a, a first via 1012, a lowermost electrode 1010b, a first inner electrode 1022, a second inner electrode 1024a, a third inner electrode 1024b, a fourth inner electrode 1030, a second via 1050, and a third via 1060.

The first via 1012 connects the uppermost electrode 1010a and the lowermost electrode 1010b. The length of the first via 1012 is substantially half of a resonant wavelength. Therefore, the first via 1012 exhibits a negative dielectric constant with respect to an electromagnetic wave having the resonant wavelength.

In this embodiment, the uppermost electrode 1010a and the lowermost electrode 1010b are connected by the linear first via 1012. However, like the structure shown in FIG. 27, plural vias and the line in the horizontal plane may be combined to realize the λ/2 line. As described in other embodiments, to make the unit smaller, the line in this case is preferably meandered.

Like the uppermost electrode 910a and the lowermost electrode 910b according to the fifth embodiment, the uppermost electrode 1010a and the lowermost electrode 1010b increase the absolute value of a negative dielectric constant and shorten a resonant frequency.

The second inner electrode 1024a, the second via 1050, the third inner electrode 1024b, the fourth inner electrode 1030, the third via 1060, and the third inner electrode 1024b have the same structure as a split ring resonator, and function as the negative magnetic permeability resonator. Like the first inner electrode 722 of the fourth embodiment, the first inner electrode 1022 compensates for the electrostatic capacitance in the disconnected portion between the second inner electrode 1024a and the third inner electrode 1024b to lower a resonant frequency.

The first inner electrode 1022, the second inner electrode 1024a, the second via 1050, the third inner electrode 1024b, the third via 1060, and the fourth inner electrode 1030 are arranged in the space sandwiched between the uppermost electrode 1010a and the lowermost electrode 1010b. That is, in the unit according to this embodiment, the negative magnetic permeability resonator is formed in the negative dielectric constant resonator.

Like the unit 900 according to the fifth embodiment, the unit 1000 according to this embodiment connects the inner electrodes by the vias. The unit 900 can thus be easily made. In addition, the unit 1000 has no electrodes on the surfaces of the unit. The unit 1000 is thus preferable for making the metamaterial.

[Addition]

The resonator position relation in order that a metamaterial exhibits a negative dielectric constant and a negative magnetic permeability at the same time at a certain resonant frequency will be summarized. Here, this will be described by giving a metamaterial (or metamaterial unit) which combines a split ring resonator and a half-wavelength resonator, described in the fifth embodiment.

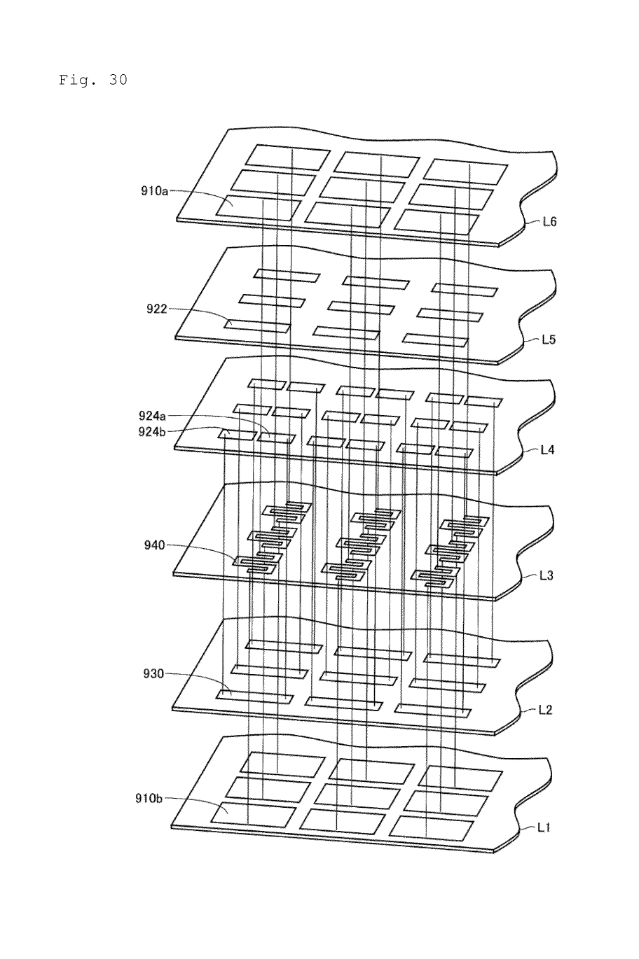

FIG. 32 is a schematic diagram of the position relation between a metamaterial which combines a split ring resonator 1210 and a half-wavelength resonator 1220, the signal line 200, and the ground 220. As described in the fifth embodiment, the metamaterial exhibits a negative magnetic permeability and a negative dielectric constant at the same time. This is because when the metamaterial is resonated with an electromagnetic field, the electric field concentration regions and the magnetic field concentration region are not overlapped with each other.

The electric field concentration region will be described with reference to FIG. 33. FIG. 33 is a schematic diagram of the state of electric charges and electric fields when the metamaterial shown in FIG. 32 exhibits a negative dielectric constant. Referring to FIG. 33, the half-wavelength resonator 1220 includes a first outermost electrode 1222, a second outermost electrode 1224, and a line 1226. The first outermost electrode 1222 is arranged on the signal line 200 side. The second outermost electrode 1224 is arranged on the ground 220 side.

FIG. 33 shows a state in which an electric current flows through the signal line 200 to generate electric fields from the signal line 200 to the ground 220. When the electric current having a resonant frequency flows, a negative electric charge is stored in the first outermost electrode 1222, and a positive electric charge is stored in the second outermost electrode 1224. Then, a large electric field is generated in a region 1230 between the first outermost electrode 1222 and the signal line 200, and a large electric field is generated in a region 1240 between the second outermost electrode 1224 and the ground 220.

That is, each of the region which is sandwiched between the end of the half-wavelength resonator 1220 in which the electric charge is stored by the half-wavelength resonance and the signal line 200 and the region which is sandwiched between the end of the half-wavelength resonator 1220 in which the electric charge is stored by the half-wavelength resonance and the ground is the electric field concentration region by resonance. Here, the electrodes connected to both ends of the half-wavelength line correspond to the ends of the half-wavelength resonator 1220. However, when the half-wavelength resonator 1220 does not include the electrodes, both ends of the half-wavelength line correspond to the ends of the half-wavelength resonator 1220.

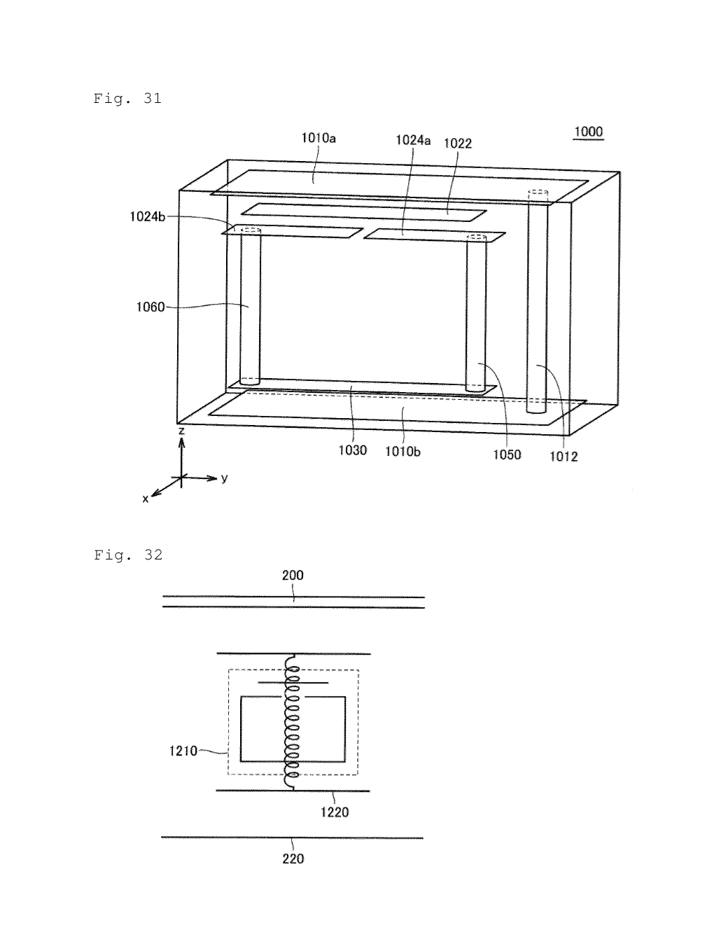

The magnetic field concentration region will be described with reference to FIG. 34. FIG. 34 is a schematic diagram of the state of a magnetic field when the metamaterial shown in FIG. 32 exhibits a negative magnetic permeability. Referring to FIG. 34, the split ring resonator 1210 includes a first conductor 1212, and a second conductor 1214.

FIG. 34 shows a state in which an electric current flows through the signal line 200 to generate a magnetic field from the split ring resonator 1210. When the electric current having a resonant frequency flows, the electric current and the split ring resonator 1210 are LC resonated, so that a large magnetic field which cancels the magnetic field generated by the electric current flowing through the signal line 200 is generated in a region 1250 in the second conductor 1214. The generated magnetic field is mainly orthogonal to the sheet.

That is, the inner region in the loop generated by the LC resonance is the magnetic field concentration region by resonance. In other words, the space surrounded by the capacitance forming-electrode pair and the inductance forming-conductive portion is the magnetic field concentration region by resonance.

Comparing FIGS. 33 and 34, the electric field concentration regions (the regions 1230 and 1240) and the magnetic field concentration region (the region 1250) are away from each other. Therefore, the electric field generated by resonance in the half-wavelength resonator 1220 hardly affects the resonance in the split ring resonator 1210, and vice versa. Therefore, the metamaterial shown in FIG. 32 can exhibit a negative dielectric constant and a negative magnetic permeability at the same time. In the metamaterial having the structure shown in FIG. 32, the magnetic field generated by magnetic permeability resonance concentrates onto the region different from the electric field concentration regions generated by dielectric constant resonance.

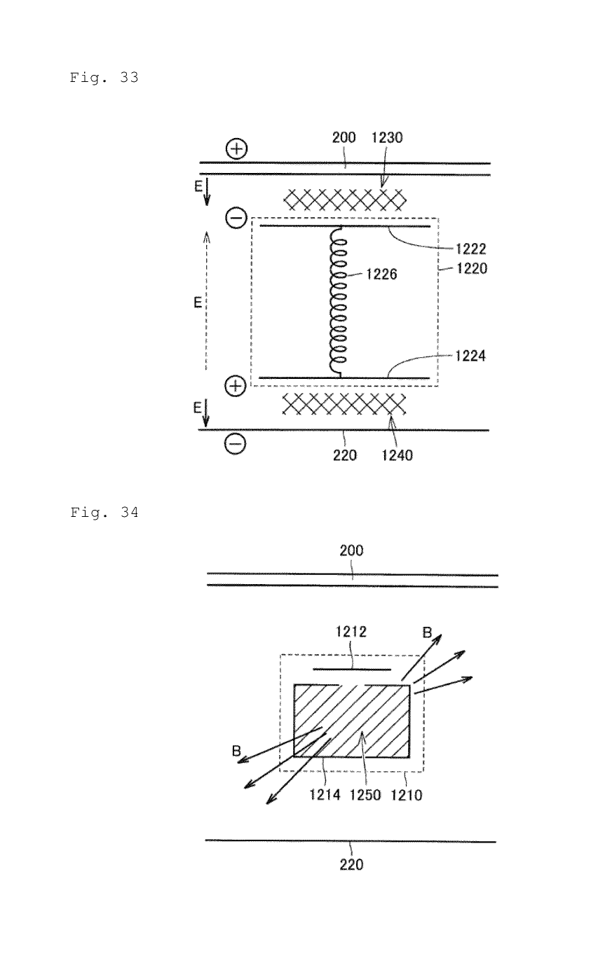

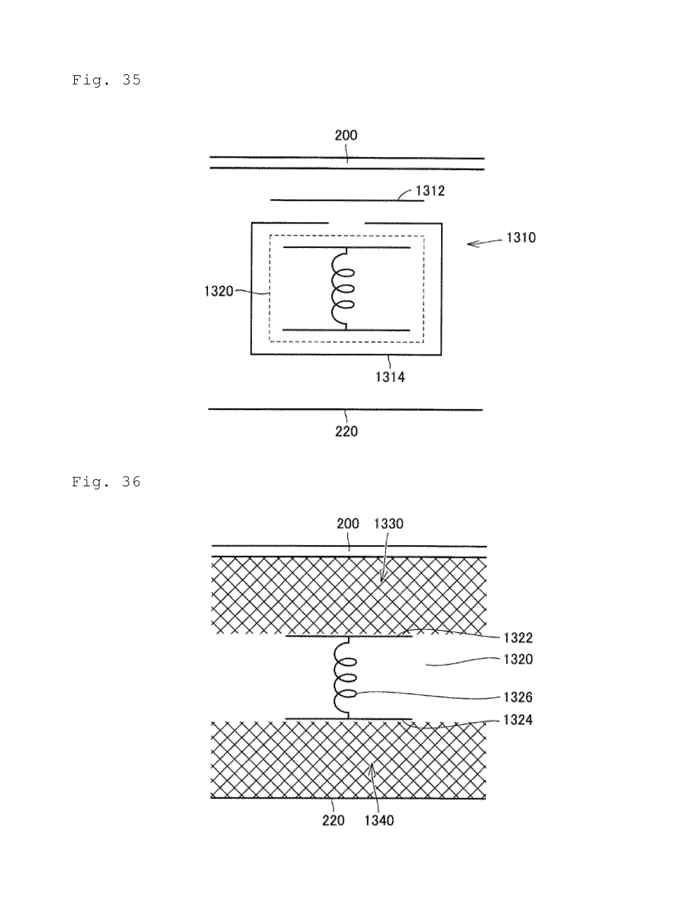

For comparison, a metamaterial in which the position relation between the split ring resonator and the half-wavelength resonator is changed will be described with reference to FIGS. 35 to 37.

FIG. 35 is a schematic diagram of the position relation between the metamaterial which has a resonator arrangement different from that of the metamaterial in FIG. 34, the signal line 200, and the ground 220.

The metamaterial shown in FIG. 35 includes a split ring resonator 1310, and a half-wavelength resonator 1320. The split ring resonator 1310 includes a first conductor 1312, and a second conductor 1314. The entire half-wavelength resonator 1320 is arranged in the second conductor 1314.

In this metamaterial, when the metamaterial is resonated with an electromagnetic field, the electric field concentration regions and the magnetic field concentration region are overlapped with each other. Therefore, it is somewhat difficult to stably exhibit a negative magnetic permeability and a negative dielectric constant at the same time.

FIG. 36 shows the electric field concentration regions. FIG. 36 is an explanatory view of the electric field concentration regions when the metamaterial shown in FIG. 35 exhibits a negative dielectric constant. Referring to FIG. 36, the half-wavelength resonator 1320 includes a first outermost electrode 1322, a second outermost electrode 1324, and a line 1326. The first outermost electrode 1322 is arranged on the signal line 200 side. The second outermost electrode 1344 is arranged on the ground 220 side.

When a negative dielectric constant is generated, a large electric field is generated in a region 1330 between a first outermost electrode 1322 and the signal line 200 and a large electric field is generated in a region 1340 between a second outermost electrode 1324 and the ground 220.

The magnetic field concentration region will be described with reference to FIG. 37. FIG. 37 is an explanatory view of the magnetic field concentration region when the metamaterial shown in FIG. 35 exhibits a negative magnetic permeability. When a negative magnetic permeability is exhibited, a large magnetic field in the direction canceling a magnetic field generated by an electric current flowing through the signal line 200 is generated in a region 1350 in the second conductor 1314.

Comparing FIGS. 36 and 37, part of the electric field concentration regions (the regions 1330 and 1340) and part of the magnetic field concentration region (the region 1350) are overlapped with each other. Therefore, the electric field generated by the resonance in the half-wavelength resonator 1220 affects the resonance in the split ring resonator 1210, and vice versa. Therefore, the metamaterial shown in FIG. 35 is somewhat difficult to exhibit a negative dielectric constant and a negative magnetic permeability at the same time.

The above description applies to metamaterials having other kinds of resonators. For instance, a metamaterial in which a split resonator is replaced with a multi-layer capacitor resonator applies to the above description.

However, as described in the first and second embodiments, when the multi-layer capacitor resonator is used, preferably, electric charges having the same polarity do not interfere with each other. That is, the resonator is preferably structured so that electric charges having the same polarity are generated to be away from each other to the extent that the exhibitions are not influenced with each other. Specifically, of plural electrodes forming electrostatic capacitance, the polarities of two outermost electrodes are preferably reverse.

### Seventh Embodiment

The metamaterials alone have been described in the first to sixth embodiments. In a seventh embodiment, an antenna using a metamaterial will be described.

FIG. 38 is a diagram showing the transmission of an electromagnetic wave on a transmission line for each value range of magnetic permeability μ and dielectric constant ∈. Referring to FIG. 38, in the region in which μ>1 and ∈>1 and the region in which μ<0 and ∈<0 (above-described left-handed region), an electromagnetic wave is transmitted without being attenuated.

In the region in which μ>1 and ∈>1, when Å is brought close to 1 and μ is brought close to infinite, the impedance can be sufficiently increased. An electromagnetic wave can thus be cut off. However, in materials in the natural world in the region in which μ>1 and ∈>1, actually, μ cannot be brought close to infinite. An electromagnetic wave cannot thus be cut off.

However, the metamaterial enables the region in which μ<0 and ∈<0, and can take the value of 0<∈<1, which is not enabled in materials in the natural world. Accordingly, ∈ is brought close to 0 so that the impedance can be theoretically brought close to infinite. An electromagnetic wave can thus be cut off.

In addition, the use of the “evanescent solution region” in which any one of ∈ and μ is negative can cut off an electromagnetic field. Further, these are combined so that ∈=0 and μ<0, which can increase the cutoff effect. The use of the metamaterial in such a region can form a high impedance region.

As such a metamaterial, MLCC (multi-layer ceramic capacitor) which can exhibit a negative magnetic permeability, described in the first embodiment, may be used, and a split ring resonator may be used. The helical coil which can exhibit a negative dielectric constant, described in the first embodiment, may be used. A chip coil may be used. A metal thin wire resin may be used.

An LC resonator, a half-wavelength resonator, and a left-handed metamaterial chip may be used. As the half-wavelength resonator, a λ/2 metal wire which is not particularly shaped may be used. As described later in FIG. 40, when a ground is provided on the opposite side of a region 2000 of a metal housing 2001 across a metamaterial, a λ/4 resonator may be used.

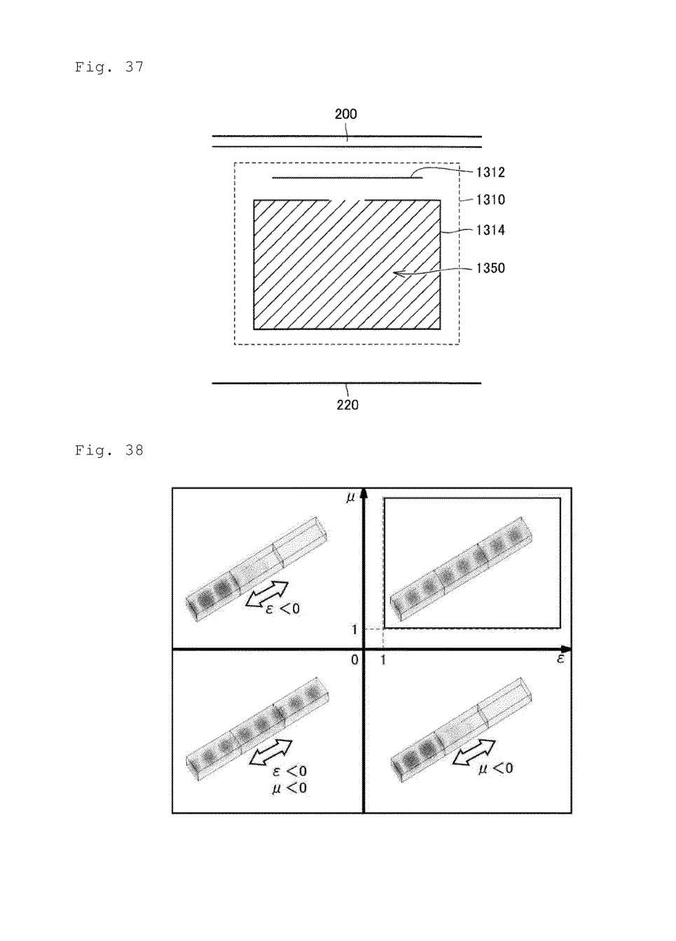

FIG. 39 is a diagram showing an antenna using metamaterials 2100 according to a seventh embodiment. Referring to FIG. 39, plural metamaterials 2100 are stuck onto the inside of the metal housing 2001 in the region which sections the region 2000 to function as an antenna from other regions.

Thereby, the portion of the metal housing 2001 onto which the metamaterials 2100 are stuck is one of the region which greatly cuts off the near resonant wavelength components of the electromagnetic waves of the metamaterials 2100 equivalent to a high impedance region and the region which substantially cuts off the electromagnetic wave components. Therefore, the region 2000 is isolated from other regions in the resonance with the resonant wavelength components of the electromagnetic fields.

Therefore, when electricity is supplied from a circuit substrate 2300 to the region 2000 via an electricity supply line 2200, the region 2000 is electromagnetically isolated from other regions to function as an antenna resonated with the electromagnetic waves having the near resonant wavelength components of the metamaterials 2100 in the electromagnetic field. As a result, part of the metal housing 2001 can function as an antenna. That is, even when the entire surface of the metal housing 2001 is formed of a metal, an antenna is not required to be provided on the outside. Thus, part of the housing is not required to be opened, and is not required to be an insulator. Therefore, the cost can be lowered, the design can be flexible, and the strength cannot be lowered.

On the circuit substrate, mounted are a circuit (e.g., a tuning circuit, an amplifier circuit, and an output circuit) which supplies electricity to the electricity supply point in the region 2000 functioning as an antenna via the electricity supply line 2200, and a circuit which processes the electromagnetic wave near the resonant wavelength resonated in the region 2000 functioning as an antenna.

The region 2000 functioning as an antenna is not limited to the rectangular antenna shown in FIG. 39 so that the length of each long side is λ/4 and the length of each short side is less than λ/4. A λ/4 strip-like antenna may be used. The line may have a meandered shape for space saving, an inverted F shape, a folded dipole shape, and other shapes.

The bandwidth of the EBG (Electromagnetic Band Gap) of the metamaterial is narrow. When the metamaterials 2100 having slightly different resonant frequencies (resonant wavelengths) are mixed, the bandwidth of the antenna structured of the region 2000 can be wider.

The EBG of CRLH (Composite Right/Left-Handed) of the mushroom structure in Patent Documents 2 and 3 is required to form electrostatic capacitance on the surface onto which a signal flows. Therefore, like the mushroom structure, a slit is required to be provided. Consequently, the surface of the metal housing cannot be directly used.

On the other hand, like this embodiment, when the resonant metamaterial is used, the front side of the metal housing is directly used to stick the metamaterial onto the back side thereof, so that the particular region 2000 can be electromagnetically isolated. Therefore, there is a merit in the strength and design of the metal housing.

When like the conventional art, part of the metal housing of a notebook PC is formed of a resin to mount an antenna in that portion, the resin portion is small. The antenna mounted position is thus limited.

However, when the antenna is structured like this embodiment, the entire housing of an electric apparatus, such as the top plate of a notebook PC, can be formed of a metal to function as an antenna, so that the antenna area can be larger. Plural antennas can thus be mounted. In addition, even when plural antennas are provided in the same metal housing, the antenna portions are isolated by the EBG, and cannot be electromagnetically coupled to each other.

Since the large area can be used, wavelength shortening by a dielectric is not required. Therefore, as compared with a small dielectric antenna, the antenna of this embodiment is more advantageous in gain and bandwidth.

The antenna using the EBG of the metamaterial is more disadvantageous than the metal antenna having the same size in terms of bandwidth and gain. However, as described above, the merit in which the antenna area is not limited can compensate for such disadvantageous points.

FIG. 40 is a diagram showing in more detail the antenna using the metamaterials 2100 according to the seventh embodiment. Referring to FIG. 40, a ground 2400 may be provided on the opposite side of the region 2000 of the metal housing 2001 across the metamaterials. In addition, the periphery of the ground 2400 may be connected to the metal housing 2001. Thereby, the portion which functions as a shield remains, and the radiation surface of the antenna is mainly on the outside of the metal housing 2001. Accordingly, the noise problem can also be eliminated.

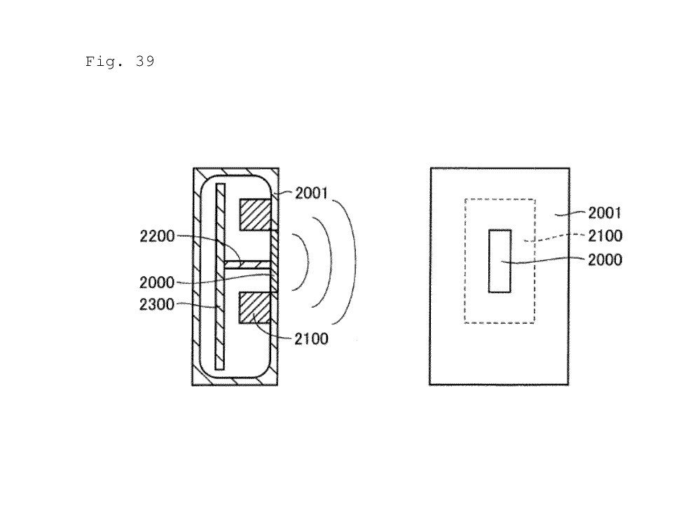

FIG. 41 is a diagram showing an example of a structure which forms an antenna using the metamaterial 2100 according to the seventh embodiment. Referring to FIG. 41, in this embodiment, a chip coil is used as the metamaterial 2100.

In this manner, the metamaterial 2100 of the chip coil is arranged and stuck, and the region 2000 is formed in the metal housing 2001 inside the region onto which the metamaterial 2100 is stuck. Therefore, even an apparatus covered by the metal housing 2001 can add an antenna function.

### Eighth Embodiment

In an eighth embodiment, the simulation of the antenna using the metamaterial described in the seventh embodiment will be described.

FIG. 42 is a diagram showing the structure of electromagnetic wave resonance simulation on a metal plate 4001A when a metamaterial is not used. Referring to FIG. 42, an electricity supply line 4200A is connected to the back surface at the center of the metal plate 4001A. In addition, a ground plate 4400A is arranged away from the back surface of the metal plate 4001A by a very small distance.

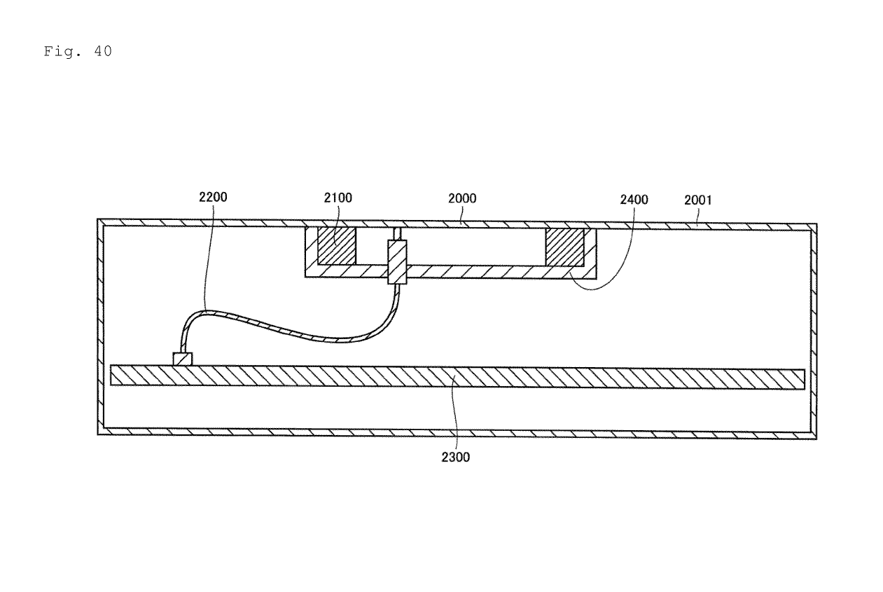

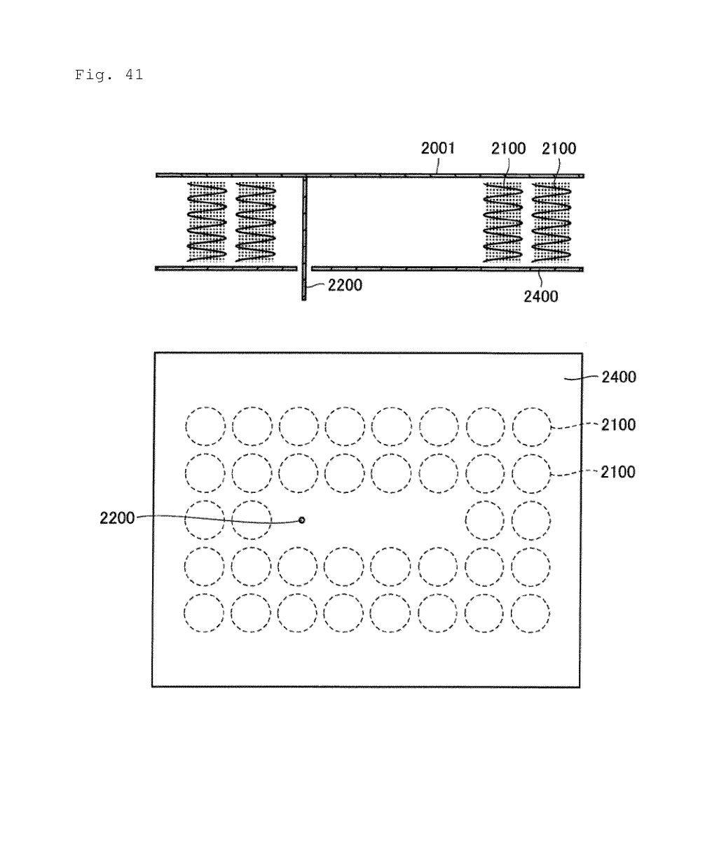

FIGS. 43(A), 43(B), and 43(C) are diagrams showing electromagnetic wave resonance simulation results on the metal plate 4001A when the metamaterial is not used. Referring to FIGS. 43(A), 43(B), and 43(C), when electricity is supplied from the electricity supply line 4200A shown in FIG. 42, the metamaterial is resonated with electromagnetic waves at various frequencies in electromagnetic fields. As shown in FIGS. 43(A), 43(B), and 43(C), the simulation results in the electric field intensity distributions showing various resonances on the entire metal plate 4001A are obtained.

FIG. 44 is a diagram showing the structure of electromagnetic wave resonance simulation on a metal plate when a metamaterial is used. Referring to FIG. 44, an electricity supply line 2200A is connected to the back surface at the center of the metal plate 2001A. In addition, a ground plate 2400A is arranged away from the back surface of the metal plate 2001A by a very small distance.

Further, a metamaterial 2100A is stuck onto the region of a metal plate 2001A which sections the region including the electricity supply point to which electricity supply point 2200A is connected, from other regions. Thereby, the metamaterial 2100A is arranged between the metal plate 2001A and the ground plate 2400A.

In addition, the metal plate 2001A and the ground plate 2400A are electrically connected on the outside of the region onto which the metamaterial 2100A is stuck.

In the simulation of this embodiment, dielectric constant ∈ of the metamaterial 2100A is 0.01, and magnetic permeability μ is −100.

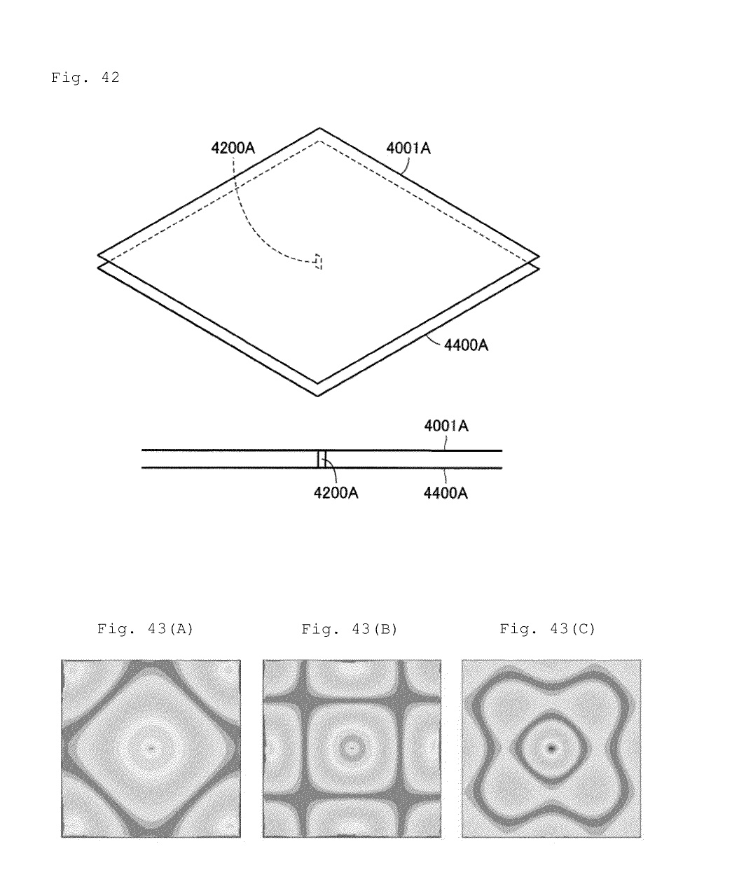

FIGS. 45(A) and 45(B) are diagrams showing electromagnetic waves resonance simulation results on the metal plate when the metamaterial is used. Referring to FIGS. 45(A) and 45(B), when electricity is supplied from the electricity supply line 2200A shown in FIG. 44, the metamaterial is resonated with electromagnetic waves at various frequencies in electromagnetic fields. As shown in FIGS. 45(A) and 45(B), the simulation results in the electric field intensity distributions in which various resonances are shown only inside the region onto which the metamaterial 2100A is stuck, and resonance is not shown outside the region onto which the metamaterial 2100A is stuck are obtained. In this way, part of the metal plate 2001A is brought into a cut-away state.

### Ninth Embodiment

In a ninth embodiment, an antenna using the metamaterial shown in the seventh embodiment is applied to a product.

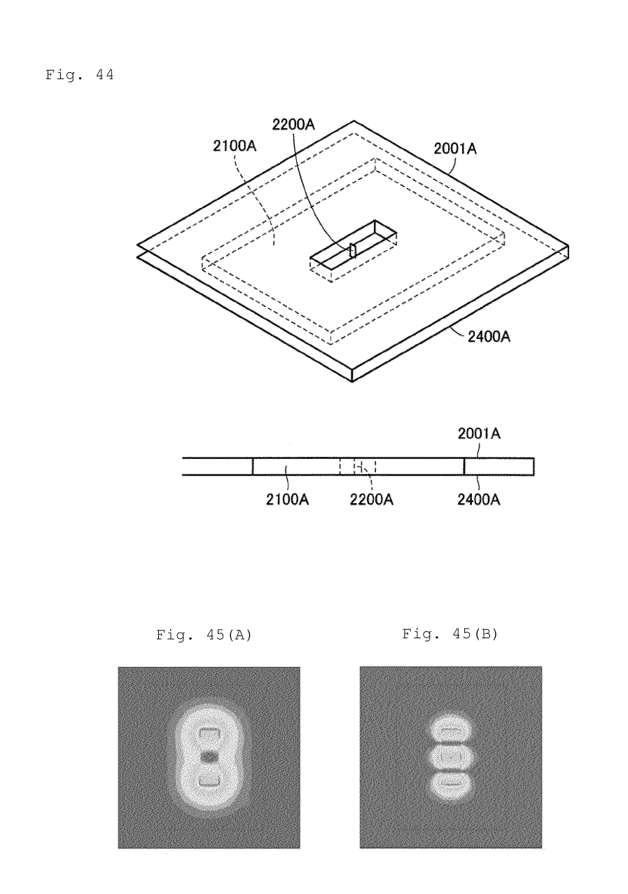

FIG. 46 is a diagram showing an example in which an antenna using metamaterials 2100B according to the ninth embodiment is applied to a product. Referring to FIG. 46, the antenna using the metamaterials 2100B is applied to a portable terminal, such as a smartphone. The middle drawing shows a metal housing 2001B in which the surface of the portable terminal including a liquid crystal display is opened.

As shown in the middle drawing in FIG. 46, the antenna using the metamaterials 2100B is formed near the center inside the metal housing 2001B. The upper right drawing in FIG. 46 shows a state in which the metal housing 2001B in the middle drawing is reversed. In this manner, the antenna is formed in a region 2000B of the metal housing 2001B. The components which form the antenna, such as the metamaterials 2100B, are provided inside the metal housing 2001B, so that the components cannot be visible from the outside. Therefore, the components cannot affect the design and texture of the metal housing 2001B.

The lower right drawing in FIG. 46 is an enlarged view of the portion formed with the antenna in the middle drawing in FIG. 46. In this state, an electricity supply line 2200B and a ground plane 2400B can be visible.

The lower left drawing in FIG. 46 shows a state in which the components forming the antenna are detached from the metal housing 2001B, seen from the surface side stuck onto the metal housing 2001B. In addition, the upper left drawing in FIG. 46 is an enlarged view of the portion including the electricity supply line 2200B in the lower left drawing in FIG. 46. In this manner, the metamaterials 2100B are arrayed on the outside of the region including the electricity supply line 2200B in the metal housing 2001B on the ground plane 2400B side.

### Tenth Embodiment

In a tenth embodiment, a modification example of the antenna using the metamaterial described in the seventh embodiment will be described.

FIG. 47 is a diagram showing an example of a structure which forms an antenna using metamaterials 2100C according to the tenth embodiment. Referring to FIG. 47, in this embodiment, the metamaterials 2100C structured of a helical coil are not directly stuck onto a metal plate 2001C, and a magnetic body 2700 having magnetic permeability μ of 30 is provided between the metamaterials 2100C and the metal plate 2001C.

In addition, one side of a rectangular region 2000C including an electricity supply line 2200C is part of one side of the rectangular metal plate 2001C, and other three sides are in contact with a region in which the metamaterials 2100C and the magnetic body 2700 are provided.

An electricity supply point to which the electricity supply line 2200C is connected is provided near the side of the region 2000C which is part of one side of the metal plate 2001C.

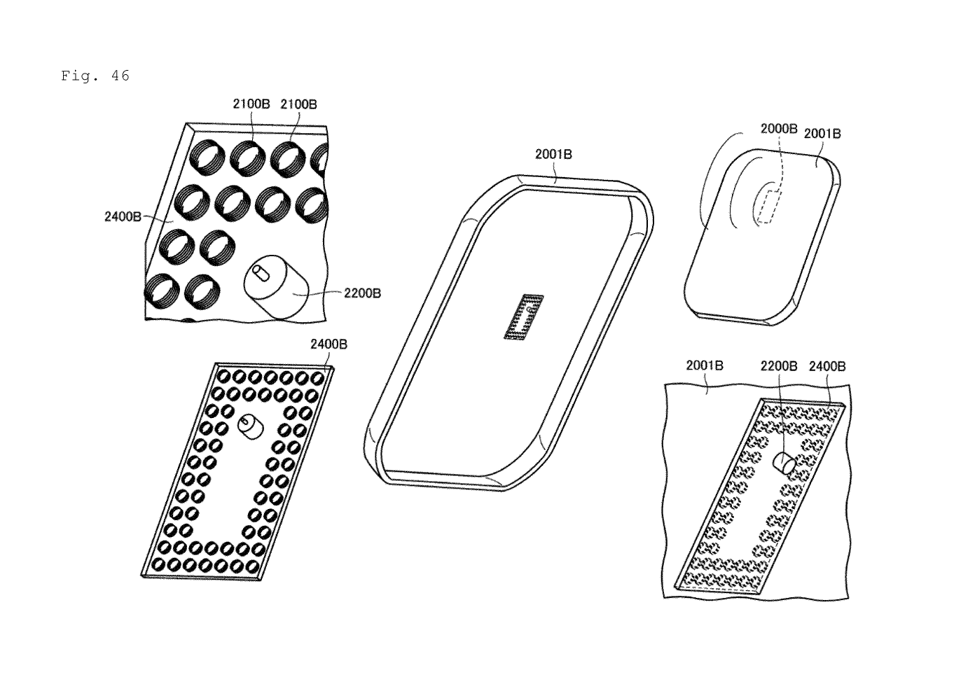

FIG. 48 is a diagram showing in detail part of the structure which forms the antenna using the metamaterials 2100C according to the tenth embodiment. Referring to FIG. 48, the magnetic body 2700 is provided on the metamaterials 2100C structured of a helical coil on the metal plate 2001C side.

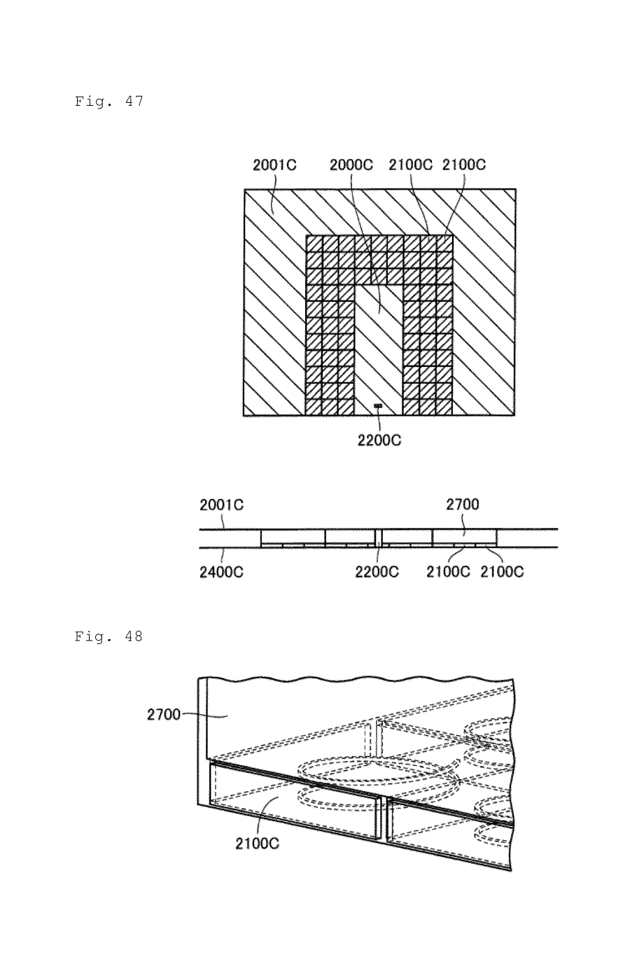

FIGS. 49(A) and 49(B) are diagrams showing the simulation results of the antenna using the metamaterials 2100C according to the tenth embodiment. FIG. 49(A) shows the electric field distribution of the metal plate 2001C. FIG. 49(B) shows the electric current distribution of the metal plate 2001C.

As shown in FIGS. 49(A) and 49(B), in the simulation results, various resonances are shown only inside the region of the metal plate 2001C on which the metamaterials 2100C and the magnetic body 2700 are provided, and resonance is not shown outside the region of the metal plate 2001C on which the metamaterials 2100C and the magnetic body 2700 are provided. In this way, part of the metal plate 2001C is brought into a cut-away state.

### Eleventh Embodiment

In the seventh to ninth embodiments, the metamaterial 2100 is stuck onto the region sectioned by surrounding the entire periphery of the particular region 2000 of the metal housing 2001. The region 2000 thus functions as an antenna.

FIG. 50 is a schematic explanatory view of the structure of an antenna using the metamaterial 2100 according to the seventh to ninth embodiments. Referring to FIG. 50, in the seventh to ninth embodiments, there is the region onto which the metamaterial 2100 is stuck so as to surround the entire periphery of the particular region 2000.

In the eleventh embodiment, the region onto which a metamaterial 2100D is stuck does not surround the entire periphery of a particular region 2000D of a metal plate 2001D.

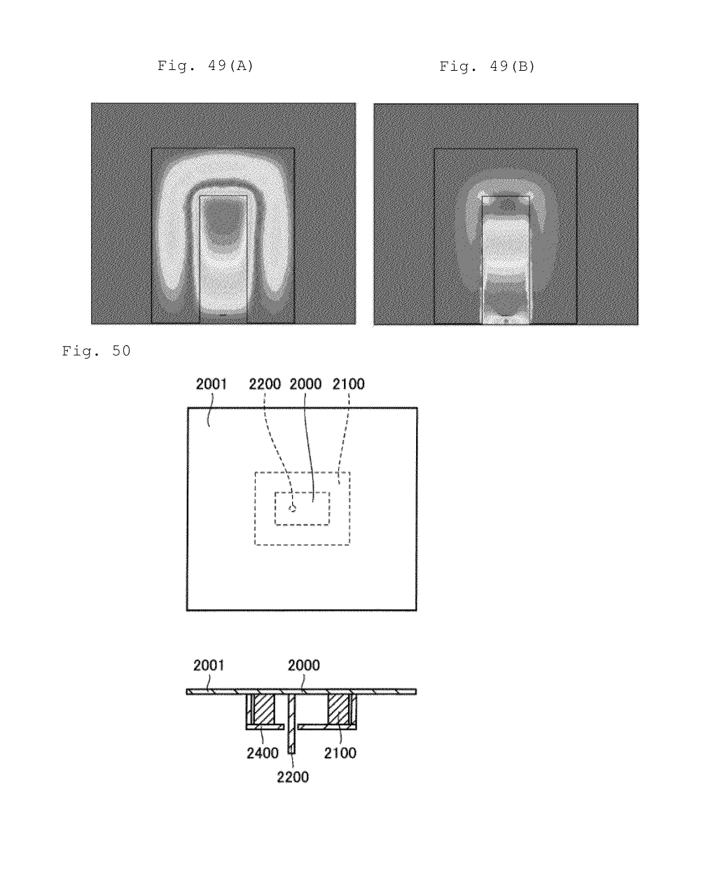

FIG. 51 is a schematic explanatory view of the structure of an antenna using the metamaterial 2100D according to the eleventh embodiment. Referring to FIG. 51, in the structure of the antenna using the metamaterial 2100D according to the eleventh embodiment, two long sides and one short side of the rectangular particular region 2000D are in contact with the region onto which the metamaterial 2100D is stuck, and one remaining short side near an electricity supply point to which the electricity supply line 2200D in the region 2000D is connected is connected to a ground surface 2500. The ground surface 2500 is connected to a ground 2400D. Even by such a structure, the region 2000D functions as an antenna.

In a λ/4 monopole antenna, the distal end thereof is opened to have the highest voltage and the lowest electric current, and the other end has the lowest voltage and the highest electric current, so that the vicinity of the electricity supply point may be grounded. As compared with when the entire region 2000 functioning as an antenna is surrounded by the region onto which the metamaterial 2100 is stuck, in this embodiment, at least one surface is the ground surface 2500. Therefore, the amount of the metamaterial 2100D is small to reduce the cost.

The EBG of the metamaterial cannot completely cut off the transmission of an electromagnetic wave, and can be electromagnetically isolated. Therefore, one surface is grounded, which can have a high cutoff efficiency. This is advantageous in the characteristic of the antenna formed in the region 2000D.

When one surface is not grounded, the antenna needs a λ/2 length. However, since one surface is grounded, the antenna can have a λ/4 length. Size reduction is thus enabled.

Although the impedance is lowered, like an inverted F antenna, the electricity supply point may be slightly away from the ground surface. The antenna may have a folded monopole antenna structure to increase the impedance.

### Twelfth Embodiment

Like the eleventh embodiment, in a twelfth embodiment, the region onto which metamaterials 2100E are stuck does not surround the entire periphery of a particular region 2000E of a metal plate 2001E.

FIG. 52 is a schematic explanatory view of the structure of an antenna using the metamaterials 2100E according to the twelfth embodiment. Referring to FIG. 52, in the structure of the antenna using the metamaterials 2100E according to the twelfth embodiment, two long sides of the rectangular particular region 2000E are structured of part of the side of the metal plate 2001E. Two short sides of the particular region 2000D are in contact with the regions onto which the metamaterials 2100E are stuck. Even by such a structure, the region 2000E functions as an antenna.

Only part of the metal plate 2001E having about the same size as the wavelength is electromagnetically isolated by the metamaterials 2100E. The isolated region 2000E can thus function as an antenna.

### Thirteenth Embodiment

Like the eleventh and twelfth embodiments, in a thirteenth embodiment, the region onto which metamaterials 2100F are stuck does not surround the entire periphery of a particular region 2000F of a metal plate 2001F.

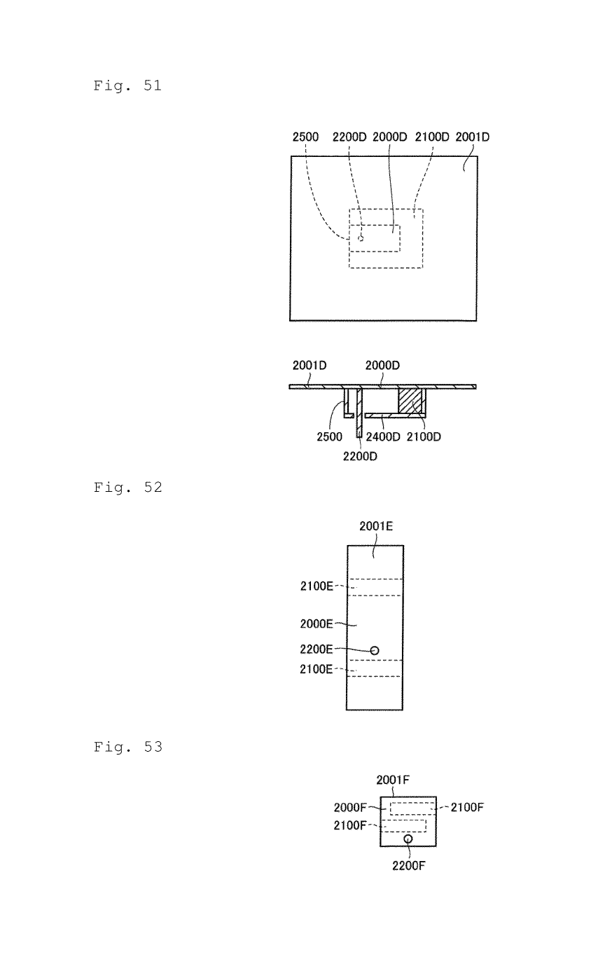

FIG. 53 is a schematic explanatory view of the structure of an antenna using the metamaterials 2100F according to the thirteenth embodiment. Referring to FIG. 53, in the structure of the antenna using the metamaterials 2100F according to the thirteenth embodiment, the regions onto which the metamaterials 2100F are stuck are provided so that the particular region 2000F of the metal plate 2001F is meandered. Thereby, the region 2000F functions as an antenna which has a longer resonant wavelength (shorter resonant frequency) than when the metal plate 2001F is directly used as an antenna.

### Fourteenth Embodiment

Like the eleventh to thirteenth embodiments, in a fourteenth embodiment, the region onto which a metamaterial 2100G is stuck does not surround the entire periphery of a particular region 2000G of a metal plate 2001G.

FIG. 54 is a schematic explanatory view of the structure of an antenna using the metamaterial 2100G according to the fourteenth embodiment. Referring to FIG. 54, in the structure of the antenna using the metamaterial 2100G according to the fourteenth embodiment, one long side and one short side of the rectangular particular region 2000G are structured of part of the sides of the metal plate 2001G. The remaining long side and short side of the particular region 2000G are in contact with the region onto which the metamaterial 2100G is stuck. Even by such a structure, the region 2000G functions as an antenna.

When an electricity supply point can be provided at one of the end and corner of the metal housing, part of the entire periphery of the region functioning as an antenna is not required to be the region onto which the metamaterial is stuck.

### Fifteenth Embodiment

In the seventh to fourteenth embodiments, the antenna using the metamaterial at one resonant wavelength has been described. In the fifteenth embodiment, an antenna using metamaterials at plural resonant wavelengths will be described.

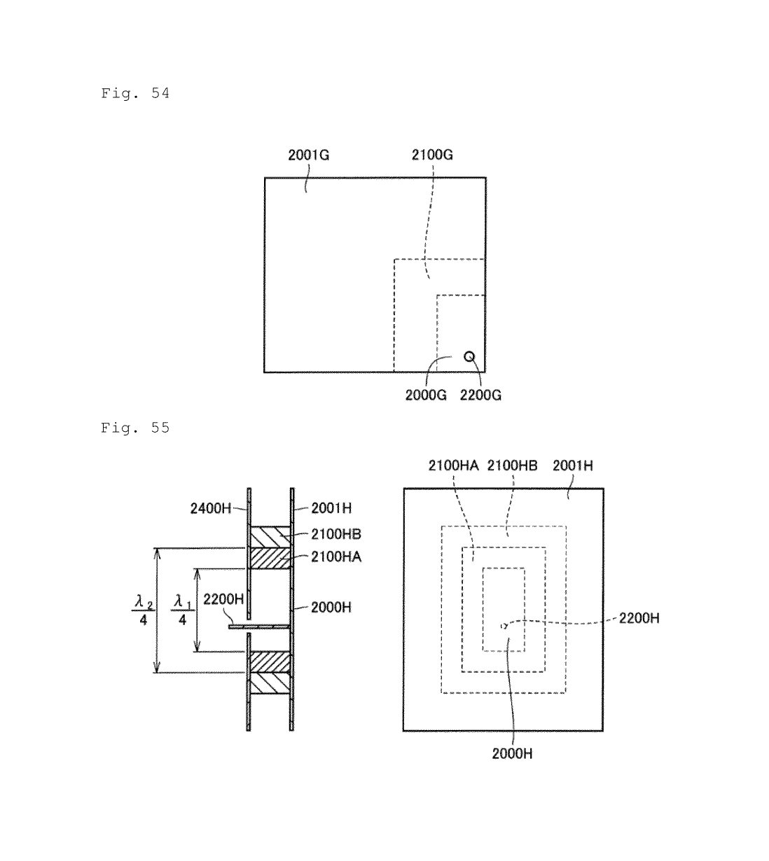

FIG. 55 is an explanatory view of the structure of an antenna using metamaterials 2100HA and 2100HB according to the fifteenth embodiment. Referring to FIG. 55, in a metal plate 2001H, a particular region 2000H is surrounded by the region onto which the metamaterial 2100HA having a resonant frequency of f1 (a resonant wavelength of λ₁) is stuck.

The region onto which the metamaterial 2100HA is stuck is surrounded by the region onto which the metamaterial 2100HB having a resonant frequency of f2 (a resonant wavelength of λ₂) is stuck. An electricity supply point to which the electricity supply line 2200H is connected is provided near the short side of the particular region 2000H.

The length of the long side of the particular region 2000H is λ₁/4, and the length of the long side of the region onto which the metamaterial 2100HA is stuck is λ₂/4.

In this manner, the region 2000H can function as an antenna which is resonated at both of the resonant wavelengths λ₁ and λ₂. The particular region 2000H is not limited to be doubly surrounded, and may be surrounded by the regions onto which metamaterials having more resonant wavelengths are stuck.

When the resonant wavelength difference between the metamaterials is small, the bandwidth of the antenna formed in the particular region 2000H can be wide.

### Sixteenth Embodiment

In a sixteenth embodiment, the antenna using the metamaterial 2100E described in the twelfth embodiment is applied to a product.

FIG. 56 is a diagram showing an example in which an antenna using metamaterials according to the sixteenth embodiment is applied to a product. Referring to FIG. 56, an antenna using metamaterials 2100KA and 2100KB is applied to a portable terminal, such as a smartphone.

This drawing shows a metal housing 2001K and a

non-metal housing 2002K in which the surface of the portable terminal including a liquid crystal display is opened. The portion of the surface of the housing including the liquid crystal display and contacted onto the metal housing 2001K is formed of a non-metal. Here, the non-metal material is e.g., a resin.

The regions onto which the metamaterials 2100KA and 2100KB are stuck are provided so that the region of the entire periphery of the metal housing 2001K is divided into two regions. Thereby, two short sides of a particular region 2000K including an electricity supply point to which an electricity supply line 2200K is connected are in contact with the regions onto which the metamaterials 2100KA and 2100 KB are stuck, and two long sides are in contact with the non-metal housing. Thereby, the particular region 2000K functions as an antenna.

### Seventeenth Embodiment

In the sixteenth embodiment, the region of the entire periphery of the metal housing 2001K is divided into two regions. In a seventeenth embodiment, the entire periphery of a metal housing 2001J functions as an antenna without being divided into two regions.

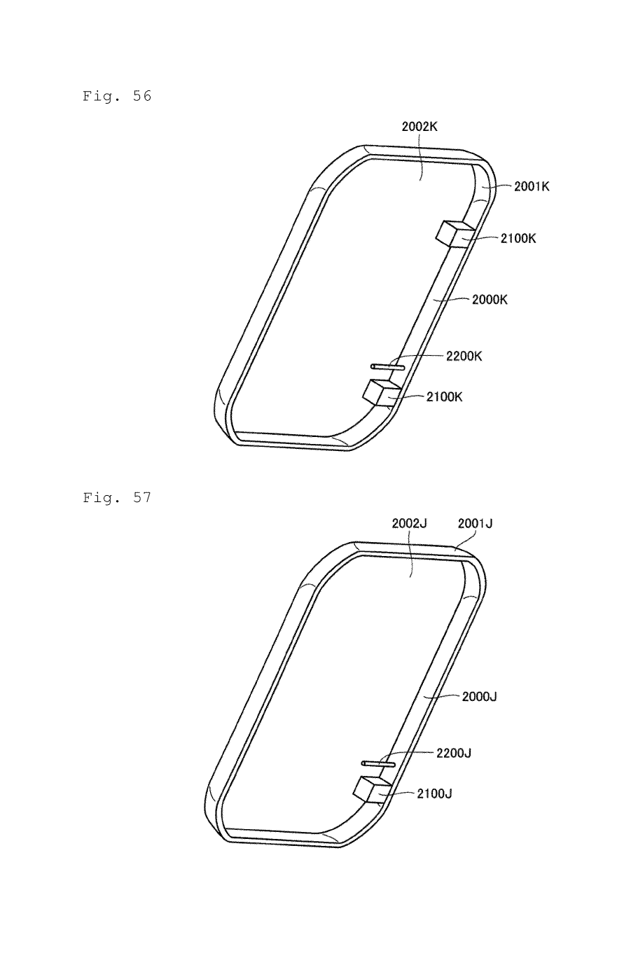

FIG. 57 is a diagram showing an example in which an antenna using metamaterials according to a seventeenth embodiment is applied to a product. Referring to FIG. 57, the metal housing 2001J and a non-metal housing 2002J are the same as the metal housing 2001K and the non-metal housing 2002K of the sixteenth embodiment.

Unlike the sixteenth embodiment, the region onto which a metamaterial 2100J is stuck is provided in one portion of the region of the entire periphery of the metal housing 2001J. Thereby, two short sides of a particular region 2000J including an electricity supply point to which an electricity supply point 2200J is connected are in contact with the region onto which the metamaterial 2100J is stuck, and two long sides are in contact with the non-metal housing. Thereby, the particular region 2000J functions as an antenna.

### Eighteenth Embodiment

Referring to FIG. 50 again, the metal housing 2001 according to the seventh to ninth embodiments desirably has a thickness less than the skin depth according to the material of the metal housing 2001. This is because when the metal housing 2001 is thicker than the skin depth, the electric current supplied from the electricity supply line 2200 flows only through the inside of the metal housing 2001 in the region 2000, and does not flow through the outside of the metal housing 2001 in the region 2000, so that the region 2000 is difficult to function as an antenna.

Therefore, the metal housing 2001 is structured of a metal layer which has a thickness less than the skin depth, and an insulator layer which maintains the strength of the metal housing 2001. For instance, metal plating is provided to an insulator layer, such as a resin, to form a metal layer which has a thickness less than the skin depth.

Among conductor metals, silver has a relatively small skin depth of about 2 μm with respect to an electromagnetic wave at a frequency of 1 GHz. As the frequency is lowered, silver has a larger skin depth, and other metals, such as copper, gold, aluminum, and iron, have a larger skin depth than silver.

The metal layer preferably has a thickness less than the skin depth, but may be thicker than the skin depth when the thickness thereof can radiate an electromagnetic wave necessary for the region 2000 to function as an antenna.

As described in the twelfth to fourteenth, sixteenth, and seventeenth embodiments, the end surfaces of the particular regions 2000E to 2000G, 2000J, and 2000K are the end surfaces of the metal plates 2001E to 2001G and the metal housings 2001J and 2001K, and an electromagnetic wave can be radiated from the end surfaces, so that the thickness of the metal layer may be equal to or more than the skin depth. Therefore, even when the housing is structured only of the metal layer having a thickness which can maintain the strength, the particular regions 2000E to 2000G, 2000J, and 2000K can function as an antenna.

However, as described in the eighteenth embodiment, even when the end surface of a particular region 2000M is exposed from the inner surface of a slit 2900M in a metal plate 2001M, an electromagnetic wave can be radiated from the end surface. Even when the thickness of the metal layer is equal to or more than the skin depth, the particular region 2000M can function as an antenna.

FIG. 58 is an explanatory view of the structure of an antenna using metamaterials 2100M according to the eighteenth embodiment. Referring to FIG. 58, in the structure of the antenna using the metamaterials 2100M according to the eighteenth embodiment, two long sides of the rectangular particular region 2000M are in contact with the region onto which the metamaterials 2100M are stuck. In addition, one short side of the particular region 2000M is in contact with the slit 2900M. Another short side of the particular region 2000M near an electricity supply point to which an electricity supply line 2200M is connected is connected to a ground surface 2500M. Like the ground surface 2500 in FIG. 51 of the eleventh embodiment, the ground surface 2500M is connected to the ground. Even by such a structure, the region 2000M functions as an antenna.

Even when the thickness of the metal layer is equal to or more than the skin depth, the end surface of the particular region 2000M is exposed from the inner surface of the slit 2900M in a metal plate 2001M, so that an electromagnetic wave can be radiated from the end surface. The particular region 2000M can thus function as an antenna.

As compared with when the entire region 2000M functioning as an antenna is surrounded by the region onto which the metamaterial is stuck, in this embodiment, at least one surface has the ground surface 2500M, and another surface has the slit, so that the amount of the metamaterials 2100M are small to reduce the cost.

The ground surface 2500M is not required to be provided. In this case, the antenna length is required to be changed from λ/4 to λ/2.

### Nineteenth Embodiment

In the eighteenth embodiment, the slit is in contact with the short side of the region 2000M. In the nineteenth embodiment, slits are contacted onto the long sides of a region 2000N.

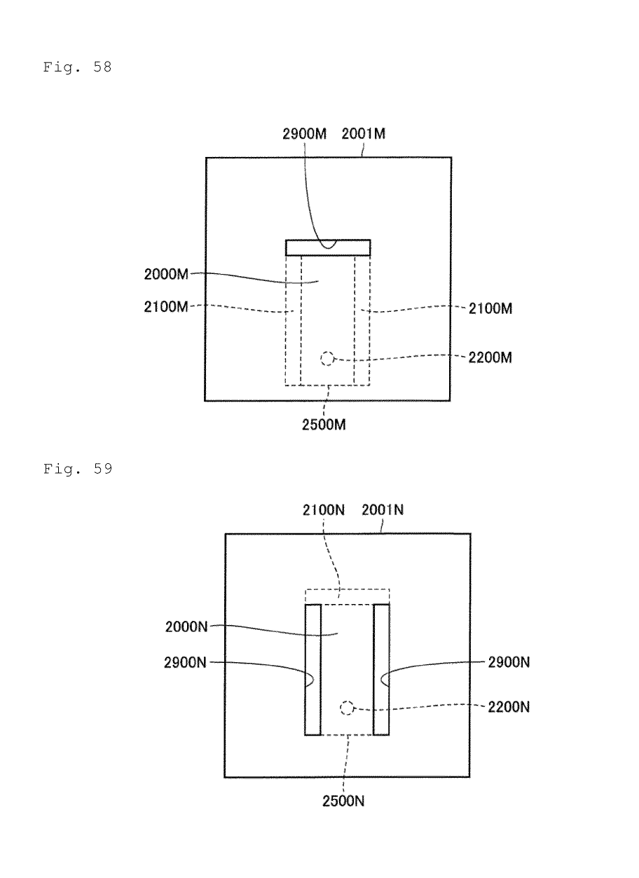

FIG. 59 is an explanatory view of the structure of an antenna using the metamaterial 2100N according to the nineteenth embodiment. Referring to FIG. 59, in the structure of the antenna using the metamaterial 2100N according to the nineteenth embodiment, two long sides of the rectangular particular region 2000N are in contact with slits 2900N. In addition, one short side of the region 2000N is in contact with the region onto which the metamaterial 2100N is stuck. Another short side of the particular region 2000N near an electricity supply point to which an electricity supply line 2200N is connected is connected to a ground surface 2500N. Like the ground surface 2500 in FIG. 51 of the eleventh embodiment, the ground surface 2500N is connected to the ground. Even by such a structure, the region 2000N functions as an antenna.

Even when the thickness of the metal layer is equal to or more than the skin depth, the end surface of the particular region 2000N is exposed from the inner surfaces of the slits 2900N in a metal plate 2001N, so that an electromagnetic wave can be radiated from the end surface. The particular region 2000N can thus function as an antenna.

As compared with when the entire region 2000N functioning as an antenna is surrounded by the region onto which the metamaterial is stuck, in this embodiment, at least one surface has the ground surface 2500N, and other two surfaces has the slits, so that the amount of the metamaterial 2100N is smaller than the eighteenth embodiment to reduce the cost.

However, as compared with the eighteenth embodiment, the number of slits is increased, which is disadvantageous in strength. When the slit is provided like the eighteenth and nineteenth embodiments, the slit is preferably reinforced by the insulator to maintain the strength. When the slit is used for a product, the slit is preferably water-proof since the electric component is arranged therein.

The ground surface 2500N is not required to be provided. In this case, the antenna length is required to be changed from λ/4 to λ/2.

### Twentieth Embodiment

In a twentieth embodiment, the antenna described in the eighteenth and nineteenth embodiments in which the region used as the antenna is sectioned by the metamaterial and the slit is applied to a product.

In the twentieth embodiment, a metamaterial 2100L is previously incorporated into a component unit like a camera unit 2800. The component unit is attached at a predetermined position of an electric apparatus, such as a smartphone 2010, so that the metamaterial 2100L is arranged at a position in which the region which attenuates the near resonant wavelength component of the electromagnetic wave of the metamaterial 2100L is formed in the region which sections a particular region 2000L from other regions.

FIG. 60 is a first diagram showing an example in which the antenna using the metamaterial 2100L according to the twentieth embodiment is applied to the smartphone 2010. Referring to FIG. 60, the smartphone 2010 includes the camera unit 2800. In a state in which the camera unit 2800 is attached to a metal housing 2001L, only the lens of the camera unit 2800 is projected to the outside of the metal housing 2001L.

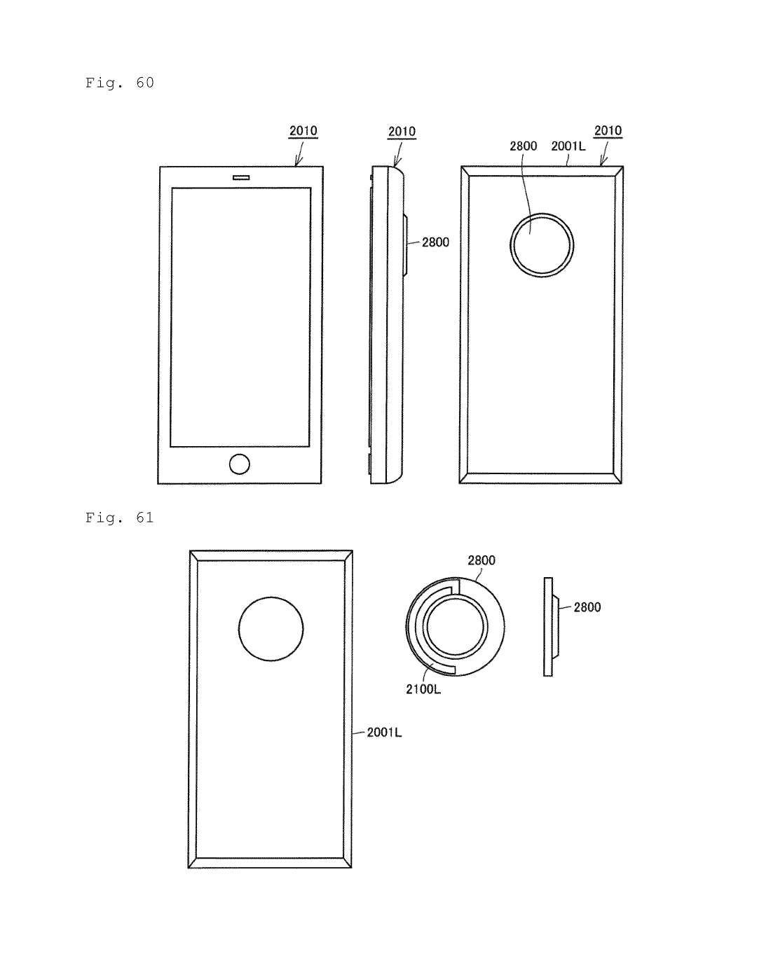

FIG. 61 is a second diagram showing an example in which the antenna using the metamaterial 2100L according to the twentieth embodiment is applied to the smartphone 2010. Referring to FIG. 61, the metamaterial 2100L is buried into the portion of the camera unit 2800 contacted onto the metal housing 2001L when the camera unit 2800 is manufactured.

FIG. 62 is a third diagram showing an example in which the antenna using the metamaterial 2100L according to the twentieth embodiment is applied to the smartphone 2010. Referring to FIG. 62, the camera unit 2800 is attached to the metal housing 2001L.

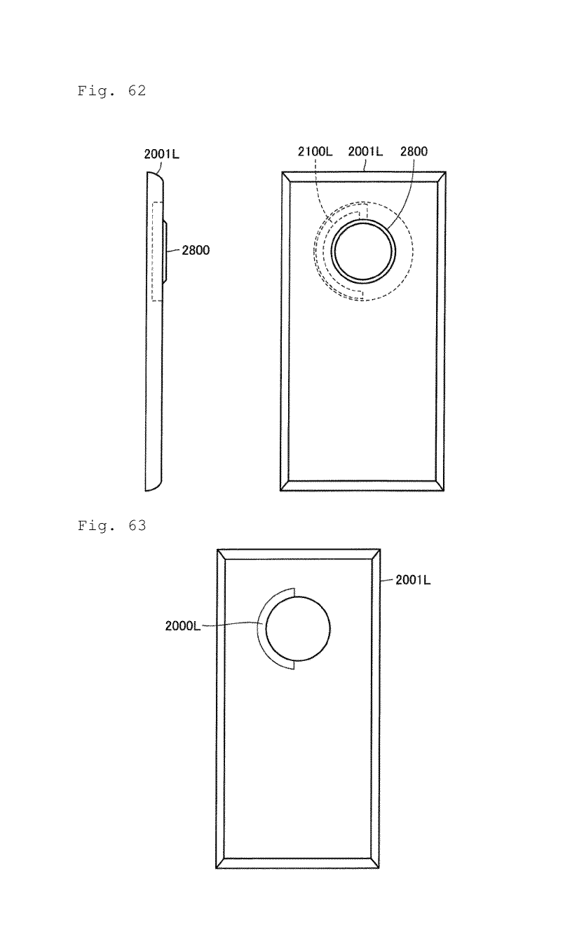

FIG. 63 is a fourth diagram showing an example in which the antenna using the metamaterial 2100L according to the twentieth embodiment is applied to the smartphone 2010. As described above, referring to FIG. 63, when the camera unit 2800 is attached to the metal housing 2001L, the region of the metal housing 2001L onto which the metamaterial 2100L is contacted is electromagnetically isolated from the particular region 2000L surrounded by the hole in the metal housing 2001L through which the lens of the camera unit 2800 extends. An electricity supply line is connected to near the lower end in the drawing of the particular region 2000L. The grounding portion may be provided at the lower end in the drawing of the particular region 2000L. Thereby, the isolated particular region 2000L functions as an antenna.

In this manner, the hole is originally provided in the portion of the metal housing 2001L to which the camera unit 2800 is attached. By the hole and the metamaterial 2100L which is previously incorporated into the camera unit 2800, the particular region 2000L can be electromagnetically isolated to function as an antenna. Therefore, one of the hole and the slit which attach thereinto a device, such as the camera unit 2800 of a portable terminal, such as a smartphone 2010, is used so that the antenna can be easily formed in part of the metal housing 2001L.

Even when the component unit having a predetermined function is close to the metal housing without the hole, the metamaterial may be previously incorporated into the component unit. Thereby, by attaching the component unit at the predetermined position, the metamaterial is arranged at the position in which the region which cuts off the near resonant wavelength component of the electromagnetic wave of the metamaterial is formed in the region which sections the particular region from other regions. The particular region can thus function as an antenna.

As compared with when the metamaterial is attached to the metal housing of the electric apparatus, the metamaterial is previously incorporated into the component unit to be attached to the electric apparatus, which is not required to greatly change the design for arranging the component of the electric apparatus. The developing cost can thus be reduced.

### Twenty-First Embodiment

In the seventh to twentieth embodiments, the electricity supply line is connected to the particular region sectioned by one of the metamaterial and the contour of the plate to function as an antenna. In a twenty-first embodiment, the electricity supply line is not connected to the particular region sectioned by one of the metamaterial and the contour of the plate to function as an electric window.

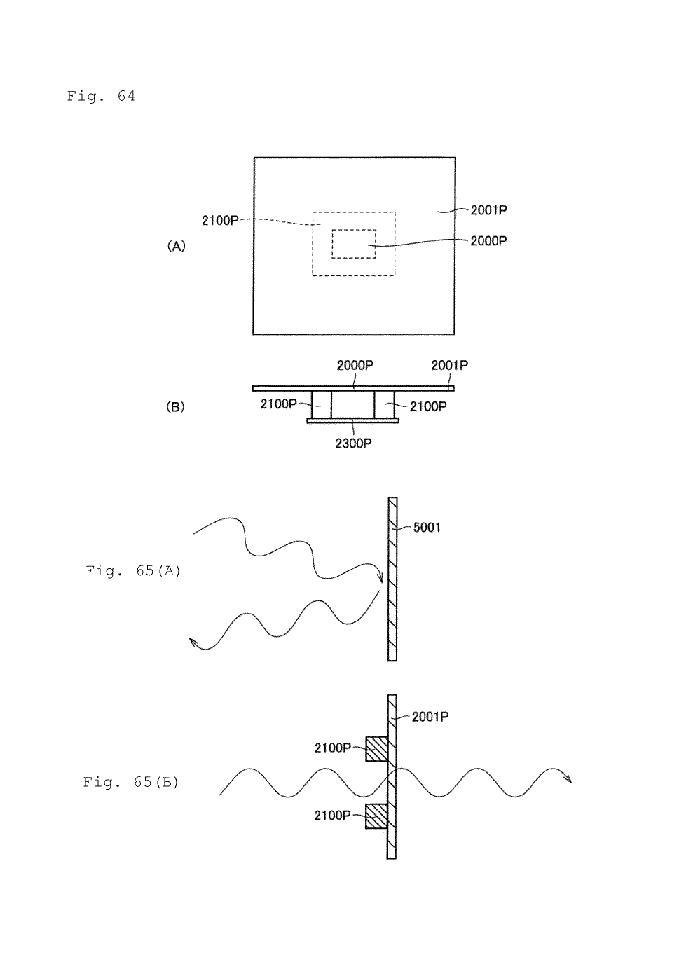

FIGS. 64(A) and 64(B) are explanatory views of the structure of the electric window using metamaterials 2100P according to the twenty-first embodiment. FIG. 64(A) is a plan view. FIG. 64(B) is a side view. Referring to FIGS. 64(A) and 64(B), plural metamaterials 2100P are stuck onto the surface inside a metal housing 2001P in the region which sections a region 2000P to function as the electric window from other regions.

Thereby, the portion of the metal housing 2001P onto which the metamaterials 2100P are stuck is one of the region which greatly cuts off the near resonant wavelength components of the electromagnetic waves of the metamaterials 2100P equivalent to a high impedance region and the region which substantially cuts off the electromagnetic wave components. Therefore, the region 2000P is isolated from other regions in the resonance with the resonant wavelength components of the electromagnetic fields.

When an electromagnetic wave is incident onto the inner side surface from the antenna on a circuit substrate 2300P, the region 2000P is electromagnetically isolated from other regions to be resonated with the electromagnetic waves having the near resonant wavelength components of the metamaterials 2100P in the electromagnetic field, and functions as the electric window which radiates the electromagnetic wave having the wavelength of the electromagnetic wave incident from the inner side surface, from the outer side surface. As a result, part of the metal housing 2001P can function as the electric window. That is, even when the entire surface of the metal housing 2001P is formed of a metal, the antenna can be mounted inside the metal housing 2001P.

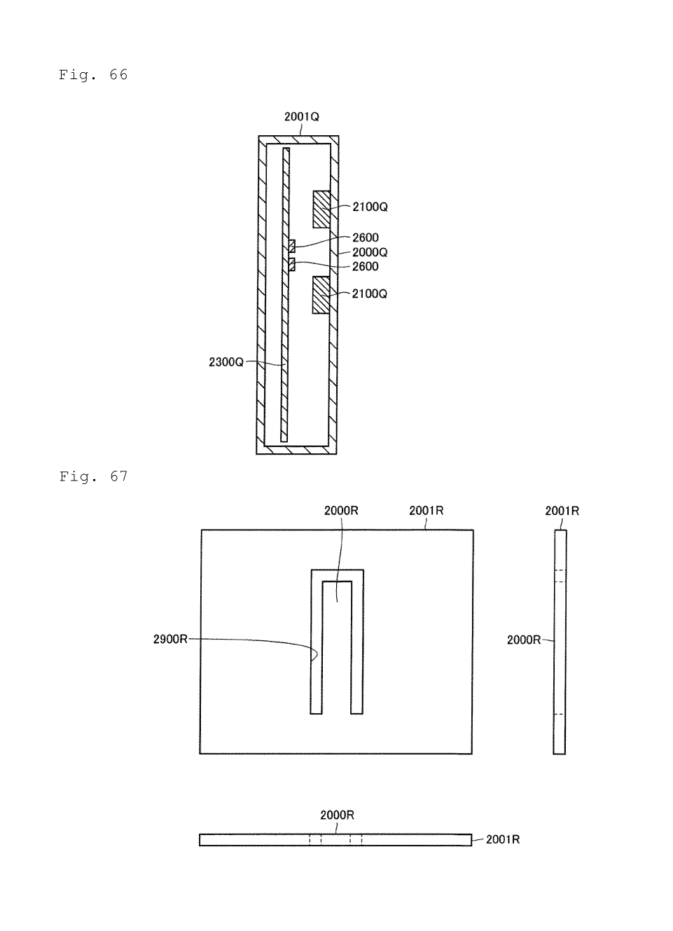

FIGS. 65(A) and 65(B) are explanatory views of the function of the electric window using the metamaterials 2100P according to the twenty-first embodiment. FIG. 65(A) shows the traveling state of an electromagnetic wave in a conventional metal housing 5001. FIG. 65(B) shows the traveling state of an electromagnetic wave in the electric window of this embodiment.

Referring to FIG. 65(A), in the conventional metal housing 5001, the electromagnetic wave cannot pass through the metal housing 5001. Referring to FIG. 65(B), in the electric window of this embodiment, the electromagnetic wave can pass through the portion of the electric window in the region 2000P of the metal housing 2001P.

### Twenty-Second Embodiment

In a twenty-second embodiment, the electric window described in the twenty-first embodiment is applied to a product.

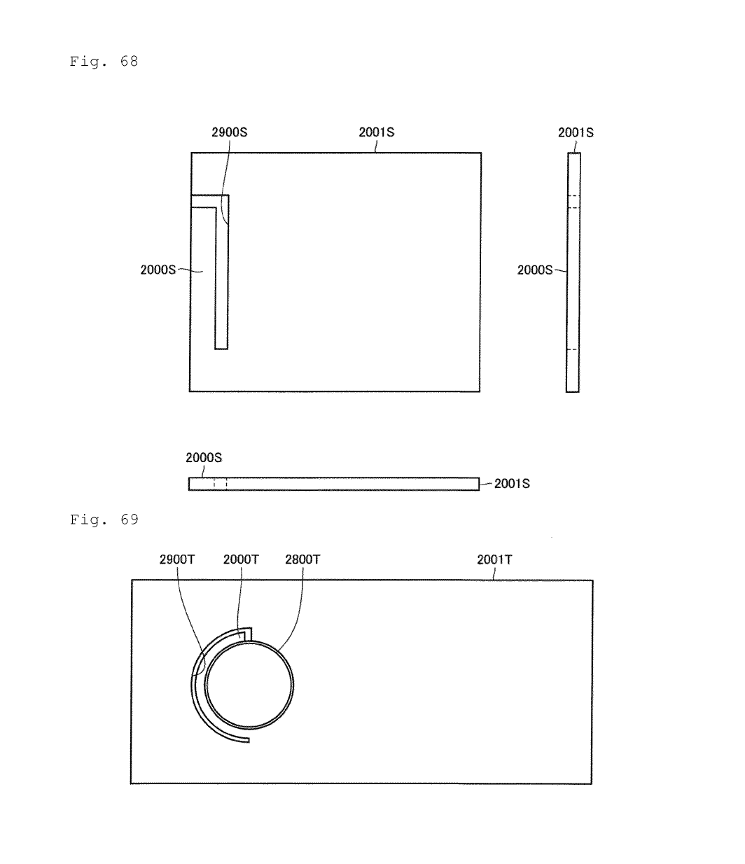

FIG. 66 is a diagram showing an example in which the electric window using metamaterials 2100Q according to the twenty-second embodiment is applied to a product. Referring to FIG. 66, the metamaterials 2100Q are stuck onto the inside of a metal housing 2001Q to form a region 2000Q which functions as the electric window. Plural antennas 2600 are provided on an inside circuit substrate 2300Q.

Electromagnetic waves radiated from the antennas 2600 pass through the electric window in the region 2000Q. The electromagnetic waves cannot pass through the metal housing 2001Q other than the portion of the electric window in the region 2000Q.

By providing the electric window in this manner, plural antennas can be provided in the metal housing 2001Q. Thereby, as the antennas 2600, for instance, chip antennas and antennas by the wiring on a printed substrate can be used. Therefore, when plural antennas are provided, space saving is enabled to lower the manufacturing cost.

### Twenty-Third Embodiment

Antennas have a long history, including many known techniques, such as a monopole antenna, a dipole antenna, a helical antenna, and an inverted F antenna. In addition, there is a ceramic chip antenna (see Japanese Patent Application Laid-Open (JP-A) No. 9-162525).

In a cellular phone, a smartphone, and a wireless apparatus, such as a W-LAN (Wireless Local Area Network) router, an antenna is provided in the housing for size reduction, heat dissipation, and design. Therefore, a resin which passes an electric wave therethrough is employed for the housing.

On the other hand, a notebook PC (Personal Computer) and a tablet PC which are large and thin are required to ensure the strength of the housing. Therefore, the number of cases of employing a metal housing has been increased.

In this case, since a metal does not pass an electric wave therethrough, an antenna cannot be provided inside by the conventional method. Therefore, a rod antenna is projected to the outside, which is not troublesome. However, this is not preferable in size and design. Therefore, the above case has been hardly employed in recent years.

Accordingly, for instance, in a notebook PC, only the upper end of the housing on the liquid crystal display side is formed of a resin to provide an antenna in that portion. Thereby, as compared with when the entire housing is formed of a resin, the strength can be ensured and the thickness can be smaller.

For instance, a monopole antenna which receives one segment reception service for cellular phones and mobile terminals, so-called a one segment broadcast, is of the extendable and contractable rod type to be provided on the outside of an apparatus. The antenna of a cellular phone is often formed on a printed substrate. A chip antenna is mounted on a substrate.

FIG. 75 is a diagram showing the arrangement of a conventional antenna 3000 in which a case 3001 is formed of a resin. Referring to FIG. 75, when the antenna 3000 is formed on a substrate 3300 of a cellular phone, the resin case 3001 on the outside of the cellular phone passes an electric wave therethrough, causing no problem.

FIG. 76 is a diagram in which a case 4001 is formed of a metal. Referring to FIG. 76, the case 4001 which is formed of one of a metal and a conductive resin does not pass an electric wave therethrough. Therefore, even when formed on a substrate 4300 in the case 4001, an antenna 4000 cannot function as an antenna.

In addition, the antenna in JP H9-162525 A in the case which does not pass an electric wave therethrough cannot function as an antenna.

FIG. 77 is a diagram in which a case 4002 of part of the metal case 4001 is formed of a resin. As a first method, when the case 4001 does not pass an electric wave therethrough, only the portion of the case 4002 of part of the metal case 4001 is formed of a resin which passes an electric wave therethrough so as not to cut off the electric wave. For instance, in a recent notebook PC (Personal Computer), part of the top metal plate thereof is formed of a resin to form an antenna therein.

FIG. 78 is a diagram showing an antenna 4100 arranged on the outside of the metal case 4001. Referring to FIG. 78, as a second method, when the case 4001 does not pass an electric wave therethrough, the antenna 4100 is provided on the outside of the apparatus.

The antenna 4100 on the outside of the apparatus has no functional problems. However, in that case, the antenna 4100 can be an obstacle, and can be troublesome to be projected. Consequently, the second method cannot meet the needs of consumers. After all, the antenna is desirably incorporated.

As described above, when part of the metal case 4001 is formed of a resin, the strength and the heat dissipation are lowered. In addition, the texture is partially changed, which cannot be favorable in design.

In addition, since the portion to be replaced with a resin is minimum, the antenna is required to be mounted in a small space. Therefore, the antenna is required to be smaller, so that the gain can be sacrificed.

However, the number of wireless communication standards, such as W-LAN, Bluetooth (trademark), and WiMAX (trademark) (Worldwide Interoperability for Microwave Access), has been increased. The number of antennas required to be mounted on a wireless apparatus has been increased.

Further, LTE (Long Term Evolution) introduced on a full-scale basis from this year is a wireless communication standard which enables faster communication by using plural antennas. However, in a notebook PC having a metal housing, the antenna mounting space cannot be ensured any longer.

According to the antenna of the twenty-third embodiment, the above problems can be solved, and part of the plate having the conductive layer can function as an antenna.

In the seventh to twentieth embodiments, the electricity supply line is connected to the particular region sectioned by one of the metamaterial and the contour of the plate to function as an antenna. In particular, in the eighteenth to twentieth embodiments, the electricity supply line is connected to the particular region sectioned by the metamaterial and the slit to function as an antenna. In the twenty-third embodiment, the electricity supply line is connected to the particular region sectioned by the slit to function as an antenna.

FIG. 67 is an explanatory view of the structure of an antenna using a slit 2900R according to the twenty-third embodiment. Referring to FIG. 67, the U-shaped slit 2900R is provided in a metal plate 2001R. Thereby, a particular region 2000R is sectioned inside the U-shape. The particular region 2000R has a shape in which the particular region 2000R functions as an antenna by supplying electricity to the particular region 2000R (in this embodiment, a rectangular monopole antenna shape).

A ground is provided around the side of the particular region 2000R connected to other regions of the metal plate 2001R. The particular region 2000R is not limited to the rectangular monopole antenna shape, and may have other antenna shapes, such as a dipole antenna shape, as long as they function as an antenna.

Thereby, the metal plate 2001R is used for the housing of an electric product, so that the particular region 2000R of part of the housing of the electric product can be directly an antenna. Therefore, an existing external antenna and an antenna in which part of the metal housing is formed of a resin and provided in that portion are not necessary.

Unlike part of the metal housing formed of a resin, without bonding the metal and the resin, the slit punching and shaping in the metal housing can form an antenna. Therefore, the antenna can be easily manufactured, and the manufacturing cost can be lowered.

The entire periphery of the antenna shape is not required to be hollowed, and one surface may be the grounded, so that like this embodiment, the slit may be U-shaped. The U-shaped slit can ensure the strength of the particular region 2000R to some extent. In addition, when the U-shaped slit is successfully arranged to have a periodic pattern including a dummy which is not used as an antenna, the U-shaped slit can have not only the antenna function, but also designability. The deterioration of the appearance due to the slit can be prevented.

By slitting, the metal plate 2001R as the ground on the outside of the particular region 2000R is opposite to the particular region 2000R across the slit 2900R by a short distance. Therefore, the radiation efficiency is lower than a typical antenna of the same size with no ground thereby. In e.g., a notebook PC, as compared with when the antenna is incorporated into the resin housing portion at the end of the housing on the display side, the forming of the antenna using the slit in the metal surface can use a large area to increase the antenna size. As a result, the radiation efficiency can be higher.

As compared with the conventional method in which the antenna is projected from the housing, the metal plate 2001R near the particular region 2000R functioning as an antenna lowers the antenna gain, but can form the antenna on the same surface as the housing, enabling significant space saving.

Even when the slit 2900R is provided, the housing which is formed basically of a metal can provide a higher strength and a thinner product than the conventional resin housing.

### Twenty-Fourth Embodiment

In the twenty-third embodiment, the electricity supply line is connected to the particular region sectioned by the slit to function as an antenna. In a twenty-fourth embodiment, the electricity supply line is connected to the particular region sectioned by the slit and the contour of the metal plate to function as an antenna.

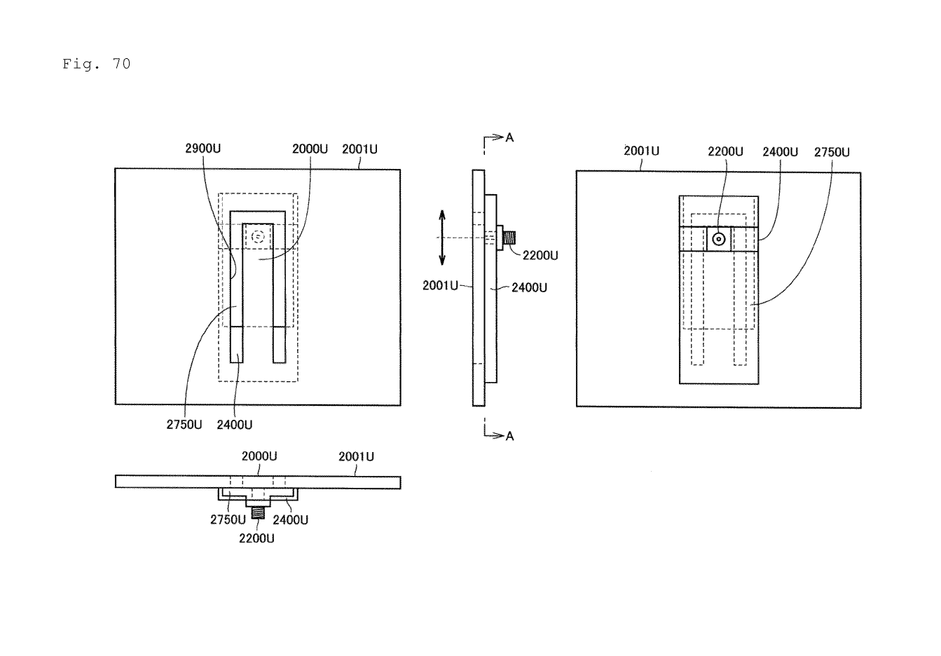

FIG. 68 is an explanatory view of the structure of an antenna using a slit 2900S according to the twenty-fourth embodiment. Referring to FIG. 68, the L-shaped slit 2900S is provided in a metal plate 2001S to be connected to the end thereof. Thereby, a particular region 2000S is sectioned by the L-shaped slit 2900S and the end of the metal plate 2001S. The particular region 2000S has a shape in which the particular region 2000S functions as an antenna by supplying electricity to the particular region 2000S (in this embodiment, a rectangular monopole antenna shape).

A ground is provided around the side of the particular region 2000S connected to other regions of the metal plate 2001S. The particular region 2000S is not limited to the rectangular monopole antenna shape, and may have other antenna shapes, such as a dipole antenna shape, as long as they function as an antenna.

Thereby, in addition to the effect described in the twenty-third embodiment, the following effect can be provided. As compared with the twenty-third embodiment in which the entire surface of the metal plate 2001R can be used, the use of the end of the metal plate 2001S reduces the number of portions which can function as an antenna, but can shorten the slit forming the antenna of the same size to increase the mechanical strength.

In the twenty-third embodiment, the antenna is formed by using the surface of the metal plate 2001R, and in the twenty-fourth embodiment, the antenna is formed by using the side of the metal plate 2001S. In the same manner, the antenna may be formed by using the corner of the metal plate.

### Twenty-Fifth Embodiment

In a twenty-fifth embodiment, the antenna described in the twenty-third and twenty-fourth embodiments is applied to a product.

FIG. 69 is an explanatory view of the structure of an antenna using a slit 2900T according to the twenty-fifth embodiment. Referring to FIG. 69, the slit 2900T is provided in a metal housing 2001T to be connected into the attaching hole in a camera unit 2800T of the metal housing 2001T. This corresponds to the fact that the side of the metal plate 2001S of the twenty-fourth embodiment is located around the hole in the surface of the metal housing 2001T. Thereby, a particular region 2000T is sectioned by the slit 2900T and the attaching hole in the camera unit 2800T. The particular region 2000T has a shape in which the particular region 2000T functions as an antenna by supplying electricity to the particular region 2000T (in this embodiment, a monopole antenna shape).

A ground is provided around the side of the particular region 2000T connected to other regions of the metal housing 2001T. The particular region 2000T is not limited to the monopole antenna shape, and may have other antenna shapes, such as a dipole antenna shape, as long as they function as an antenna.

Thereby, in addition to the effect described in the twenty-third and twenty-fourth embodiments, the following effect can be provided. By the shape of the attaching hole in the camera unit 2800T, the shape of the particular region 2000T functioning as an antenna is arc, and can be ideal as an antenna.

The camera unit 2800T is bonded to the particular region 2000T, so that the particular region 2000T is supported from the back side thereof. The mechanical strength of the particular region 2000T can thus be improved.

### Twenty-Sixth Embodiment

In a twenty-sixth embodiment, the back side of the slit described in the twenty-third and twenty-fourth embodiments is reinforced.

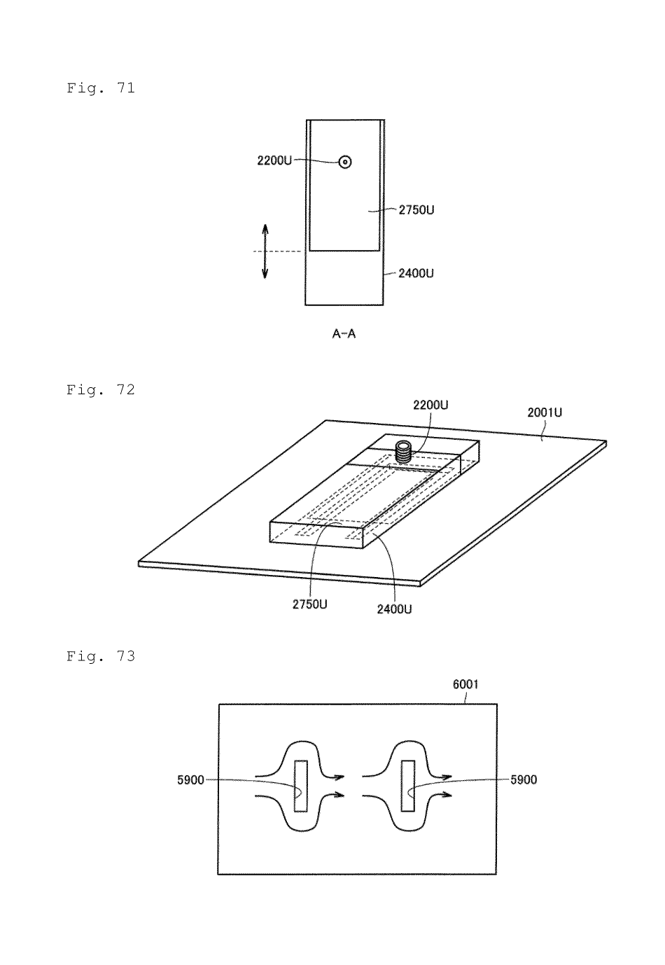

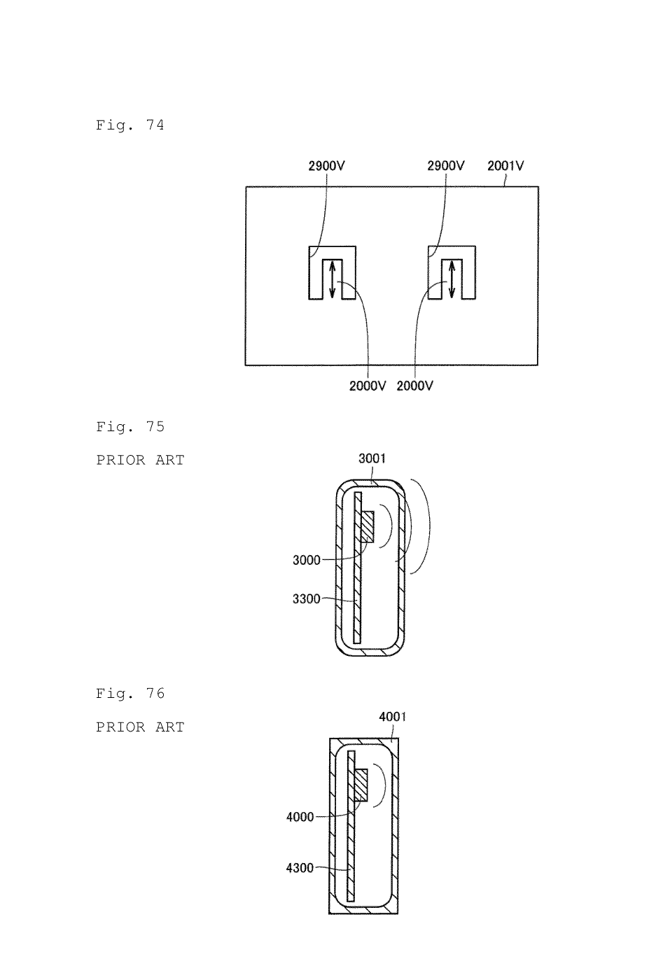

FIG. 70 is an explanatory view of the structure of an antenna using a slit 2900U according to the twenty-sixth embodiment. FIG. 71 is a diagram taken along line A-A in FIG. 70, seen in the direction of the appended arrows. FIG. 72 is a perspective view of the structure of the antenna using the slit 2900U according to the twenty-sixth embodiment.

As shown in FIG. 67 of the twenty-third embodiment, referring to FIGS. 70 to 72, the U-shaped slit 2900U is provided in a metal plate 2001U. Thereby, a particular region 2000U is sectioned inside the U-shape. The particular region 2000U has a shape in which the particular region 2000U functions as an antenna by supplying electricity to the particular region 2000U (in this embodiment, a rectangular monopole antenna shape).

A printed substrate 2750U is stuck from the back side of the metal plate 2001U to close the slit 2900U. An electricity supply line 2200U and a ground electrode 2400U are previously provided on the printed substrate 2750U. The electricity supply line 2200U supplies electricity to the particular region 2000U. The ground electrode 2400U is connected to the ground of the electricity supply line 2200U.

The ground electrode 2400U is electrically connected to around the side of the particular region 2000U connected to other regions of the metal plate 2001U. When the position in which the electricity supply line 2200U is connected to the particular region 2000U is changed, the impedance matching of the antenna in the particular region 2000U can be adjusted. When the position of the particular region 2000U connected to the ground electrode 2400U is changed, the resonant frequency of the antenna in the particular region 2000U can be adjusted.

The particular region 2000U is not limited to the rectangular monopole antenna shape, and may have other shapes, such as a dipole antenna shape, as long as they function as an antenna.

Thereby, in addition to the effect described in the twenty-third to twenty-fifth embodiments, the following effect can be provided. It is difficult to finely adjust the size of the slit 2900U punched by using a die.

However, even with the slit 2900U having the same shape, the antenna in the particular region 2000U is affected by the inner dielectric constant and the metal distribution to subtly change the resonant frequency. Fine adjustment is thus typically necessary.

Here, in this embodiment, plural printed substrates 2750 in which the attaching position of the electricity supply line 2200U and the position of the ground electrode 2400U are different are prepared. The impedance matching and the resonant frequency adjustment are thus enabled by changing the substrates.

The printed substrate 2750 is stuck from the back side of the slit 2900U to close the slit 2900U. The mechanical strength of the particular region 2000U can thus be reinforced.

The printed substrate 2750 reinforcing the slit 2900U, the ground electrode 2400U, and the electricity supply line 2200U may be integrally formed like this embodiment, and may be separated.

The portion of the slit 2900U is replaced with the printed substrate 2750. Alternatively, the portion of the slit 2900U may be filled with an insulating adhesive resin in the printed substrate 2750.

### Twenty-Seventh Embodiment

In a twenty-seventh embodiment, plural antennas using the slit described in the twenty-third and twenty-fourth embodiments are provided on the same metal plate.

FIG. 73 is an explanatory view of plural conventional slot antennas 5900 on the same metal plate 6001. Referring to FIG. 73, the slot antennas 5900 generate electromagnetic fields in the slots. However, the electric current flows around the slots and is coupled to the slot antennas 5900.

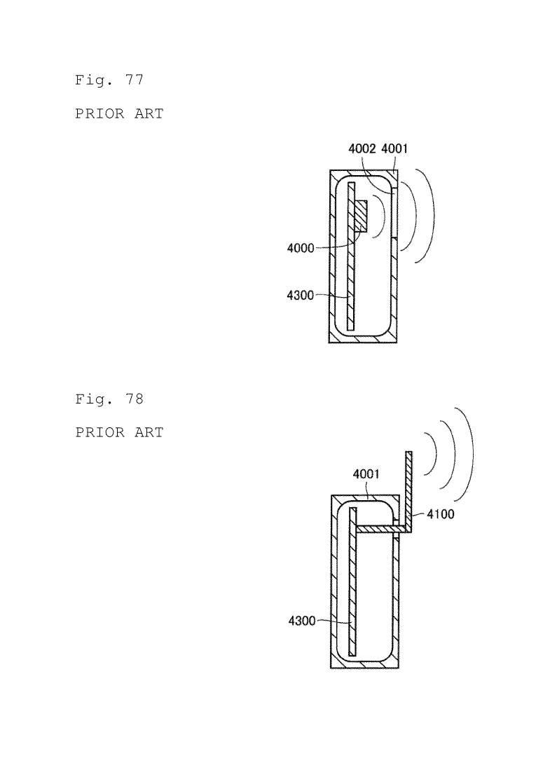

FIG. 74 is an explanatory view of plural antennas using slits 2900V according to the twenty-seventh embodiment on the same metal plate 2001V. Referring to FIG. 74, in particular regions 2000V functioning as a monopole antenna are separated by the slits 2900V, the electric current concentrates onto the separated particular regions 2000V, and is not coupled to the antennas.

Thereby, in addition to the effect described in the twenty-third to twenty-sixth embodiments, the following effect can be provided. The number of antenna mounting regions is larger than when part of the metal housing is formed of a resin to provide an antenna. Therefore, plural antennas can be provided on the entire surface of the metal plate 2001V structuring the metal housing. The number of antennas mounted can thus be increased.

In the twenty-third to twenty-seventh embodiments, the slit is in contact with the particular region. Therefore, an electromagnetic wave can be radiated from the slit. The thickness of the metal layer of the metal plate and the metal housing may be equal to or more than the skin depth.

### Twenty-Eighth Embodiment

In the seventh to twentieth embodiments, the method with the coil as the metamaterial (e.g., see FIG. 41) and the method with the coil and the magnetic body (for instance, see FIG. 47) are shown.

In these methods, the surrounded particular region is electrically isolated from other regions to surround part of the metal plate by a high impedance region. The square root of μ/∈ is impedance Z, but the method with the coil lowers dielectric constant ∈ to increase impedance Z. When ∈=0, Z is infinite, so that the particular region can be isolated from other regions. However, this is enabled at only one particular frequency, and in terms of the bandwidth, it is difficult to sufficiently increase the impedance.

In the method with the coil and the magnetic body, dielectric constant ∈ is decreased, and magnetic permeability μ is increased to increase impedance Z. However, there are no suitable magnetic bodies usable in the GHz bandwidth, except for YIG (Yttrium Iron Garnet). In addition, YIG has a not-high Q value to require a magnet.

According to the structure of a metamaterial 2100W according to the twenty-eighth embodiment, the impedance can be higher than the method with the coil. In addition, the method with the coil and the magnet, although there are no suitable materials usable in the GHz bandwidth, the structure of the metamaterial 2100W according to the twenty-eighth embodiment can increase the impedance.

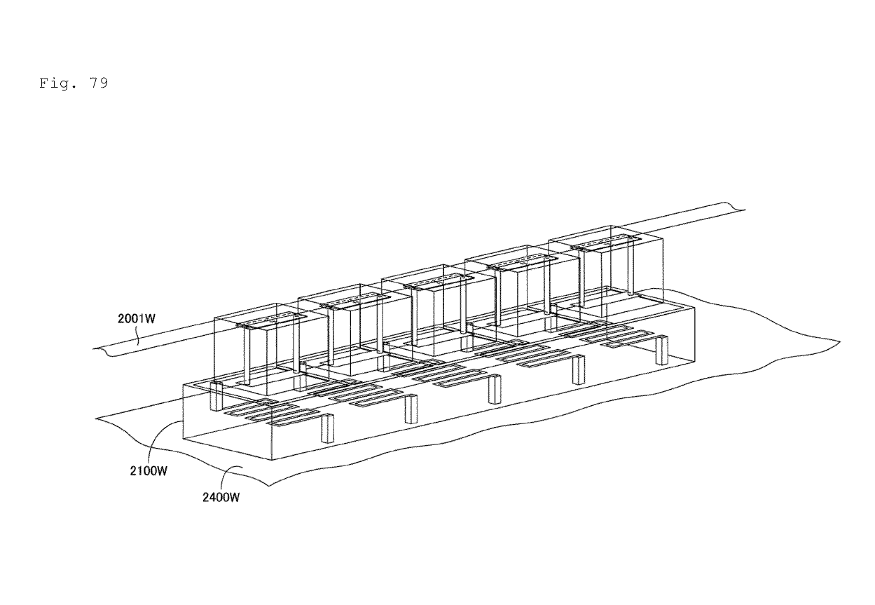

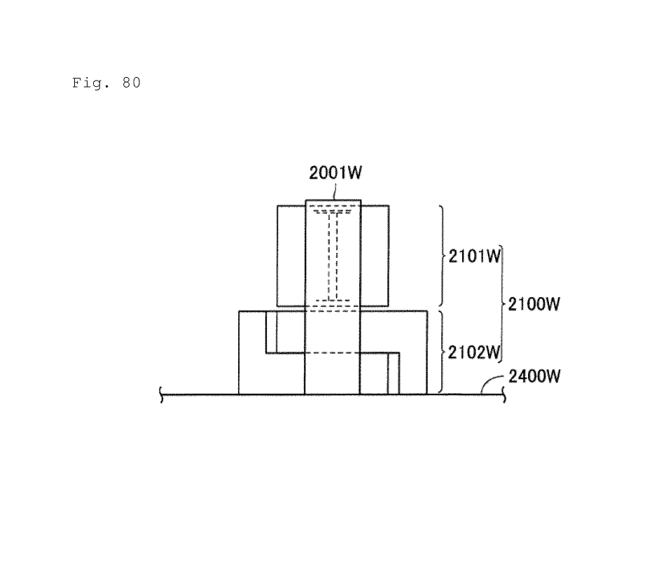

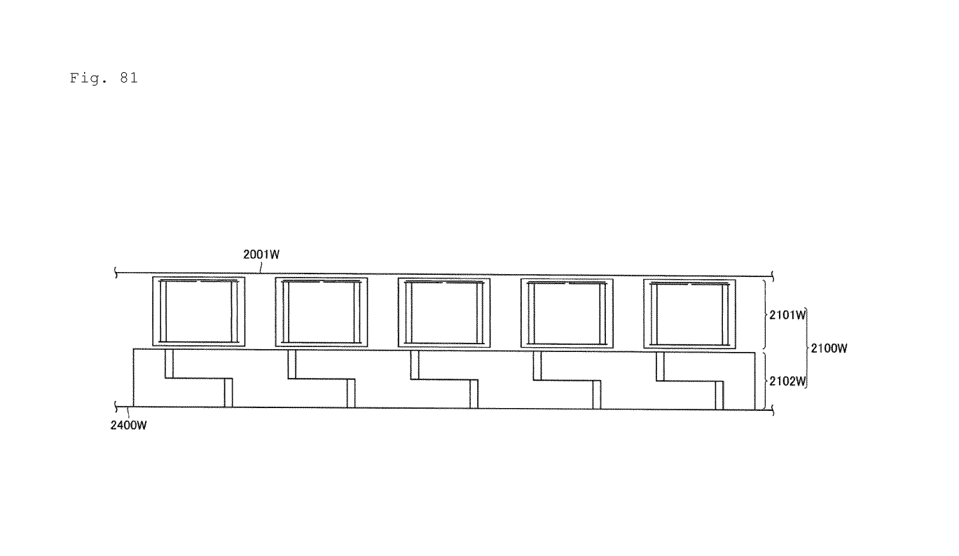

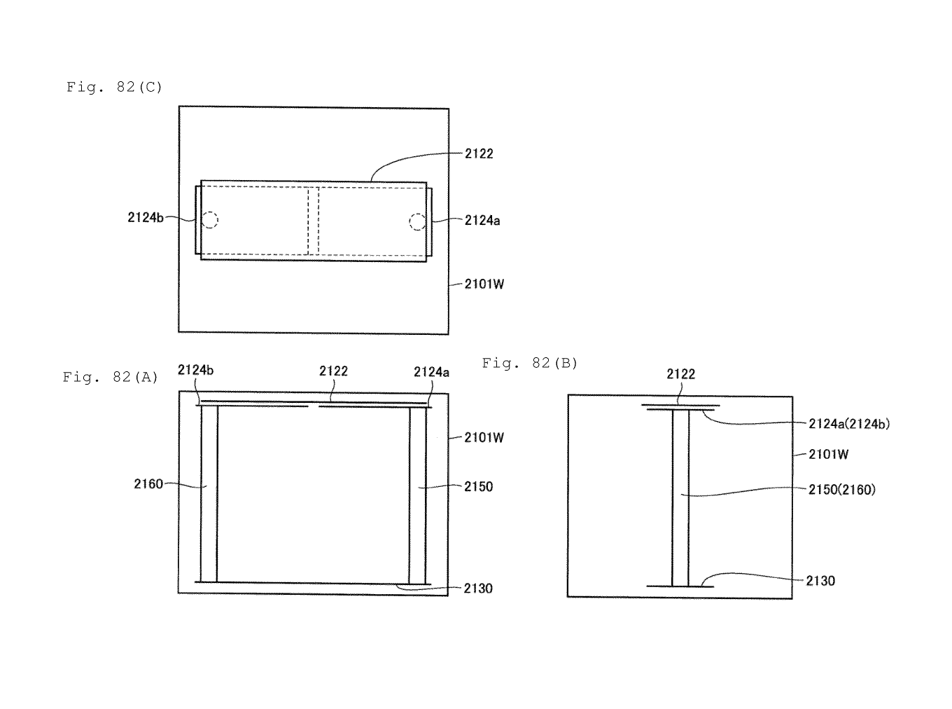

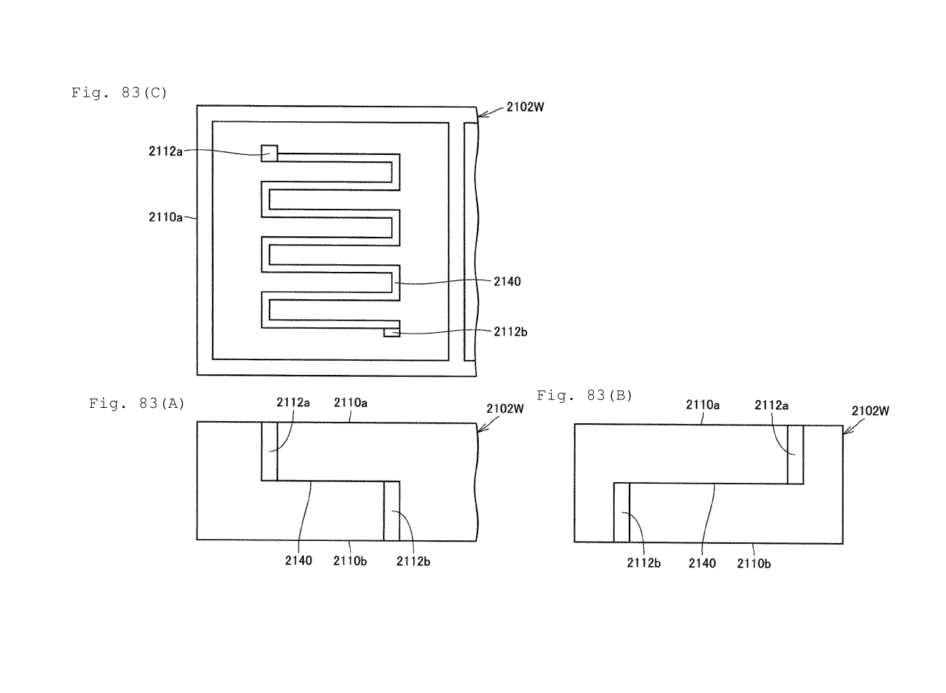

FIG. 79 is an explanatory view of a structure which electrically isolates a metal line 2001W by using the metamaterial 2100W according to the twenty-eighth embodiment. FIG. 80 is a side view of the structure which electrically isolates the metal line 2001W by using the metamaterial 2100W according to the twenty-eighth embodiment. FIG. 81 is a front view of the structure which electrically isolates the metal line 2001W by using the metamaterial 2100W according to the twenty-eighth embodiment. FIGS. 82(A), 82(B), and 82(C) are three views showing the detail of an upper stage of the structure which electrically isolates the metal line 2001W by using the metamaterial 2100W according to the twenty-eighth embodiment. FIGS. 83(A), 83(B), and 83(C) are three views showing the detail of a lower stage of the structure which electrically isolates the metal line 2001W by using the metamaterial 2100W according to the twenty-eighth embodiment.

In the twenty-eighth embodiment, the upper and lower stages exhibit a positive magnetic permeability more than 1 and a dielectric constant having an absolute value less than 1. Alternatively, the upper and lower stages exhibit a negative magnetic permeability less than −1 and a dielectric constant having an absolute value less than 1. Thereby, the metal line 2001W can be electrically isolated. Herein, the dielectric constant having an absolute value less than 1 also includes a dielectric constant of zero.

A ground 2400W is provided on the opposite side of the metal line 2001W across the metamaterial 2100W.

Referring to FIGS. 83(A), 83(B), and 83(C), a lower stage 2102W includes an uppermost electrode 2110a, a first via 2112a, a second via 2112b, a lowermost electrode 2110b, and a line 2140. The first via 2112a, the line 2140, and the second via 2112b connect the uppermost electrode 2110a and the lowermost electrode 2110b.

The entire length of the first via 2112a, the line 2140, and the second via 2112b is substantially ¼ of the resonant wavelength. The first via 2112a, the line 2140, and the second via 2112b function as part of a λ/4 line to realize the dielectric constant having an absolute value less than 1. The shape of the line 2140 is not limited to the shown meandered shape, and may be e.g., helical and spiral.

The uppermost electrode 2110a and the lowermost electrode 2110b have the dielectric constant having an absolute value less than 1 and exhibit the function to shorten a resonant wavelength. However, the uppermost electrode 2110a and the lowermost electrode 2110b can also be omitted.

The lowermost electrode 2110b is electrically connected to the ground 2400W. Here, as the λ/4 line, λ/4 resonance is used, so that the lowermost electrode 2110b is electrically connected to the ground 2400W. The use of half-wavelength resonance makes the coil long, but the lowermost electrode 2110b is not required to be connected to the ground 2400W. The manufacturing process is thus simplified.

In a prototype, the lower stage 2102W has a width of 3.2 mm, a depth of 3.4 mm, and a height of 1.5 mm. In the structure of the lower stage 2102W, five resonators having this size are continuous in the width direction. The lower stage 2102W is formed of e.g., a resin substrate.

Referring to FIGS. 82(A), 82(B), and 82(C), the upper stage 2101W includes a first inner electrode 2122, a second inner electrode 2124a, a third inner electrode 2124b, a fourth inner electrode 2130, a third via 2150, and a fourth via 2160.

The third via 2150 connects the second inner electrode 2124a and the fourth inner electrode 2130. The fourth via 2160 connects the third inner electrode 2124b and the fourth inner electrode 2130. The second inner electrode 2124a, the third via 2150, the third inner electrode 2124b, the fourth via 2160, and the fourth inner electrode 2130 have the same structure as a split ring resonator, and function as a resonator which exhibits one of the negative and positive magnetic permeability. Like the first inner electrode 722 of the fourth embodiment, the first inner electrode 2122 compensates for the electrostatic capacitance in the disconnected portion between the second inner electrode 2124a and the third inner electrode 2124b to lower a resonant frequency.

In a prototype, the upper stage 2101W has a width of 2.4 mm, a depth of 2.0 mm, and a height of 1.8 mm. Five resonators of this size are arranged on the resonator of the lower stage 2102W. The upper stage 2101W is formed of e.g., a multi-layer ceramic substrate.

The resonator of the upper stage 2101W is an LC resonator, and functions as an artificial magnetic body at the resonant point thereof. Due to resonance, the frequency bandwidth used in the magnetic body is narrow, but can also be in the GHz bandwidth.

In addition, the LC resonator typically has anisotropy, and is resonated only in a magnetic field in the particular direction. It is thus difficult to apply the LC resonator to a plate having a relatively small aspect ratio. However, the LC resonator can be used for a line-like metal having a relatively large aspect ratio and a relatively small width, like the metal line 2001W.

In the above structure, part of the metal line 2001W can be electrically isolated. Therefore, without being limited to the length of the metal line 2001W, part of the metal line 2001W can be an antenna resonated at a desired frequency.

When the metal line 2001W is used as a multi-mode antenna resonated only at a frequency corresponding to λ/4, 3λ/4, 5λ/4, . . . , the metamaterial 2100W is provided so that without affecting the originally resonated frequency much, resonance at an optional frequency can be added. Therefore, in addition to the original resonant frequency, the antenna can respond to the optional frequency.

Plural (here, five) metamaterial units are arrayed to cover plural phases. When the phases can be covered, the number of units is not limited to five.

In the above embodiment, the upper stage 2101W is isolated, but the upper stage 2101W is not limited to this, and may be integrated. Further, in the above embodiment, the upper stage 2101W and the lower stage 2102W are bonded onto each other, but the upper stage 2101W and the lower stage 2102W are not limited to this, and may be integrally manufactured.

Although not shown, to use this embodiment as an antenna, of course, it is necessary to provide the electricity supply line.

### Twenty-Ninth Embodiment

In a twenty-ninth embodiment, the metamaterial described in the twenty-eighth embodiment is applied to a smartphone.

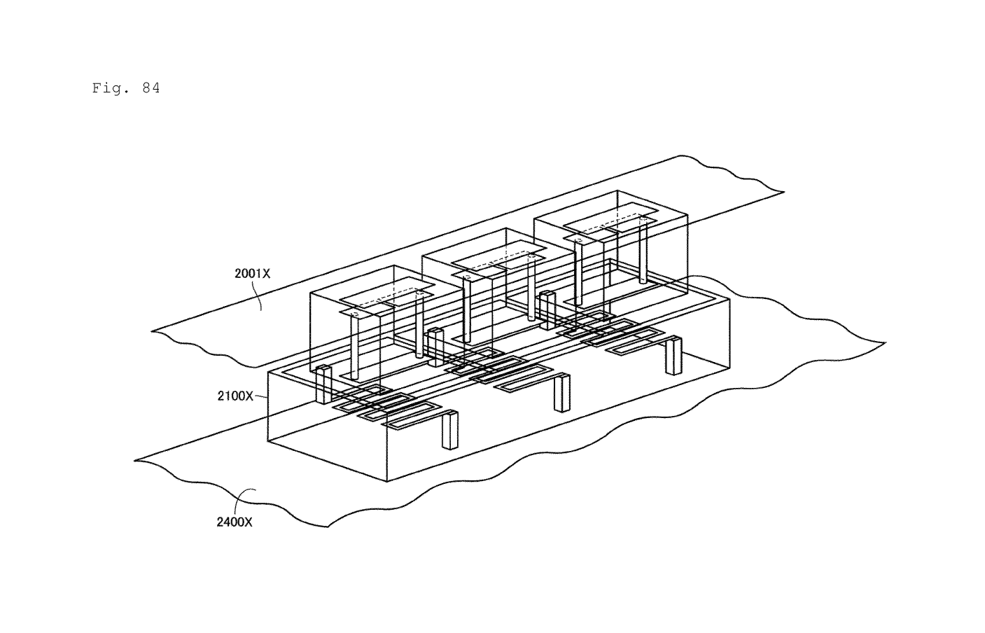

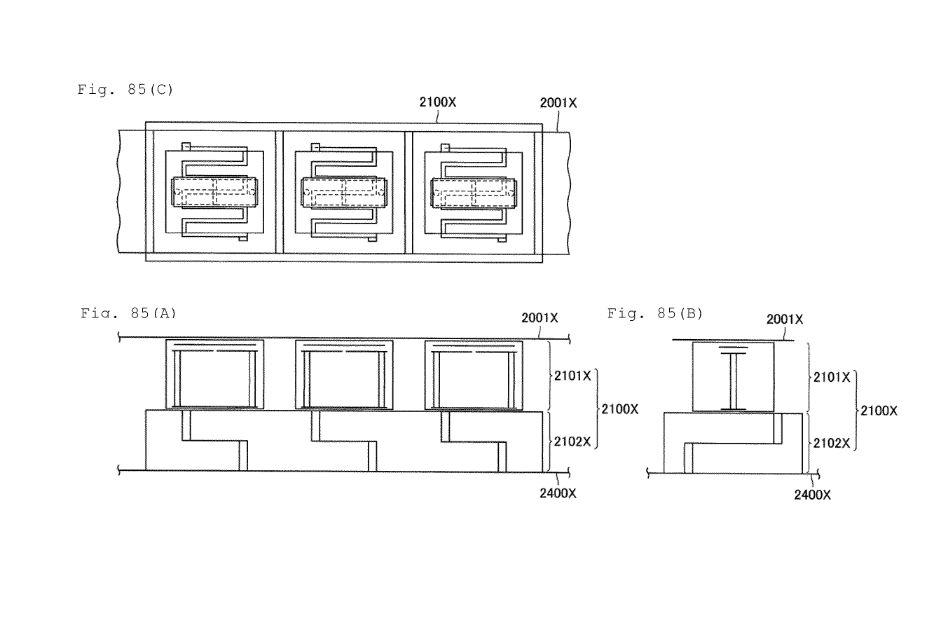

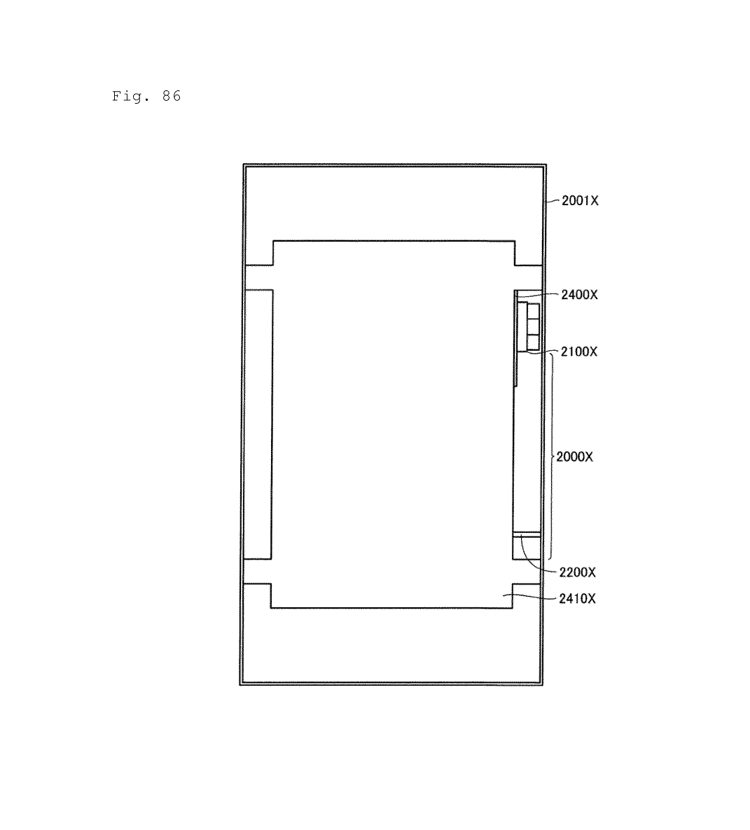

FIG. 84 is an explanatory view of the structure of a metamaterial 2100X according to the twenty-ninth embodiment. FIGS. 85(A), 85(B), and 85(C) are three views of the metamaterial 2100X according to the twenty-ninth embodiment.

Referring to FIGS. 84, 85(A), 85(B), and 85(C), five metamaterials 2100W of the twenty-eighth embodiment are replaced with three metamaterials 2100X. The structure of an upper stage 2101X and a lower stage 2102X in each metamaterial 2100X unit and the position relation between the metamaterial 2100X, a metal frame 2001X, and a ground 2400X are the same as the twenty-eighth embodiment, and the overlapped description is not repeated.

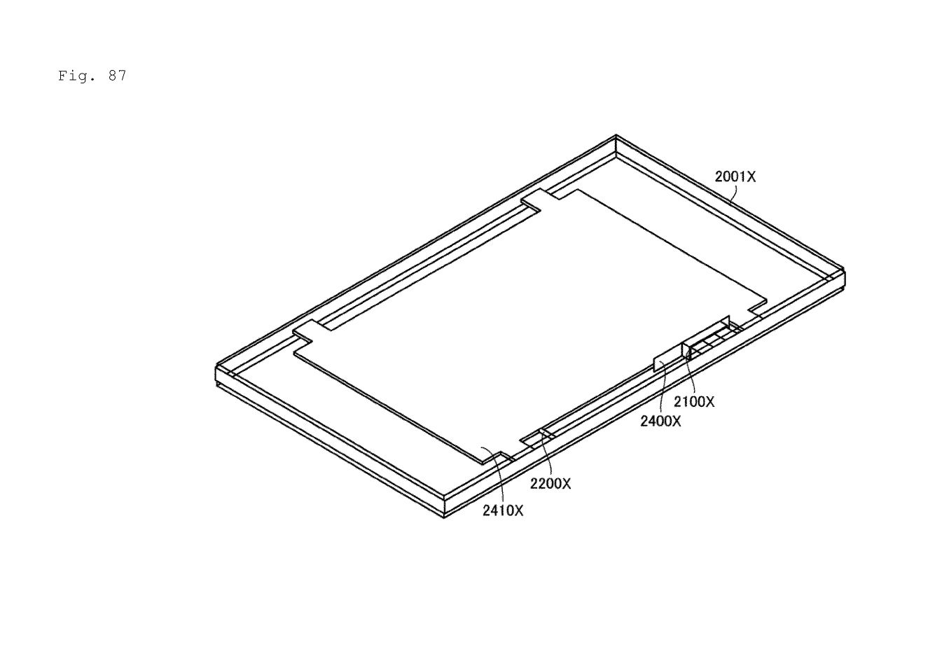

FIG. 86 is a schematic plan view of a state in which the metamaterial 2100X according to the twenty-ninth embodiment is mounted on a smartphone. FIG. 87 is a schematic perspective view of a state in which the metamaterial 2100X according to the twenty-ninth embodiment is mounted on a smartphone.

Referring to FIGS. 86 and 87, the smartphone includes the metal frame 2001X, and a ground substrate 2410X. The metal frame 2001X and the ground substrate 2410X are electrically connected to each other.

Each metamaterial 2100X described in FIGS. 84, 85(A), 85(B), and 85(C) is mounted so that the upper stage 2101X is close to the metal frame 2001X to cut off the near resonant wavelength component of the metamaterial 2100X of an electric current flowing through the metal frame 2001X. The ground 2400X is electrically connected to the ground substrate 2410X, and is arranged close to the lower stage 2102X of the metamaterial 2100X.

The ground 2400X is preferably longer than the metamaterial 2100X. To cut off an electromagnetic wave, the impedance is increased by the metamaterial 2100X. Therefore, the ground 2400X is longer than the metamaterial 2100X to lower the impedance in the portion near the metamaterial 2100X. The impedance difference thus becomes larger to enhance the cutoff effect.

An electricity supply line 2200X is connected to a particular region 2000X from the region of the metal frame 2001X to which the metamaterial 2100X is close to the grounded location connected to the ground substrate 2410X.

Thereby, electricity is supplied from the electricity supply line 2200X to the particular region 2000X, so that in the location to which the metamaterial 2100X is close, the near resonant wavelength component of the metamaterial 2100X of an electric current flowing through the metal frame 2001X is electrically cut off. Thereby, the particular region 2000X functions as an antenna at the frequency corresponding to the near resonant wavelength.

A metal frame and a bar are sometimes used mainly for design on the side and surfaces of an apparatus on which an antenna is mounted, such as a smartphone, a cellular phone, and a PC. In that case, the metal frame and the bar are desired to be used as an antenna. However, the resonant frequency is determined according to the physical length of one of the metal frame and the bar. Therefore, since it is necessary to give priority to product design, it is difficult to use the metal frame and the bar as an antenna.

Like the above embodiments, the physical slit is provided in the metal frame to function as an antenna. However, in this case, since it is necessary to give priority to product design, too many slits cannot be provided.

Accordingly, like this embodiment, since the metamaterial 2100X is close to the metal frame 2001X, the lower stage 2102X can decrease apparent dielectric constant ∈ at a resonant frequency, and the upper stage 2101X can increase apparent magnetic permeability μ. The impedance can thus be increased.

Thereby, the impedance in part of the metal frame 2001X can be increased, so that non-matching occurs in that portion to reflect the electromagnetic wave. Therefore, both sides in that portion can be electrically isolated.

In this embodiment, only part of the metal frame 2001X is electrically isolated. However, the present invention is not limited to this, and without considering the limit of the design, a necessary number of metamaterials 2100X may be provided at the necessary positions to electrically isolate plural positions. Thereby, plural antennas can be structured in one metal frame 2001X.

[Others]

(1) In the above embodiments, as an example of the apparatus which applies one of the antenna using the metamaterial and the antenna using the slit, not the metamaterial, the portable terminal, such as a smartphone, is shown. However, the present invention is not limited to this, and the apparatus which applies one of the antenna using the metamaterial and the antenna using the slit, not the metamaterial, may be any apparatus as long as it has a metal outer plate (for instance, a housing, and a body) and is required to mount the antenna therein.

For instance, the electric apparatus may be a portable terminal, a PC, a video, a television, an electric appliance such as a refrigerator and an air conditioner, a transporting apparatus such as an automobile and a train, and constructing equipment such as a house door with an electric lock. Even when the present invention is applied to any of the apparatuses, an external antenna can be eliminated and the entire surface of the outer plate can be formed of a metal. A product which cannot deteriorate rigidity and fine texture can be realized.

When the present invention is applied to a transporting apparatus, for instance, when a component which structures one of the antenna using the metamaterial and the antenna using the slit, not the metamaterial, is provided inside the roof and hood of an automobile, an outer component, such as the conventional antenna, can be eliminated. The present invention is thus advantageous in air resistance and design. An antenna buried into a glass surface can be visible to the user, which is not favorable to the user. However, in this embodiment, it is not necessary to bury an antenna into a glass surface. The present invention is applicable to keyless entry.

When an outer plate, such as the roof and hood of an automobile, is thicker than the skin depth of the material, even when an antenna using the metamaterial is structured in the outer plate, as described in the twelfth to fourteenth, sixteenth, and seventeenth embodiments, the end surface of the particular region is the end surface of the metal plate and the metal housing, and as described in the eighteenth to twentieth and the twenty-third to twenty-seventh embodiments, the end surface of the particular region is exposed from the inner surface of the slit, so that an electromagnetic wave can be radiated from the antenna.

In a portable terminal, the present invention is applicable, not only to an antenna for communication, but also to an antenna for GPS, a one segment broadcast, and an FM broadcast. The present invention is also applicable to the panel on the back side of a thin PC, such as a notebook PC and a slate PC, the panel on the back side of a liquid crystal display, the side surface panel of a desktop PC, and a PC on which MIMO (Multiple Input Multiple Output) is mounted.

One of the antenna using the metamaterial and the antenna using the slit, not the metamaterial, is applied to the metal panel on the outside of a household appliance, such as a video, a television, a refrigerator, and an air conditioner, and can be wirelessly controlled. In this case, like the outer plate of the transporting apparatus, even when the outer plate is thicker than the skin depth of the material so that one of the antenna using the metamaterial and the antenna using the slit, not the metamaterial, is structured in the outer plate, when the end surface of the particular region is the end surface of one of the metal plate and the metal housing and the end surface of the particular region is exposed from the inner surface of the slit, an electromagnetic wave can be radiated from the antenna.

The metal frame provides a multi-band antenna. However, a wiring cable can also be used as an antenna. The cable which is inexpensive and flexible is optimum for an antenna wire. However, the cable functions only as a monopole antenna, and cannot respond to a multi-band antenna. Therefore, there are few examples in which the cable is used as an antenna. However, the use of the metamaterial can freely increase the number of resonant frequencies. As a result, the cable can be used as a multi-antenna.

Even when the antenna cannot be mounted in the metal housing, the metal housing is not required to be formed of a non-metal and can be used to add the antenna function. Since the automobile antenna buried in glass which has both of the metal and non-metal portions emphasizes appearance and function, it can be mounted in the metal portion.

The housing formed of a non-metal to mount the antenna therein can be formed of a metal to structure the antenna function in the metal housing, which is advantageous in appearance and strength.

The external antenna function is provided in the metal housing, so that the antenna strength can be increased and the apparatus size can be smaller.

(2) The metal portion of the housing is physically isolated to be used as an antenna. However, when the isolated portion is pressed by hand, the body of the user becomes part of an antenna to change the resonant frequency. Consequently, the antenna cannot function properly.

In the antenna using the metamaterial according to this embodiment, even when the particular region sectioned by the region onto which the metamaterial is stuck and functioning as an antenna is pressed by hand, the resonant frequency (resonant wavelength) cannot be changed.

(3) In the above embodiments, various metamaterials structuring an antenna can be used. However, when a multi-layer ceramic capacitor (MLCC) and a chip coil are used as the metamaterial, the present invention can be smaller, and can be manufactured in the manufacturing process of the commercially-available MLCC and the chip coil at low cost.

(4) In the above embodiments, the electricity supply point is provided in the particular region. Therefore, the

metamaterial is arranged on the metal plate so that one of the region which greatly cuts off the near resonant wavelength component of the electromagnetic wave equivalent to a high impedance region of an electric current supplied from the electricity supply point and the region which substantially cuts off the electromagnetic wave component is formed in the sectioning region which sections the particular region of the metal plate from other regions. The particular region thus functions as an antenna.

The particular region functions as an antenna, but the present invention is not limited to this, and the metamaterial may be arranged so that one of the region which greatly cuts off the near resonant wavelength component of the electromagnetic wave equivalent to a high impedance region of an electric current flowing through the metal plate and the region which substantially cuts off the electromagnetic wave component is formed in the sectioning region which sections the particular region of the metal plate from other regions.

(5) The embodiments disclosed herein are illustrated in all points, and should be considered not to be limitative. The scope of the present invention is illustrated by the claims, not by the above description, and all changes in the meaning and range equivalent to the claims are intended to be included.

### DESCRIPTION OF REFERENCE SYMBOLS

2 Outer electrode
3 Outer electrode
4 Inner electrode
4a Electrode
4b Electrode
5 Inner electrode
5a Electrode
5b Electrode
6 Spacer
10 Outer cover
100 Coil resonator
110 Center axis
200 Signal line
220 Ground
300 Capacitor resonator
600 Unit
610a Uppermost electrode
610b Lowermost electrode
622, 624, 632, 634 Inner electrode
640 Line
650, 660 Outer electrode
700 Unit
710a Uppermost electrode
710b Lowermost electrode
722, 724a, 724b, 730 Inner electrode
740 Line
750, 760 Outer electrode
800 Unit
810 Coiled conductor
822, 824, 832, 834 Electrode
842, 844 Via
910a, 2110a Uppermost electrode
910b, 2110b Lowermost electrode
912a, 2112a First via
912b, 2112b Second via
922, 2122 First inner electrode
924a, 2124a Second inner electrode
924b, 2124b Third inner electrode
930, 2130 Fourth inner electrode
940, 2140 Line
950, 2150 Third via
960, 2160 Fourth via
2000, 2000B to 2000H, 2000J to 2000N, 2000P, 2000Q to 2000V, 2000X Region
2001, 2001B, 2001J to 2001L, 2001P, 2001Q, 2001T, 5001 Metal housing
2001A, 2001C to 2001H, 2001M, 2001N, 2001R, 2001S, 2001U, 2001V, 4001V, 6001 Metal plate
2001W Metal line
2001X Metal frame
2002J, 2002K Non-metal housing
2100, 2100A to 2100G, 2100HA, 2100HB, 2100J, 2100KA, 2100 KB, 2100L to 2100N, 2100P, 2100Q, 2100W, 2100X Metamaterial
2101W, 2101X Upper stage
2102W, 2102X Lower stage
2010 Smartphone
2200, 2200A to 2200C, 2200H, 2200J, 2200K, 2200M, 2200N, 2200U, 2200X, 4200A Electricity supply line
2300, 2300P, 2300Q Circuit substrate
2400A, 4400A Ground plate
2400B Ground plane
2400U Ground electrode
2400W, 2400X Ground
2410X Ground substrate
2500, 2500M, 2500N Ground surface
2600 Antenna
2700 Magnetic body
2750U Printed substrate
2800 Camera unit
2900M, 2900N, 2900R to 2900V Slit 3000, 4000, 4100 Antenna
3001, 4001, 4002 Case
3300, 4300 Substrate
5900 Slot antenna

1. A metamaterial arrangement comprising:
a metamaterial exhibiting a dielectric constant having an absolute value less than 1 and a magnetic permeability having an absolute value more than 1 with respect to a predetermined resonant wavelength in an electromagnetic field,
the metamaterial being configured to cut off a near resonant wavelength component of an electric current flowing through a conductive layer and form a particular region,
wherein at least part of the particular region is configured to radiate an electromagnetic wave.

2. The metamaterial according to claim 1,
wherein the at least part of the particular region configured to radiate the electromagnetic wave is on the surface of the conductive layer in the particular region.

3. The metamaterial according to claim 1,
wherein the particular region is formed along a contour of a component,
wherein the at least part of the particular region configured to radiate the electromagnetic wave is an end surface of the conductive layer in the particular region in the contour of the component.

4. An electric apparatus comprising:
a component having a conductive layer in a fixed range in a depth direction thereof,
wherein the conductive layer includes a particular region that is electromagnetically isolated from other regions of the conductive layer.

5. The electric apparatus according to claim 4, further comprising:
a metamaterial which exhibits a dielectric constant having an absolute value less than 1 and a magnetic permeability having an absolute value more than 1 with respect to a predetermined resonant wavelength in an electromagnetic field,
wherein the metamaterial is arranged so as to cut off a near resonant wavelength component of an electric current from flowing through the particular region, and
wherein at least part of the particular region is configured to radiate an electromagnetic wave.

6. The electric apparatus according to claim 5,
wherein the at least part of the particular region configured to radiate the electromagnetic wave is on a surface of the conductive layer in the particular region.

7. The electric apparatus according to claim 6, further comprising:
an electricity supply point in the particular region,
wherein the electric current flowing through the conductive layer is supplied from the electricity supply point, and
wherein the particular region is an antenna to which electricity is supplied from the electricity supply point.

8. The electric apparatus according to claim 7,
wherein the component is at least part of a housing configured to shield an inside thereof from an outside thereof, and
wherein the metamaterial is within the housing,
the electric apparatus further comprising a circuit within the housing that supplies electricity to the electricity supply point.

9. The electric apparatus according to claim 6,
wherein the electromagnetic wave is incident onto a first surface of the particular region,
wherein the electric current flowing through the conductive layer is an electric current generated by the electromagnetic wave incident onto the first surface of the particular region, and
wherein the particular region radiates the electromagnetic wave having the wavelength of the incident electromagnetic wave from a second surface of the particular region.

10. The electric apparatus according to claim 5,
wherein the particular region is in a contour of the component, and
wherein the at least part of the particular region configured to radiate the electromagnetic wave is an end surface of the conductive layer in the particular region in in the contour of the component.

11. The electric apparatus according to claim 10, further comprising:
an electricity supply point in the particular region,
wherein the electric current flowing through the conductive layer is supplied from the electricity supply point, and
wherein the particular region is an antenna to which electricity is supplied from the electricity supply point.

12. The electric apparatus according to claim 11,
wherein the component is at least part of a housing configured to shield an inside thereof from an outside thereof,
wherein the metamaterial is within the housing,
the electric apparatus further comprising a circuit within the housing that supplies electricity to the electricity supply point.

13. The electric apparatus according to claim 10,
wherein the electromagnetic wave is incident onto a first surface of the particular region,
wherein the electric current flowing through the conductive layer is an electric current generated by the electromagnetic wave incident onto the first surface of the particular region, and
wherein the particular region radiates the electromagnetic wave having the wavelength of the incident electromagnetic wave from a second surface of the particular region.

14. The electric apparatus according to claim 4,
wherein the particular region is defined by at least one of a slit and a grounding portion (2400U), and
wherein at least part of the particular region is configured to radiate an electromagnetic wave.

15. The electric apparatus according to claim 14, wherein an opening in the component defined by the slit is closed by an insulating component.

16. The electric apparatus according to claim 15, wherein the grounding portion is in the insulating component.

17. The electric apparatus according to claim 14, wherein a resonant frequency of the particular region is adjusted based on a position of the grounding portion.

18. The electric apparatus according to claim 14, wherein the slit is U-shaped.
